(19) United States
(12) Patent Application Publication
(10) Pub. No.: US 2013/0000178 A1
(43) Pub. Date: Jan. 3, 2013

(54) Fishing Rod Components and Method of Making and Using the Same

(76) Inventor: David A. Neeley, Canton, GA (US)

(21) Appl. No.: 13/539,685

(22) Filed: Jul. 2, 2012

Related U.S. Application Data
(60) Provisional application No. 61/504,090, filed on Jul. 1, 2011.

(51) Int. Cl. A01K 97/10; A01K 87/06

(52) U.S. Cl. 43/22; 43/21.2

(57) ABSTRACT

Fishing rod components and method of making and using the same are disclosed. The fishing rod components include a fishing rod reel seat with one or more removable handles. The fishing rod components also include a multi-functional anchoring device that secures a fishing rod to the ground, dock, boat, or other object. The disclosed anchoring device may include two main securing devices: a ground spike and a clamp. The ground spike is used primarily for securing a fishing rod to the ground, and the clamp is used to secure a fishing rod to a dock, boat, or numerous other objects. The ground spike and clamp may be combined into one compact unit that can either be integrated into and form a removable fishing rod handle, or be a separate unit that resides underneath a fishing rod handle during use.

### CROSS-REFERENCE TO RELATED APPLICATIONS

This patent application claims the benefit of priority to U.S. Provisional Patent Application Ser. No. 61/504,090 filed on Jul. 1, 2011 and entitled “FISHING ROD ANCHORING DEVICES AND METHOD OF MAKING AND USING THE SAME”, the subject matter of which is hereby incorporated by reference in its entirety.

### FIELD OF THE INVENTION

The present invention relates to fishing rod components and methods of making and using fishing rod components. The present invention further relates to fishing rod reel seats suitable for use with one or more removable handles. The present invention even further relates to a multi-functional anchoring device that secures a fishing rod to the ground, dock, boat, or other object. The present invention also relates to methods and apparatus for securing a fishing rod to the ground, a dock, a boat, etc.

### BACKGROUND OF THE INVENTION

Various types of anchoring devices have traditionally required some type of retaining mechanism to secure a fishing rod to the ground, a dock, a boat, etc. These mechanisms have been made in various forms and configurations. They usually consist of some type of metallic object separate from the fishing rod, which is usually driven into the ground. The fishing rod is then placed into or onto the object or propped against the object to be retrieved once a fish has been hooked. Other forms of anchoring devices have been developed and used on boats. These devices usually take the form of a pipe or cylindrical object screwed into the hull of a boat therefore becoming part of the boat and again separate from the fishing rod. The fishing rod is then placed into the device for later retrieval once a fish is hooked.

Securing a fishing rod to a dock either with rails or without rails has remained a problem for decades with no known solution. A user cannot drive or hammer a securing device into a dock like they can the ground without causing damage either to the securing device or the dock. Likewise, a user cannot screw or secure a pipe or cylindrical object to a dock without causing damage to the dock especially if the dock is not owned by the user. One cannot go to a public access dock and secure any object permanently to the dock without being fined or face some type of consequences. The above-mentioned devices all pose problems that fisherman have faced for years. A securing device has not been created that can be used on all surfaces.

It would be desirable to have a multi-functional anchoring device that could be used on all surfaces while still maintaining its independence from those surfaces. It would be further desirable to have a multi-functional anchoring device that can be integrated into a fishing rod handle using both a clamping principle for attaching to a dock, boat, etc. and an insertion principle for securing into dirt, mud, sand, etc. while maintaining a compact, lightweight, and aesthetic design that incorporates portability, strength, and stability.

Further, various types of handles and reel seats have traditionally been mounted or secured directly to a fishing rod. These handles and reel seats have been permanently secured directly to a fishing rod due to the construction and makeup of the fishing rod itself. All fishing rods are made using rod blanks that form one continuous, unbroken and permanent connection that extends from the rod tip thru a fore grip, a reel seat, and finally the rod handle, ending at the aft of the handle. This has been the makeup and construction method for fishing rods. Such a makeup and construction prevents a fisherman from using a variety of handles with a given fishing rod.

It would be desirable for a fisherman to be able to attach or mount a variety of different types of fishing rod handles to their fishing rod without permanently securing a given handle to the fishing rod. It would be further desirable to be able to mount interchangeable fishing rod handles to a fishing rod using a specially designed reel seat that accepts the handles without permanently securing the handles to the fishing rod.

### SUMMARY OF THE INVENTION

The present invention is directed to fishing rod components and methods of making and using fishing rod components. Fishing rod components of the present invention address one of more of the above-described shortcomings in the field of fishing equipment. In one embodiment, the present invention is directed to a multi-functional retaining device or Fishing Rod Anchor (FRA) that can be integrated into the handle of a fishing rod (e.g., a removable fishing rod handle) or reside underneath the fishing rod handle (e.g., a permanently fixed or removable fishing rod handle) depending on the users preference. The FRA can be used to anchor a fishing rod to the ground, dock, boat, etc.

In some embodiments, the FRA comprises a ground spike, an adjustable clamp, or both a ground spike and an adjustable clamp. The resulting FRA uses (i) an insertion principle for securing into dirt, mud, sand, etc, (ii) a clamping principle for attaching to a dock, boat, etc., or (iii) both (i) and (ii). The FRA provides a compact, lightweight, and aesthetic design that is portable, strong, stable, removable, non-intrusive, and easy to use.

According to one exemplary embodiment of the present invention, the present invention is directed to a fishing rod anchoring device comprising an anchor chassis member; a fishing rod attaching component operatively adapted and sized so as to attach the fishing rod anchoring device to a fishing rod; a fishing rod attaching component locking mechanism operatively adapted and sized to (i) lock the fishing rod attaching component into a locked position relative to the anchor chassis member, and (ii) unlock the fishing rod attaching component from the locked position; and at least one of (1) an adjustable clamping assembly attached to the anchor chassis member, the adjustable clamping assembly being operatively adapted and sized to clamp onto an object, and (2) a spike member attached to the anchor chassis member, the spike member (a) being operatively adapted and sized to extend into soil, and (b) being movable from (i) a housed position within the anchor chassis member to (ii) a use position outside of the anchor chassis member.

The present invention is further directed to fishing rod reel seats that may be used with removable fishing rod handles. In one exemplary embodiment, the fishing rod reel seat of the present invention comprises a reel seat member having a first end, a second end opposite the first end, and a reel connecting member positioned along the reel seat member between the first end and the second end; a first cavity extending a first depth into the reel seat member from the first end, the first cavity being sized to house a connecting end of a fishing rod therein; and a fishing rod handle connecting member comprising (i) internal threads extending along a second cavity that extends a second depth into the reel seat member from the second end, (ii) external threads extending along an outer surface of the reel seat member proximate the second end, or (iii) both (i) and (ii), the fishing rod handle connecting member being sized and configured to be attachable to one or more removable fishing rod handles. In some embodiments, the fishing rod reel seat comprises a rod handle connecting member (i) that extends a second depth into the reel seat member from the second end and (ii) comprises internal threads, the internal threads being sized and configured to attach to corresponding external threads of one or more removable rod handles.

The present invention is even further directed to fishing rod kits. In one exemplary embodiment, the fishing rod kit comprises (I) at least one fishing rod reel seat, each of the at least one fishing rod reel seat comprising a reel seat member having a first end, a second end opposite the first end, and a reel connecting member positioned along the reel seat member between the first end and the second end; a first cavity extending a first depth into the reel seat member from the first end, the first cavity being sized to house a connecting end of a fishing rod therein; and a fishing rod handle connecting member comprising (i) internal threads extending along a second cavity that extends a second depth into the reel seat member from the second end, (ii) external threads extending along an outer surface of the reel seat member proximate the second end, or (iii) both (i) and (ii), the fishing rod handle connecting member being sized and configured to be attachable to one or more removable fishing rod handles; and (II) at least one removable fishing rod handle, each of the at least one removable fishing rod handle comprising a set of internal or external threads that are engagable with the internal threads or the external threads of the at least one fishing rod reel seat. The kits may further comprise, for example, one or more of: (i) a fishing rod with a connecting end of the fishing rod being positionable or positioned within the first cavity and a tip end opposite the connecting end; (ii) a reel positionable and connectable to or positioned along and connected to the reel seat member via the reel connecting member; (iii) a plurality (i.e., greater than two) removable/interchangeable fishing rod handles suitable for use with the fishing rod reel seat.

The present invention is also directed to removable fishing rod handles suitable for use with the herein disclosed fishing rod reel seats. In one exemplary embodiment, the removable fishing rod handle comprises a fishing rod anchor, such as one of the fishing rod anchors described herein. Further, in some embodiments, the removable fishing rod handle further comprises a threaded protrusion at a front end for the purpose of attaching the removable fishing rod handle in a non-permanent fashion to a second device with a receiving threaded end (e.g., a fishing rod reel seat disclosed herein).

The present invention is further directed to methods of making and using any of the disclosed fishing rod components including, but not limited to, removable fishing rod handles, fishing rod reel seats suitable for use with removable fishing rod handles, and fishing rod anchoring devices (e.g., Type 1, Type 2, etc.), as well as kits containing any of the disclosed fishing rod components, and fishing rods comprising one or more of the disclosed fishing rod components.

These and other features and advantages of the present invention will become apparent after a review of the following detailed description of the disclosed embodiments and the appended claims.

### BRIEF DESCRIPTION OF THE FIGURES

The present invention is further described with reference to the appended figures showing exemplary embodiments of the present invention, wherein:

FIGS. 1a-1f depict views of exemplary fishing rod anchoring devices of the present invention and components thereof;

FIGS. 2a-3e depict views of exemplary ground spikes and components thereof suitable for use in the fishing rod anchoring devices of the present invention;

FIGS. 4a-9g depict views of exemplary clamping devices and components thereof suitable for use in the fishing rod anchoring device of the present invention;

FIGS. 10a-10g depict views of an exemplary rod tongue receiving device suitable for attaching a fishing rod to a fishing rod anchoring device of the present invention;

FIGS. 11a-11m depict views of another exemplary rod tongue receiving device suitable for attaching a fishing rod to a fishing rod anchoring device of the present invention;

FIGS. 12a-12d depict views of an exemplary rod tongue suitable for attaching a fishing rod to a fishing rod anchoring device of the present invention;

FIGS. 13a-13d depict views of another exemplary rod tongue suitable for attaching a fishing rod to a fishing rod anchoring device of the present invention;

FIGS. 14-15 depict cut-away views of exemplary anchor chassis and clamp screws used in exemplary fishing rod anchoring device of the present invention;

FIGS. 16a-18b depict various views of exemplary fishing rod anchoring device of the present invention attached to objects such as a dock without rails, a dock with rails, and a boat;

FIG. 19 depicts a view showing an exemplary fishing rod anchoring device of the present invention inserted into the ground/earth;

FIGS. 20a-20b depict views of an exemplary fishing rod anchoring device of the present invention attached to a fishing rod and reel;

FIG. 21 depicts views of exemplary fishing rod anchoring devices of the present invention and components thereof;

FIGS. 22a-23b depict views of other exemplary fishing rod anchoring devices of the present invention and components thereof;

FIGS. 24a-24b depict views of an exemplary fishing rod reel seat of the present invention;

FIGS. 25a-25b depict views of exemplary components suitable for use in the fishing rod anchoring devices of the present invention;

FIGS. 25c-25d depict views of exemplary fishing rod anchoring devices of the present invention in the form of removable fishing rod handles;

FIGS. 26a-31c depicts views of exemplary components used in combination to form an exemplary rod tongue receiver suitable for use in the fishing rod anchoring devices of the present invention;

FIGS. 32a-32d depict views of an exemplary elevation dial suitable for use in the fishing rod anchoring devices of the present invention;

FIGS. 33a-33d depict views of another exemplary elevation dial suitable for use in the fishing rod anchoring devices of the present invention;

FIGS. 34a-34d depict views of an exemplary kick plate suitable for use in the fishing rod anchoring devices of the present invention;

FIGS. 35a-35e depict views of another exemplary ground spike suitable for use in the fishing rod anchoring devices of the present invention;

FIGS. 36a-36e depict views of another exemplary ground spike suitable for use in the fishing rod anchoring devices of the present invention;

FIGS. 37a-37d depict views of an exemplary ground spike extension rod suitable for use in the fishing rod anchoring devices of the present invention;

FIGS. 38a-38d depict views of other exemplary fishing rod anchoring devices of the present invention;

FIGS. 39a-39b depict views of exemplary fishing rod anchoring devices of the present invention utilizing the exemplary ground spike extension rod shown in FIGS. 37a-37d;

FIGS. 40a-40b depict views of other exemplary fishing rod anchoring devices of the present invention;

FIGS. 40c-40d depict views of other exemplary fishing rod anchoring devices of the present invention in the form of removable fishing rod handles;

FIGS. 41a-41e depict views of an exemplary anchor chassis suitable for use in the fishing rod anchoring devices of the present invention;

FIGS. 42a-42e depict views of an exemplary swing clamp suitable for use in the fishing rod anchoring devices of the present invention;

FIGS. 43a-43d depict views of other exemplary fishing rod anchoring devices of the present invention;

FIGS. 44a-44b depict views of an exemplary fishing rod anchoring device of the present invention utilizing the exemplary swing clamp shown in FIGS. 42a-42e;

FIGS. 45a-45e depict views of an exemplary fishing rod anchor device handle shell suitable for use in the fishing rod anchoring devices of the present invention;

FIGS. 46a-46g depict views of a conventional (known) fishing rod blank and other conventional (known) fishing rod components;

FIGS. 47a-47e depict views of fishing rod components of the present invention in combination with a conventional (known) fishing rod blank;

FIGS. 48a-48b depict views of a conventional (known) fishing rod and reel;

FIG. 49 depicts an exemplary fishing rod and reel of the present invention;

FIGS. 50a-52d depict views of exemplary interchangeable fishing rod handles (also referred to herein as “removable fishing rod handles”) of the present invention suitable for use with the fishing rod reel seats of the present invention;

FIGS. 53a-53e depict views of an exemplary fishing rod reel seat of the present invention having external and internal threads for connecting one or more removable fishing rod handles thereto;

FIGS. 54a-54d depict views of the exemplary fishing rod reel seat of FIGS. 53a-53e in combination with an exemplary finger rest component;

FIGS. 55a-55c depict views of another exemplary fishing rod reel seat of the present invention having external threads for connecting one or more removable fishing rod handles having corresponding internal threads thereto; and

FIG. 56 depicts a view of exemplary removable fishing rod handles of the present invention in combination with an exemplary fishing rod reel seat of the present invention.

### DETAILED DESCRIPTION OF THE INVENTION

The present invention is directed to fishing rod components and methods of making and using fishing rod components. In particular, the present invention is directed to fishing rod components including, but not limited to, fishing rod anchoring devices (FRAs), fishing rod reel seats, and removable fishing rod handles connectable to one or more of the disclosed fishing rod reel seats.

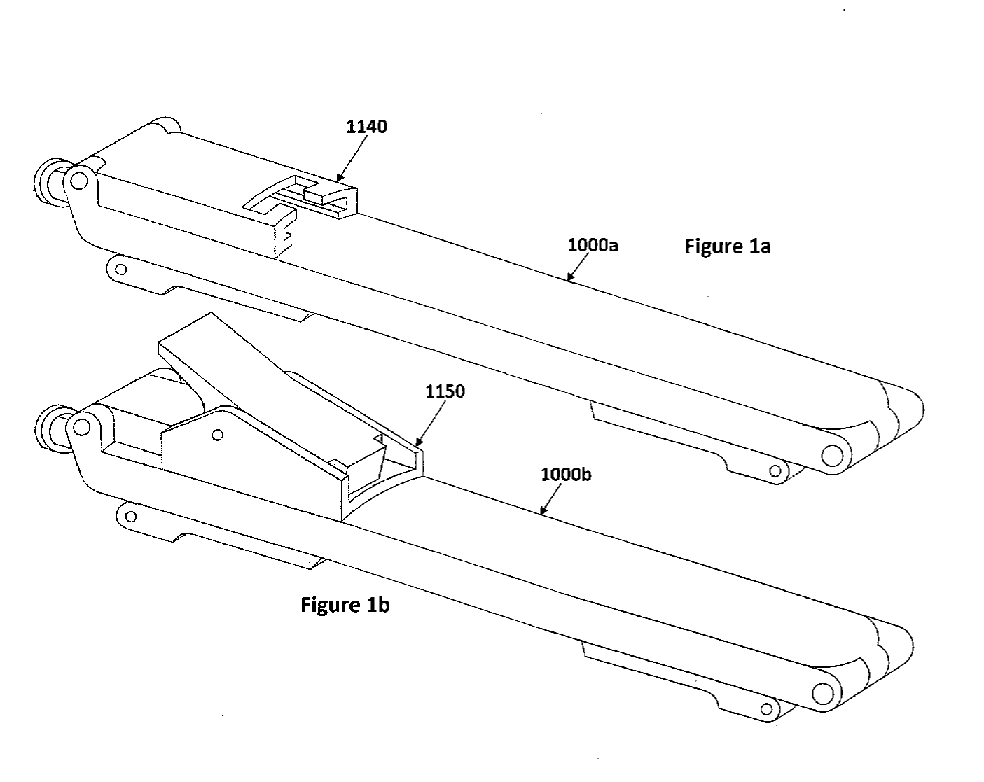

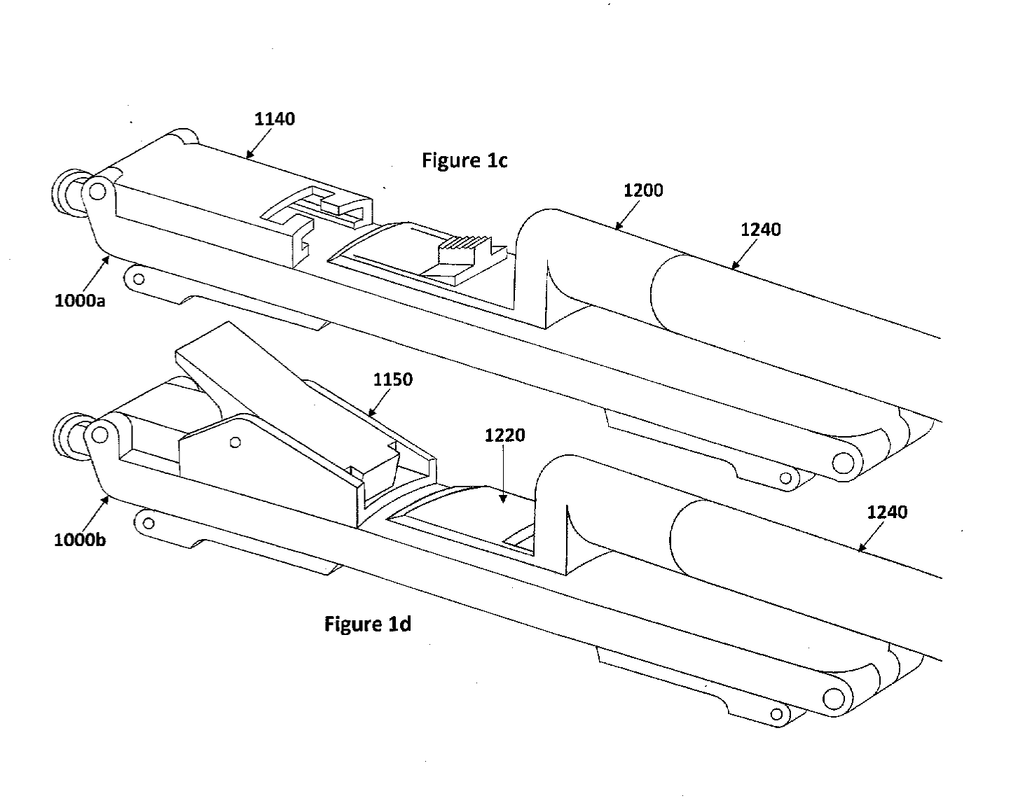

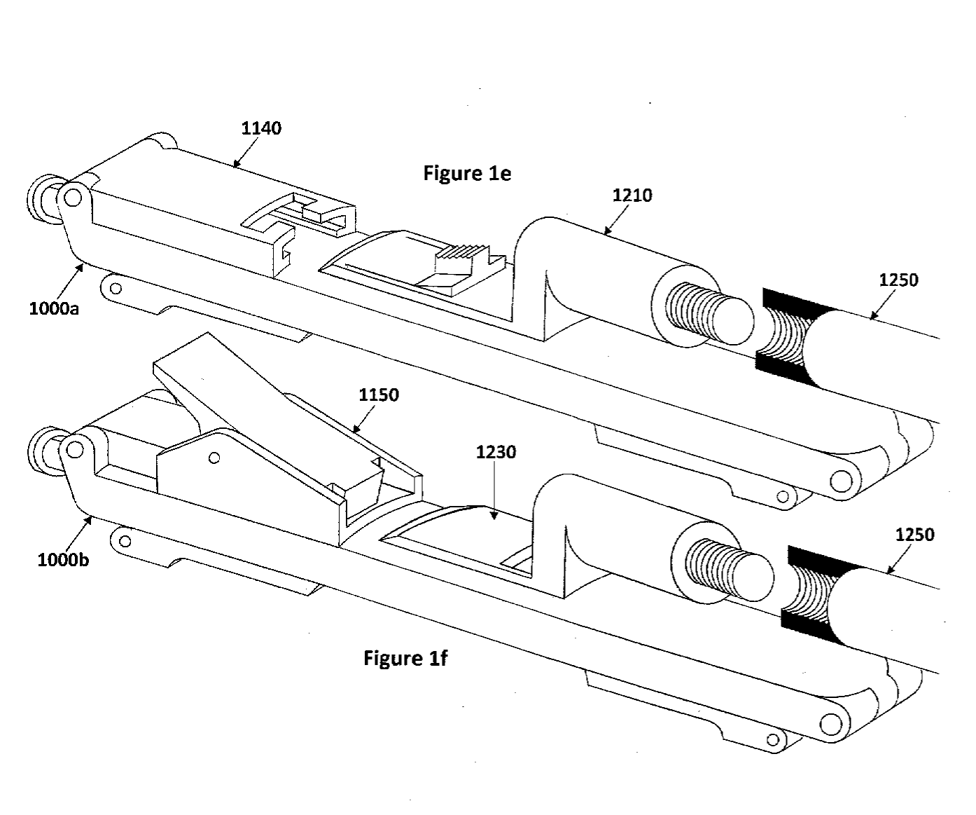

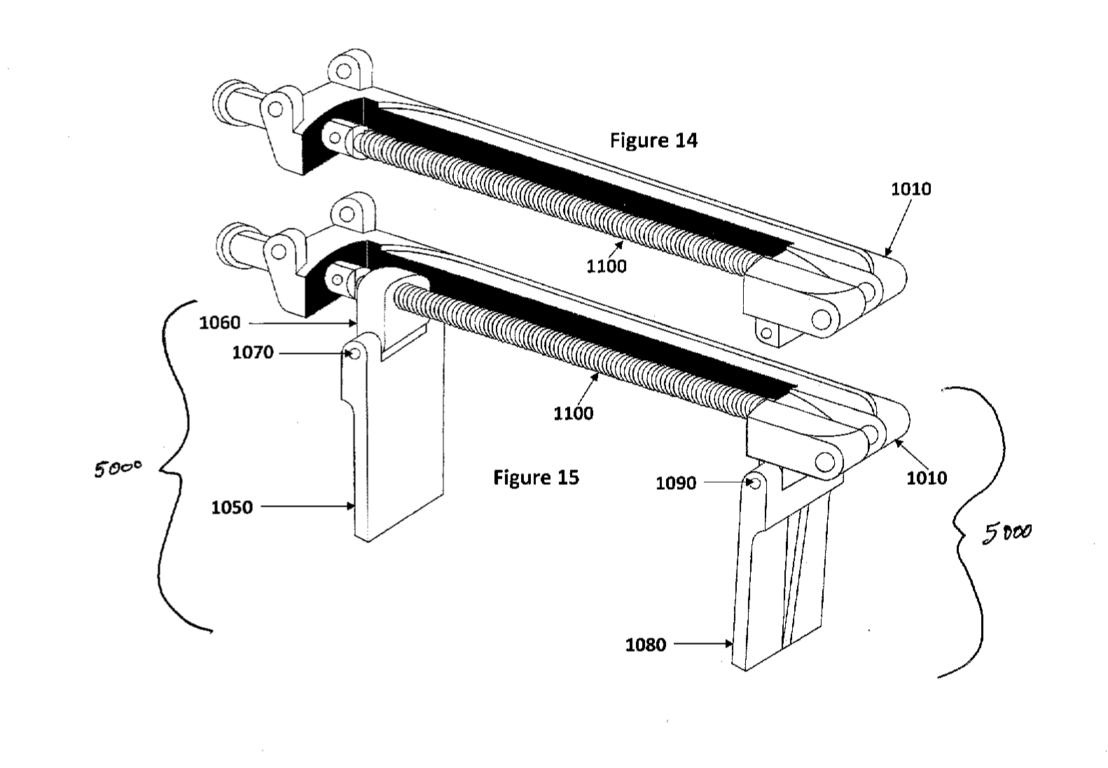

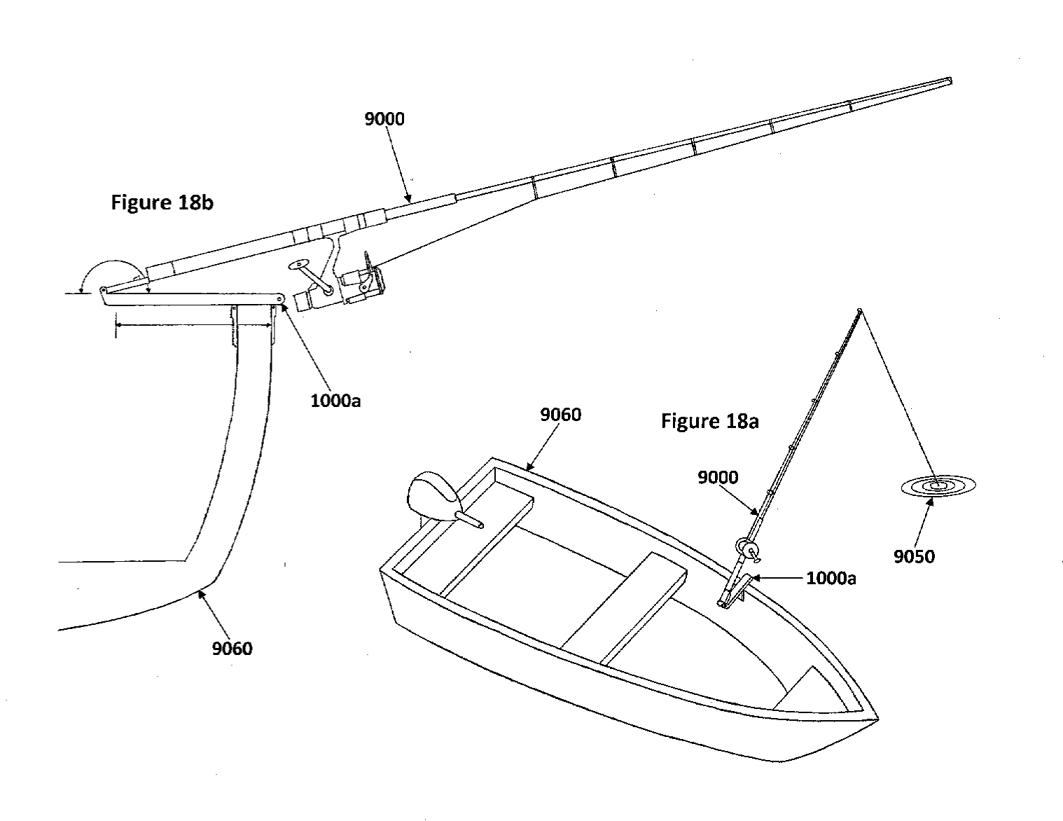

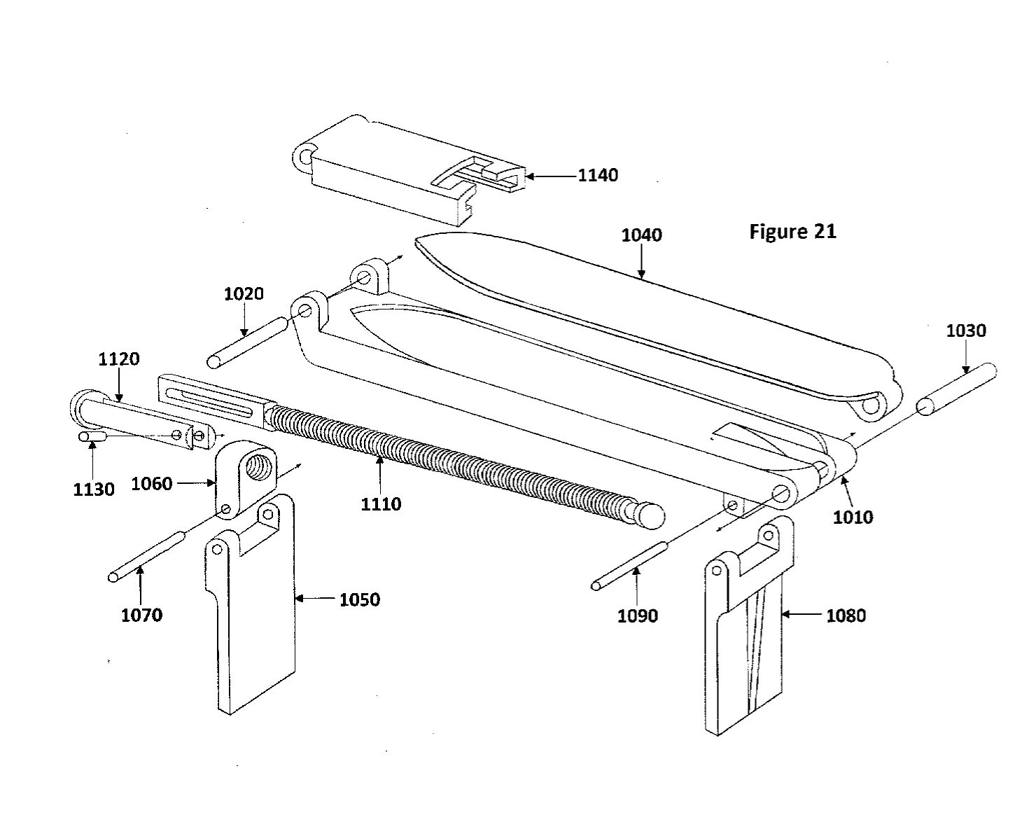

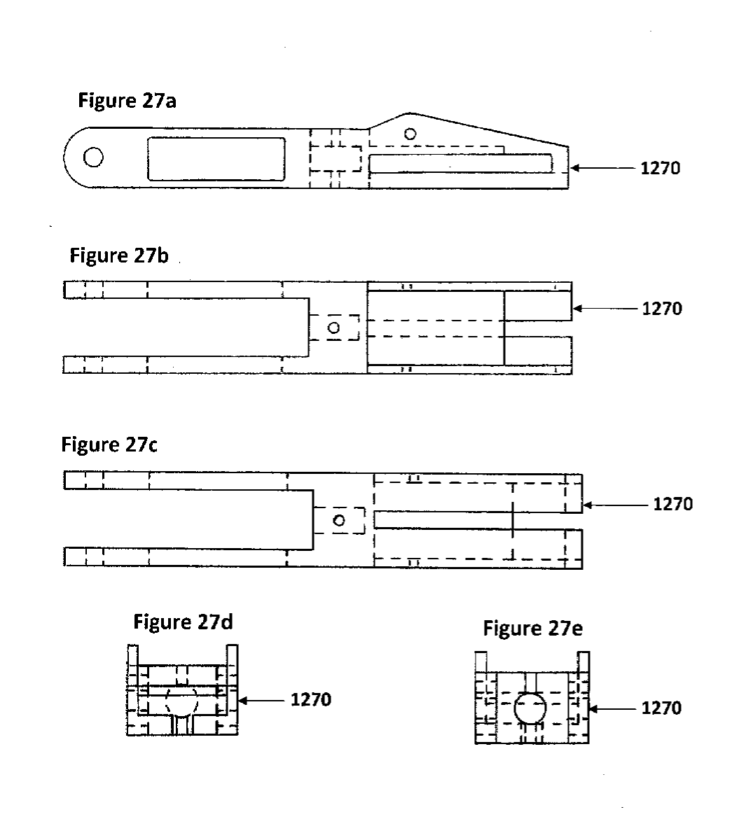

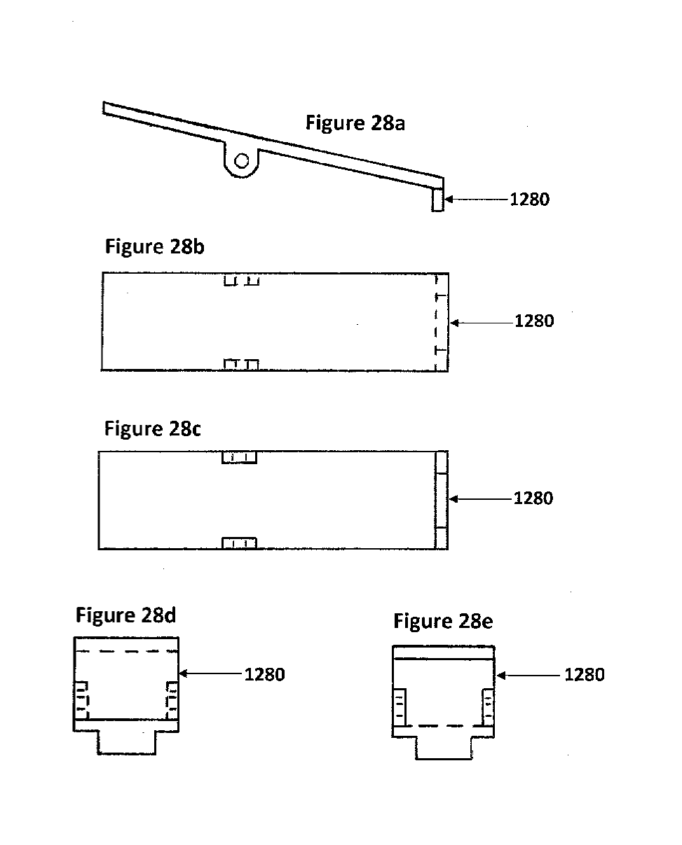

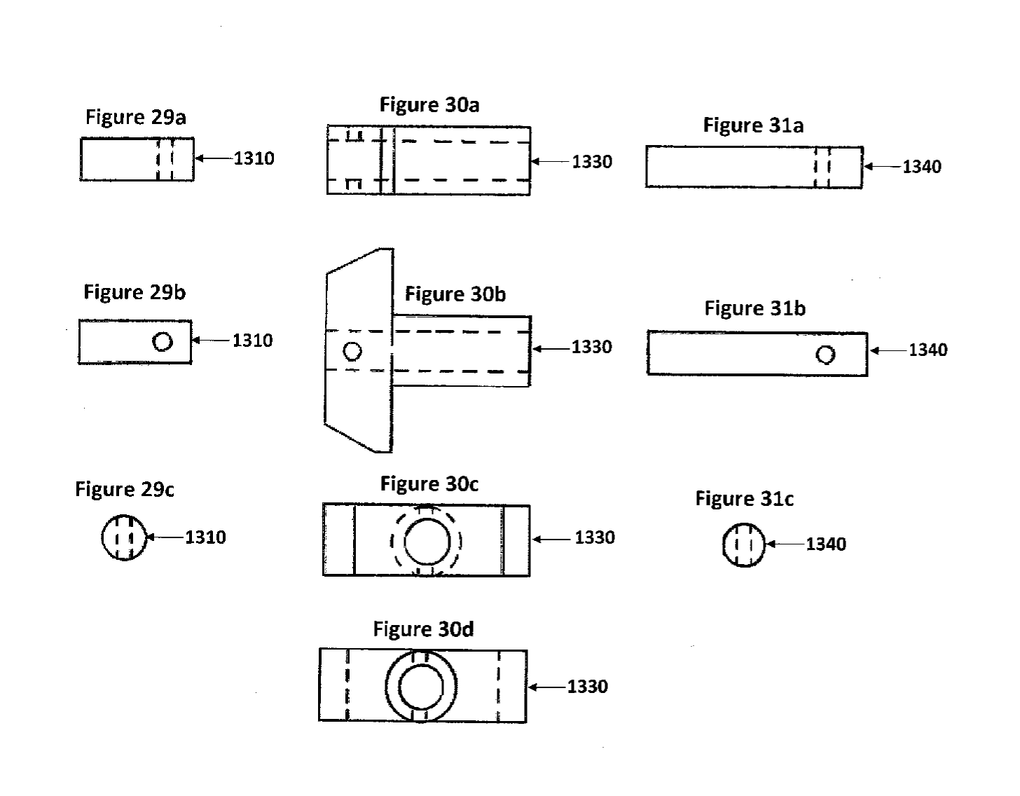

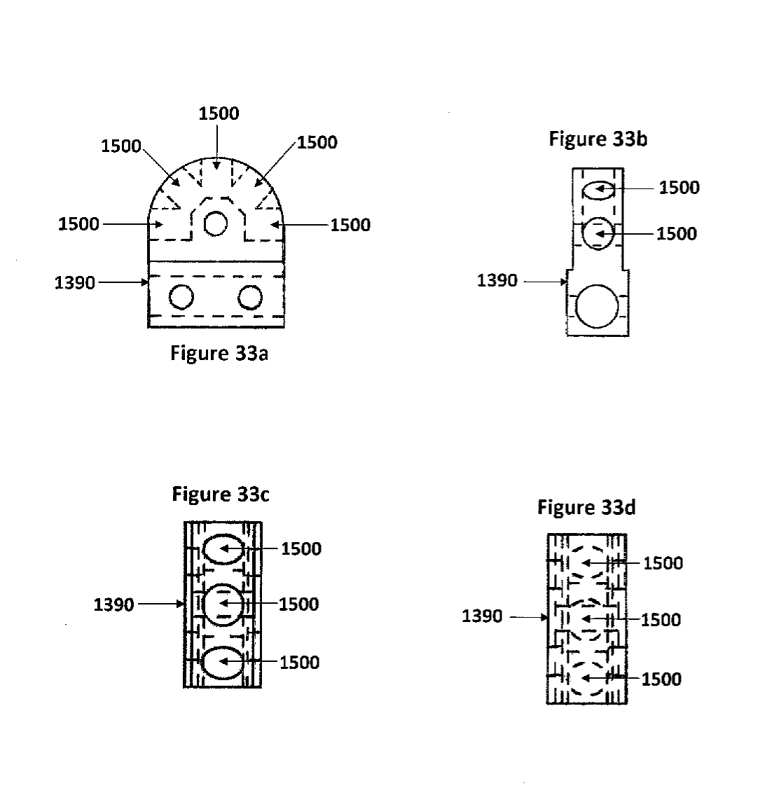

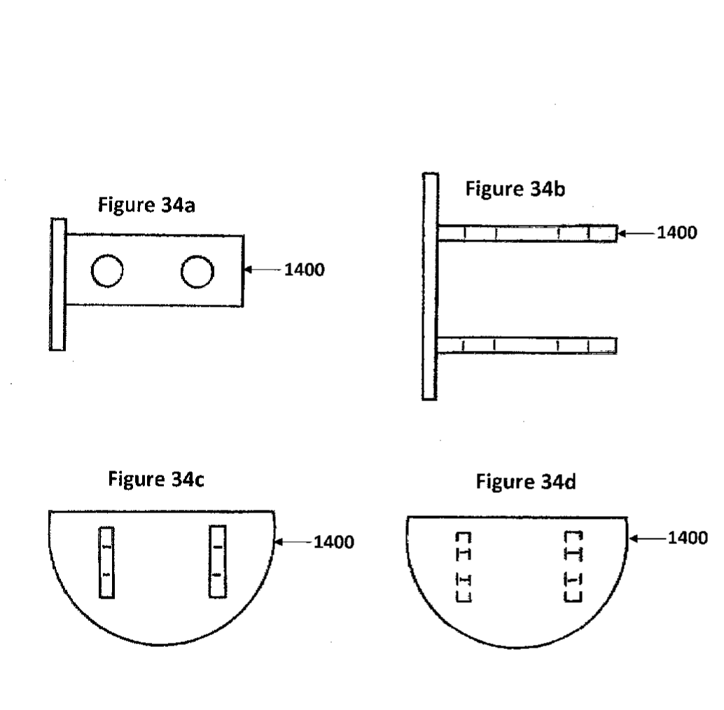

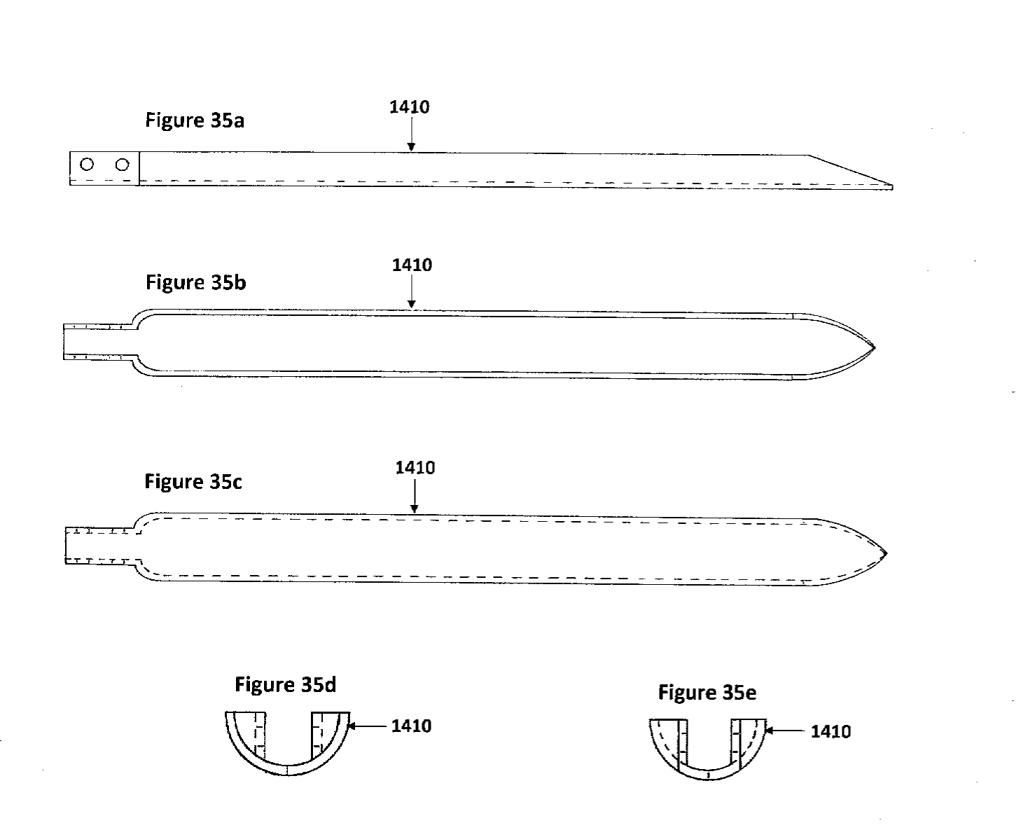

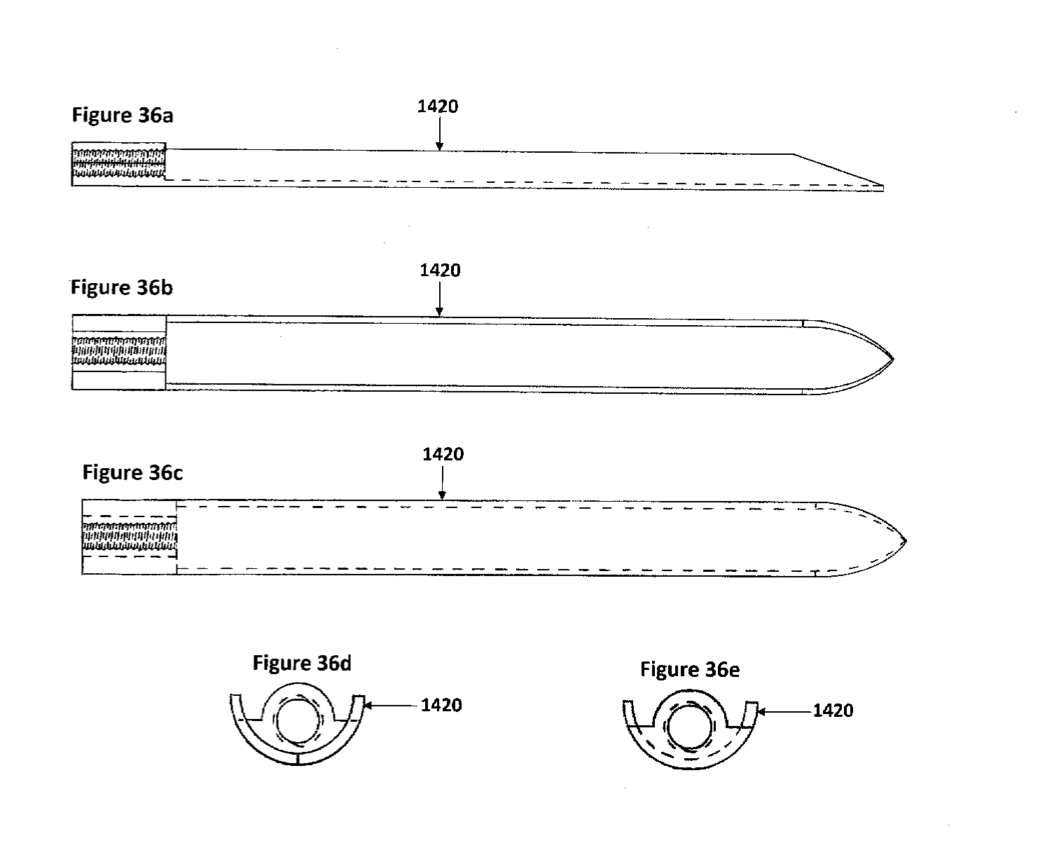

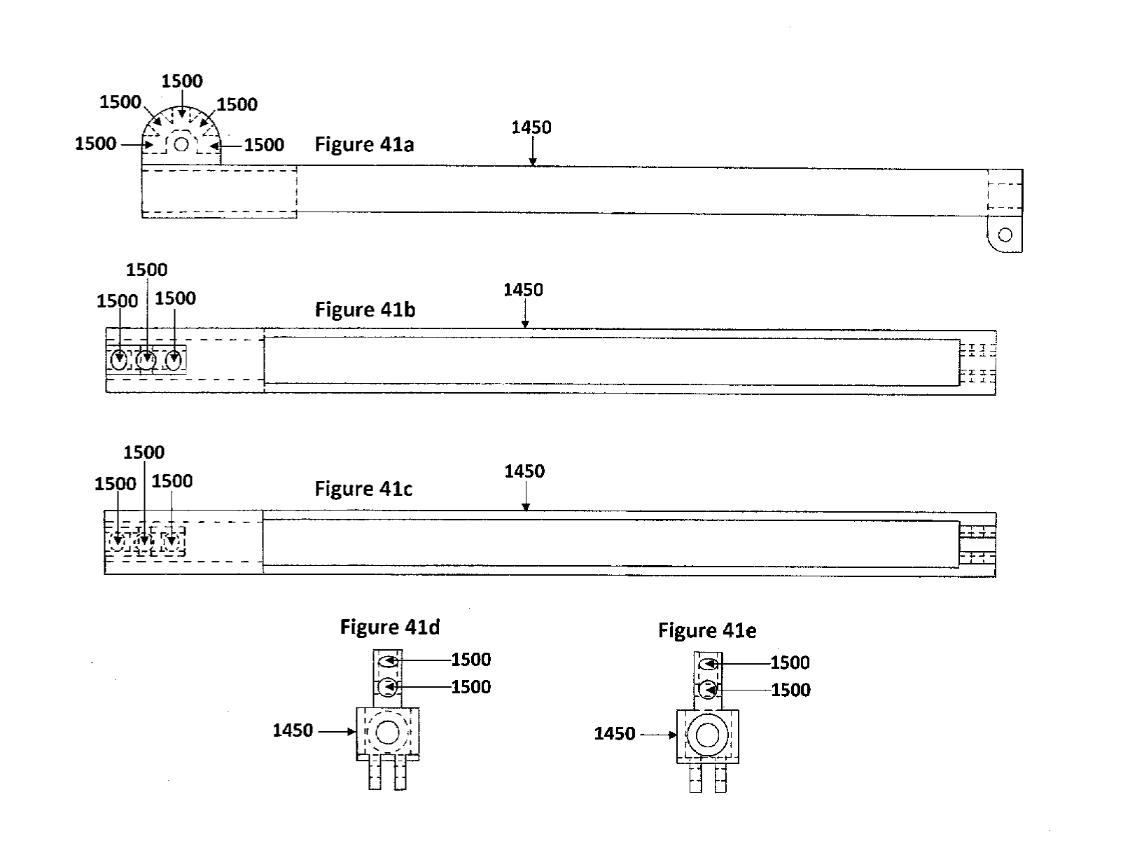

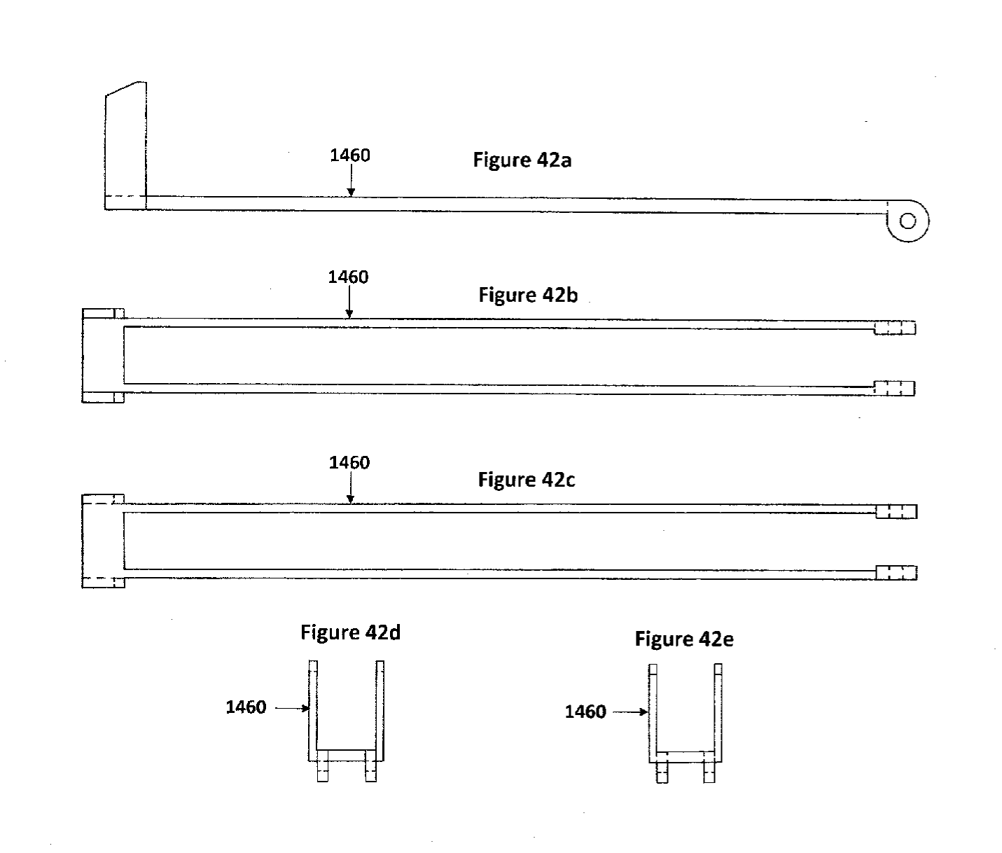

The present invention is directed to fishing rod anchoring devices (FRAs). A number of Fishing Rod Anchors (FRAs) are disclosed and described herein and as shown in FIGS. 1a to 45e and 56, two of which are referred to as (1) the Fishing Rod Anchor (Type 1) and (2) the Fishing Rod Anchor (Type 2). The Fishing Rod Anchor (Type 2) is further referred to herein as the Concealed Fishing Rod Anchor because it conceals the FRA within a fishing rod handle to conceal its view creating a more streamlined and aesthetically pleasing appearance.

In some embodiments of the present invention, the FRA comprises one or more of at least four main characteristics/features. First, the FRA of the present invention may comprise an adjustable clamp that allows the FRA to be attached to a dock, boat, etc. Second, the FRA of the present invention may comprise a ground spike, which allows the FRA to be secured to the ground. Third, the FRA of the present invention may comprise a Quick Release feature that allows the FRA to be separated from the fishing rod handle once a fish has been hooked and starts pulling on the fishing rod. Fourth, the FRA of the present invention may comprise the capability to be removed from the fishing rod in the form of an interchangeable fishing rod handle, which allows the user to change out fishing rod handles, at will, with no tools required.

The adjustable clamp may typically comprise an Adjustable Clamp Lever, Adjustable Clamp Lever Hinge, Adjustable Clamp Lever Hinge Pin, Static Clamp Lever, Static Clamp Lever Hinge Pin, and the Clamp Screw. The Clamp Screw typically comprises three parts: the Threaded Clamp Rod, Clamp Rod Handle, and the Clamp Rod Handle Hinge Pin. All of these components are connected to an Anchor Chassis. The Anchor Chassis is the main component of the FRA from which all other components are connected to either directly or indirectly. The ground spike typically comprises a Ground Spike and a Ground Spike Hinge Pin. These two components are also connected to the Anchor Chassis.

Although any type of quick release may be used on the disclosed FRA, there are two types of exemplary quick releases disclosed herein for use with the FRA, namely, the Rod Tongue Receiver (Type 1), and Rod Tongue Receiver (Type 2). The first typically comprises the Rod Tongue Receiver (Type 1) and the Rod Tongue Receiver Hinge Pin. The second typically comprises the Rod Tongue Receiver (Type 2) Chassis, Rod Tongue Receiver (Type 2) Quick Release, Rod Tongue Receiver (Type 2) Quick Release Spring, Rod Tongue Receiver (Type 2) Quick Release Hinge Pin, and the Rod Tongue Receiver Hinge Pin. Both the Rod Tongue Receiver (Type 1) and Rod Tongue Receiver (Type 2) along with all their components are connected to the Anchor Chassis.

The Fishing Rod Anchor (Type 1) and Fishing Rod Anchor (Type 2) differ in how they are attached to a fishing rod. The Fishing Rod Anchor (Type 1) attaches to a fishing rod handle via, for example, four different attachments. These are the Integrated Rod Tongue (Type 1), Threaded Rod Tongue (Type 1), Integrated Rod Tongue (Type 2), and Threaded Rod Tongue (Type 2). The Fishing Rod Anchor (Type 2) does not attach to a fishing rod handle; it is integrally formed as the fishing rod handle and it attaches to the fishing rod. The Fishing Rod Anchor (Type 2) is comprised of the Fishing Rod Anchor (Type 1) and an outer shell, which together form an entire fishing rod handle which is interchangeable and can be taken on and off a fishing rod depending on the user's preference. The outer shell used on the Fishing Rod Anchor (Type 2) is called the Fishing Rod Anchor (Type 2) Handle Shell. The Fishing Rod Anchor (Type 2) Handle Shell desirably has a threaded protrusion on its forward end, which connects to an opposing threaded end on the fishing rod. The advantage of having a removable fishing rod handle is that it allows the user to switch between the Fishing Rod Anchor (Type 1) and the Fishing Rod Anchor (Type 2).

As shown in FIGS. 1a to 45e and 56, and as discussed further below, fishing rod anchoring devices (such as exemplary FRA 1000a and 1000b shown in FIG. 1a-1b) may comprising an anchor chassis member 1010 (also referred to herein as “anchor chassis”); a fishing rod attaching component 1200/1220 operatively adapted and sized so as to attach the fishing rod anchoring device to a fishing rod 1240; a fishing rod attaching component locking mechanism 1140/1150 operatively adapted and sized to (i) lock the fishing rod attaching component 1200/1220 into a locked position relative to the anchor chassis member 1010, and (ii) unlock the fishing rod attaching component 1200/1220 from the locked position; and at least one of (1) an adjustable clamping assembly 5000 attached to the anchor chassis member 1010, the adjustable clamping assembly 5000 being operatively adapted and sized to clamp onto an object, and (2) a spike member 1040 attached to the anchor chassis member 1010, the spike member 1040 (a) being operatively adapted and sized to extend into soil, and (b) being movable from (i) a housed position within anchor chassis member 1010 to (ii) a use position outside of anchor chassis member 1010.

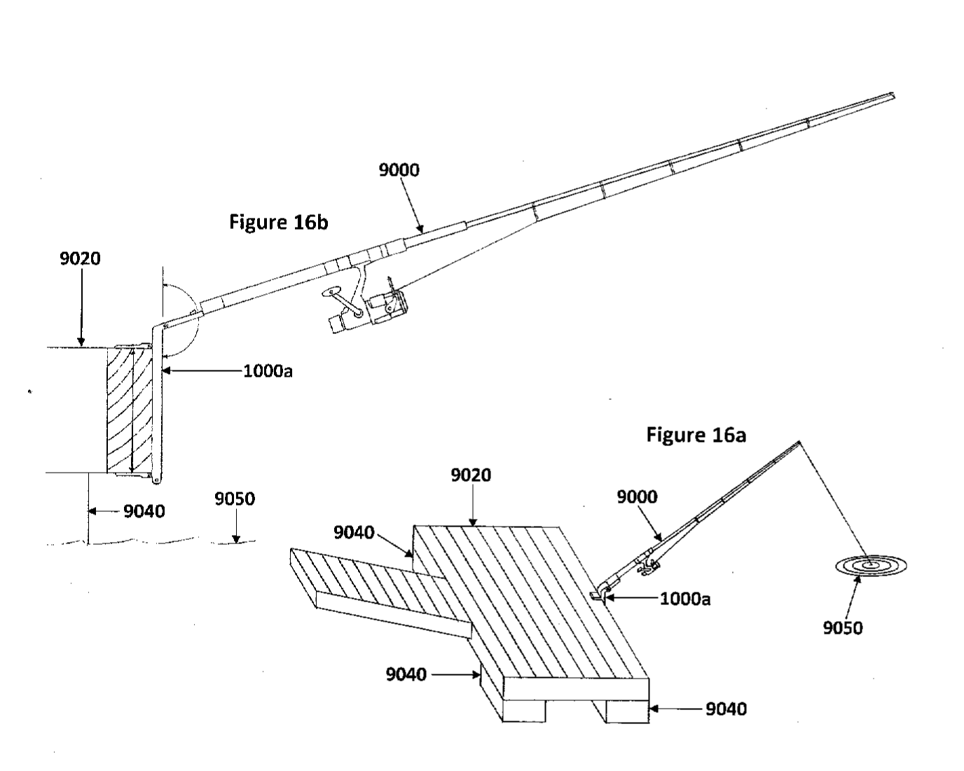

As shown in FIGS. 1a-1f, 4a-9g, 14-18b, 20a-22d, 24a-24b, 40a-44b and 56, in some embodiments, the fishing rod anchoring device of the present invention may comprises an adjustable clamping assembly 5000 attached to anchor chassis member 1010, wherein adjustable clamping assembly 5000 is operatively adapted and sized to clamp onto an object (e.g., a dock without rails, a dock with rails, a boat, etc.; see FIGS. 16a-18b). In one exemplary embodiment, shown in FIG. 15 and discussed further below, adjustable clamping assembly 5000 comprises, in combination, movable clamping lever/member 1050, static clamping lever/member 1080, and threaded clamping member rod 1100, along with other adjustable clamping assembly components described below.

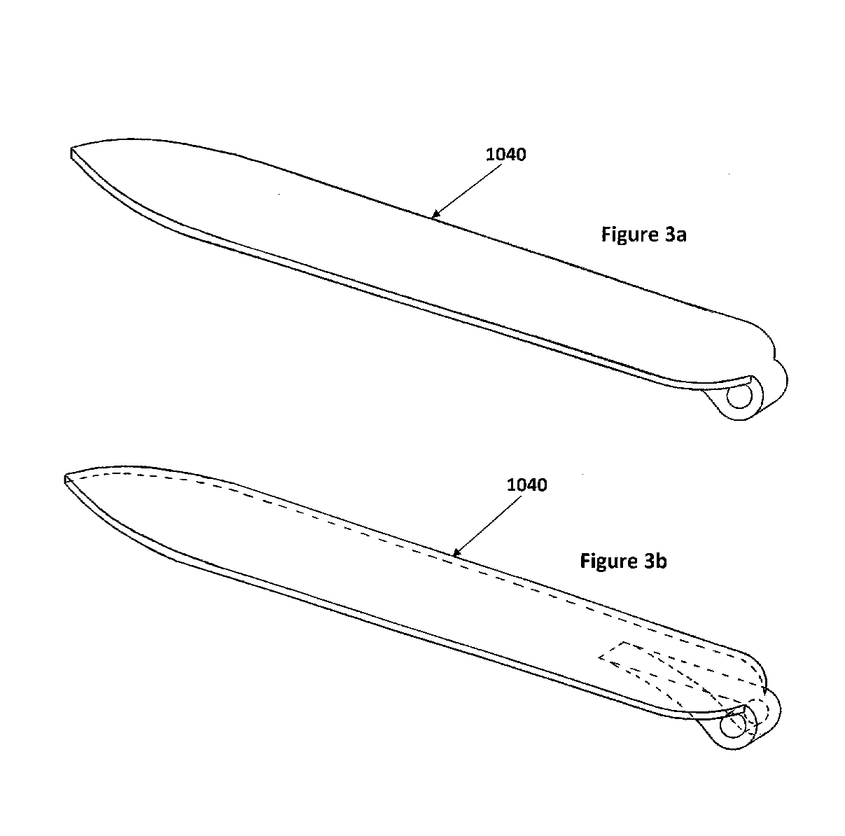

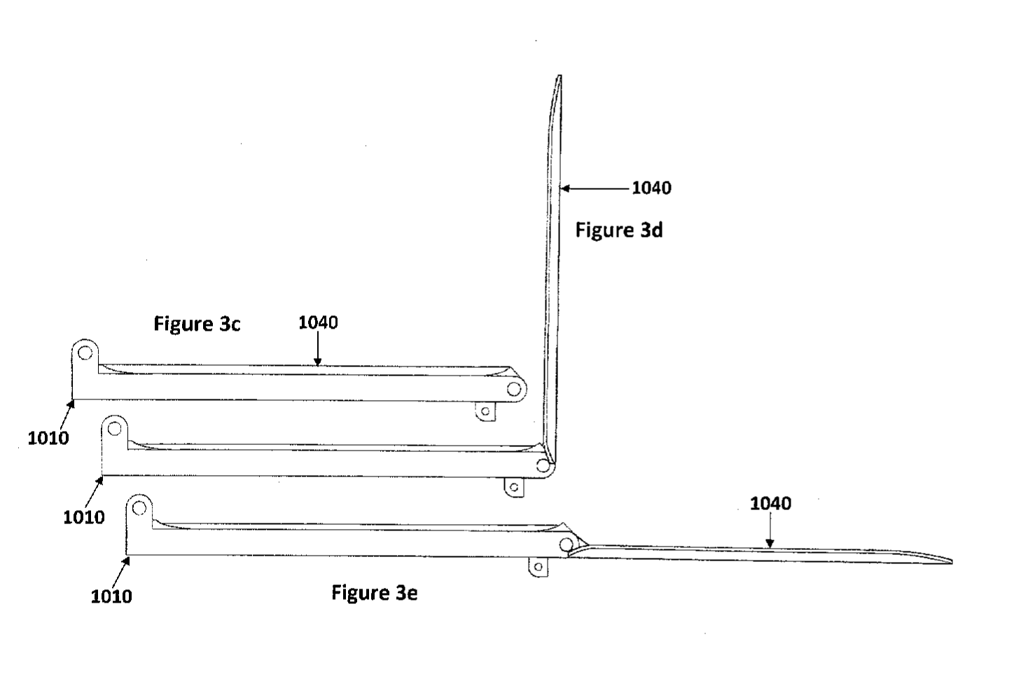

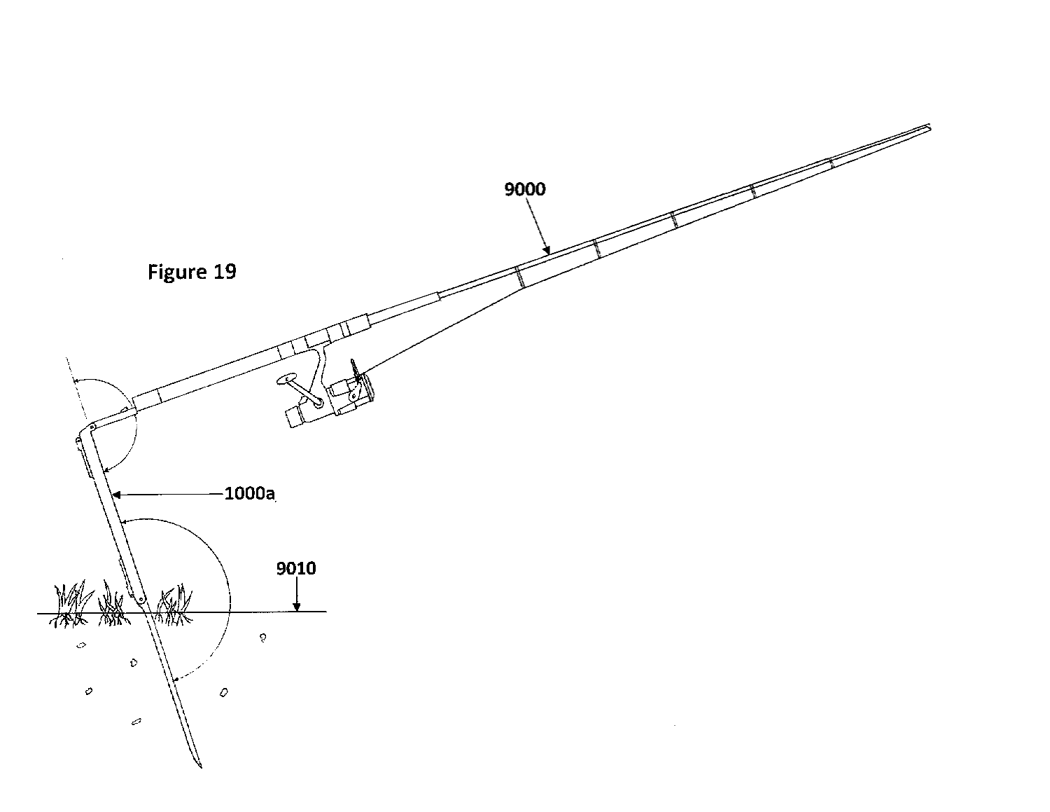

As shown in FIGS. 1a-3e, 4d-5b, 10c-10g, 11i-11m, 14-15, 19, 21, 25a-25b and 35a-39b, in some embodiments, the fishing rod anchoring device of the present invention may comprises a spike member 1040 attached to anchor chassis member 1010, wherein spike member 1040 (a) is operatively adapted and sized to extend into soil (e.g., ground 9010 shown in FIG. 19), and (b) (b) is movable from (i) a housed position (see, FIG. 3c) within anchor chassis member 1010 to (ii) a use position (see, FIG. 3e) outside of anchor chassis member 1010.

In some embodiments, the fishing rod anchoring device of the present invention comprises (1) adjustable clamping assembly 5000 attached to anchor chassis member 1010, wherein adjustable clamping assembly 5000 is operatively adapted and sized to clamp onto an object (e.g., a dock without rails, a dock with rails, a boat, etc.; see FIGS. 16a-18b); and (2) spike member 1040 attached to anchor chassis member 1010, wherein spike member 1040 (a) is operatively adapted and sized to extend into soil (e.g., ground 9010 shown in FIG. 19), and (b) (b) is movable from (i) a housed position (see, FIG. 3c) within anchor chassis member 1010 to (ii) a use position (see, FIG. 3e) outside of anchor chassis member 1010.

As shown, for example, in FIGS. 1a-1f, the fishing rod anchoring device of the present invention may comprise a fishing rod attaching component 1200/1220 comprises a quick release component 1140/1150 that attaches to a corresponding quick release component 1200/1220 on a fishing rod 1240.

Further, as discussed below, in some embodiments, the fishing rod anchoring device is a removable fishing rod handle 20 that is connectable to a fishing rod reel seat 8000a having (i) internal threads 87 extending along an interior cavity 88 of fishing rod reel seat 8000a, (ii) external threads 89 extending along an outer surface 801 of reel seat member 8000a, or (iii) both (i) and (ii).

As discussed herein and shown in the figures, the present invention relates to a securing or anchoring device, some of which are referred to herein as the Fishing Rod Anchor (Type 1), illustrated as 1000a and 1000b in FIG. 1a and FIG. 1b. The Fishing Rod Anchor (Type 1) 1000a and 1000b connects to and then secures a fishing rod to various objects including, but not limited to, the ground, docks, boats, etc.

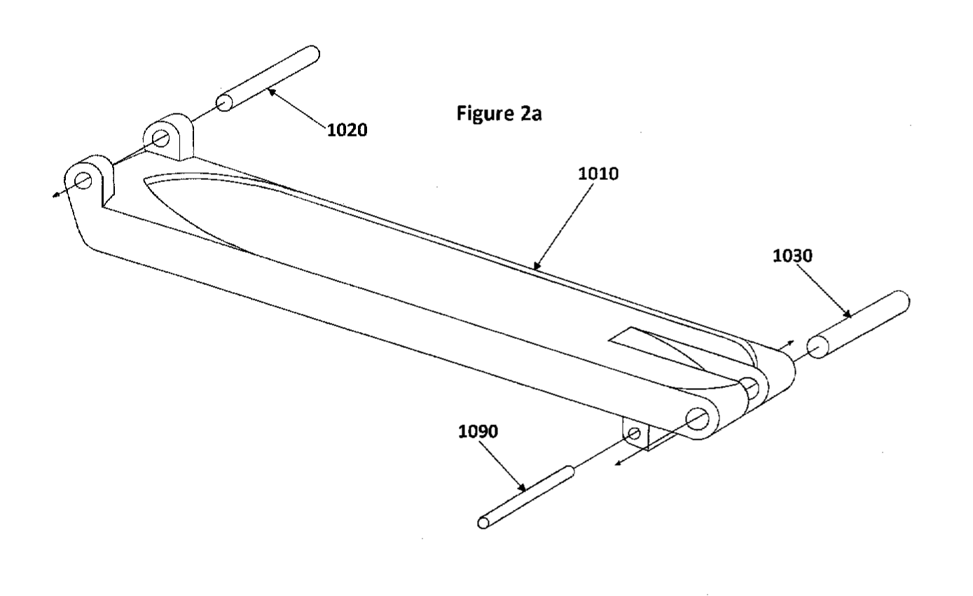

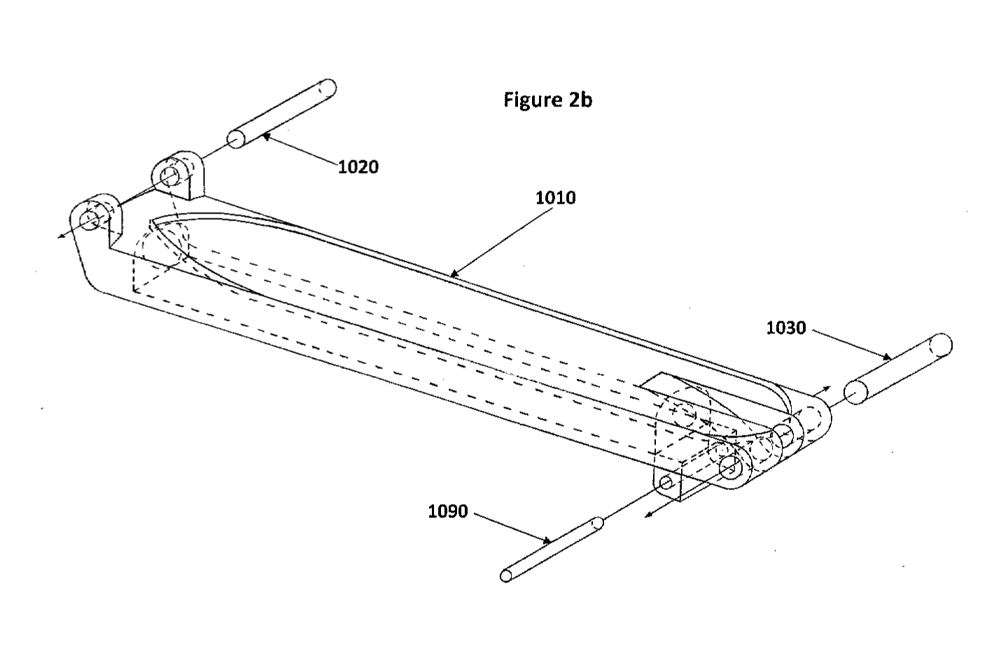

Each of the disclosed FRAs comprises anchor chassis member 1010 as shown, for example, in FIG. 2a. Anchor chassis member 1010 may be substantially rectangular and elongated, or any other desired shape. Anchor chassis member 1010 may, if desired, be cut, formed, or molded together into one solid, seamless, and uniform piece. The length and width of the anchor chassis member 1010 may be of any desired dimension to accommodate any one of the disclosed FRA types (e.g., ground spike 1040 and/or clamp assembly 5000). Anchor chassis member 1010 provides a main structure from which all other pieces are connected to form, for example, Fishing Rod Anchors (Type 1) 1000a and 1000b.

As discussed above, Fishing Rod Anchors (Type 1) 1000a and 1000b may comprise two securing devices. The first securing device is comprised of two parts, namely, ground spike 1040 shown in FIG. 3a, and ground spike hinge pin 1030 shown in FIG. 2a. Ground spike 1040 is the mechanism that secures Fishing Rod Anchor (Type 1) 1000a or 1000b into the ground 9010 as shown in FIG. 19. The ground 9010 may constitutes, for example, dirt, mud, sand, gravel, etc.

Ground spike 1040 may be substantially rectangular and elongated, or any other desired shape. Ground spike 1040 may, if desired, be cut, formed, or molded together into one solid, seamless, and uniform piece. The length and width of ground spike 1040 may be of any desired dimension to accommodate anchor chassis member 1010 and ground spike hinge pin 1030 while still meeting the requirements of securing the Fishing Rod Anchor (Type 1) 1000a or 1000b to ground 9010. Ground spike 1040 secures Fishing Rod Anchor (Type 1) 1000a or 1000b to ground 9010, while ground spike hinge pin 1030 secures ground spike 1040 to anchor chassis member 1010.

Ground spike hinge pin 1030 may be substantially circular or any other suitable cross-sectional shape. Ground spike hinge pin 1030 may, if desired, be cut, formed, or molded together into one solid, seamless, and uniform piece. The length and width of ground spike hinge pin 1030 may be of any desired dimension to accommodate the needs of securing ground spike 1040 to anchor chassis member 1010. Ground spike hinge pin 1030 (i) secures ground spike 1040 to anchor chassis member 1010, and (ii) allows ground spike 1040 to travel or rotate from a closed position at 0° (as illustrated in FIG. 3c) to a fully open position at 180° (as illustrated in FIG. 3e). While at 180°, ground spike 1040 may be locked into place and then inserted into ground 9010.

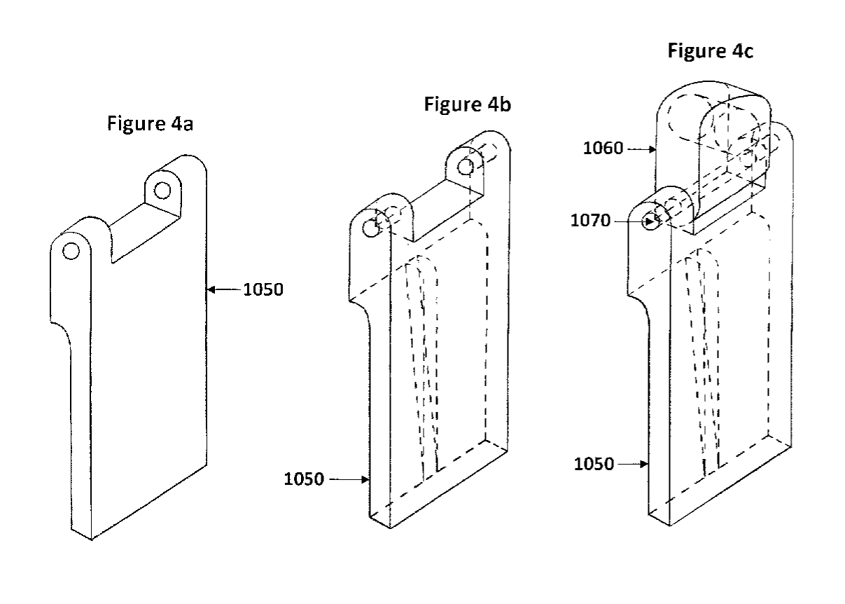

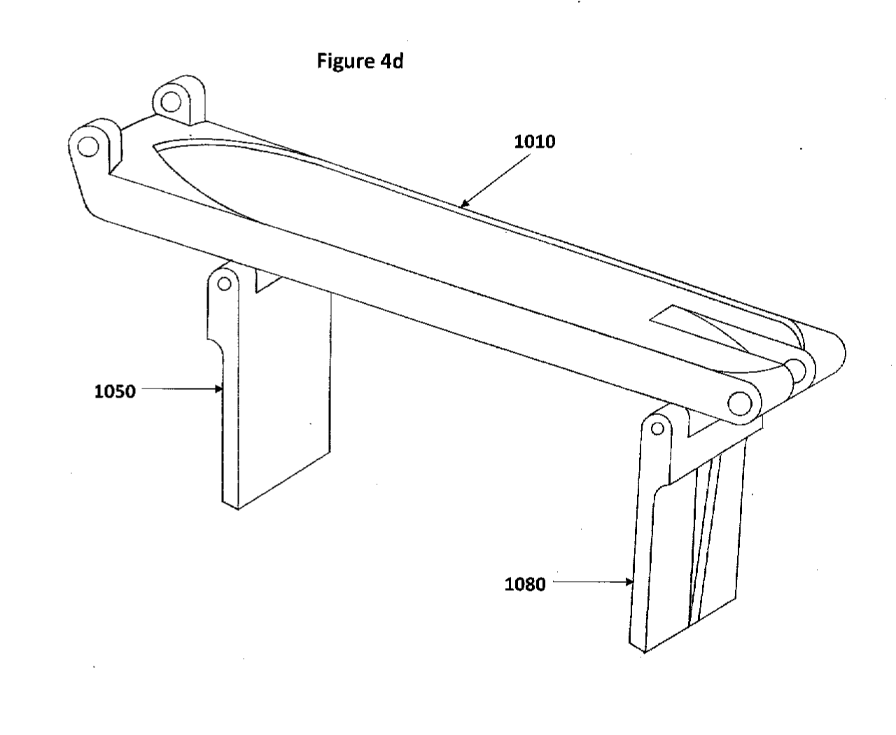

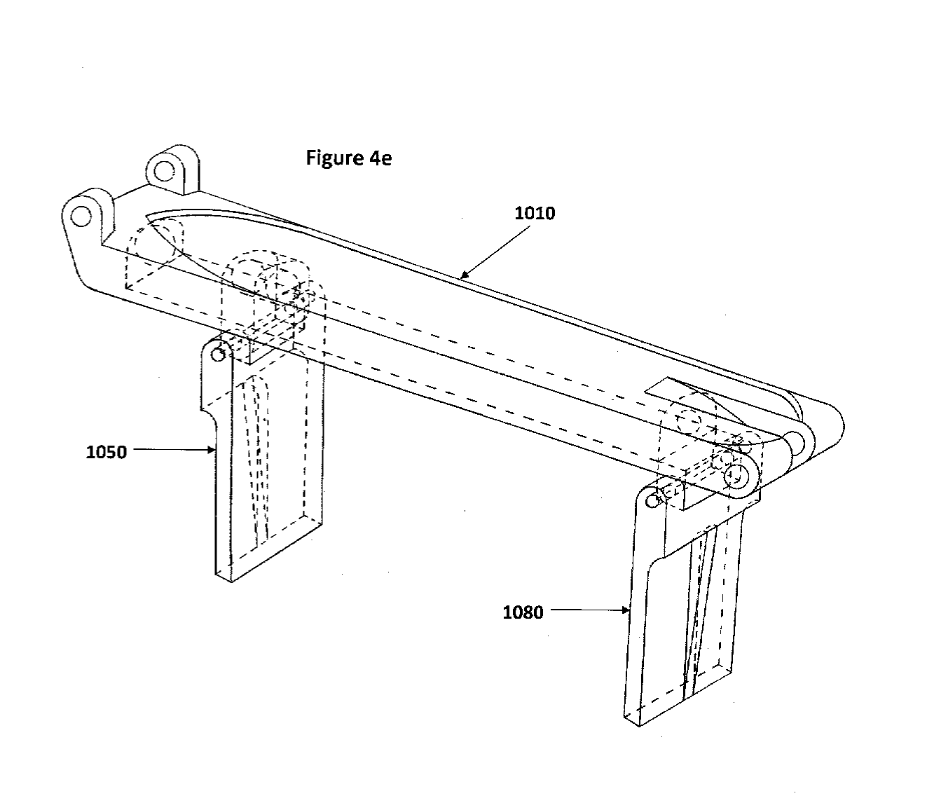

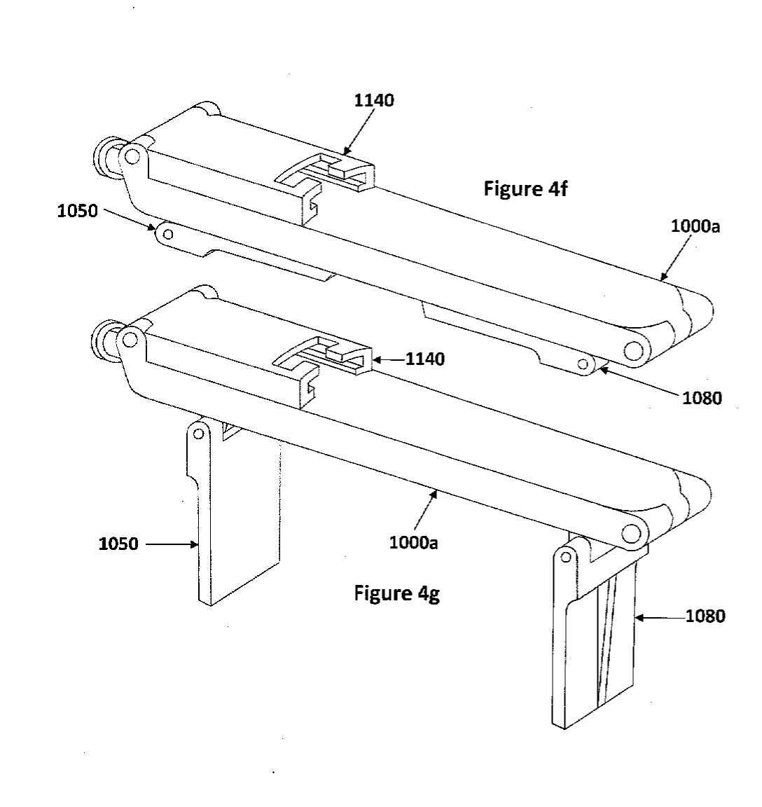

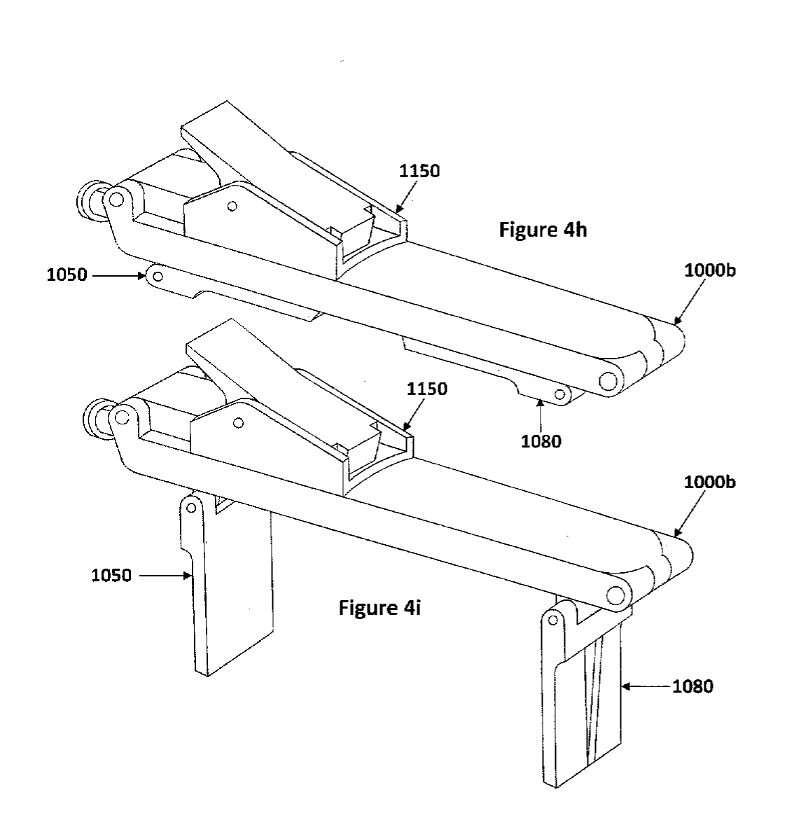

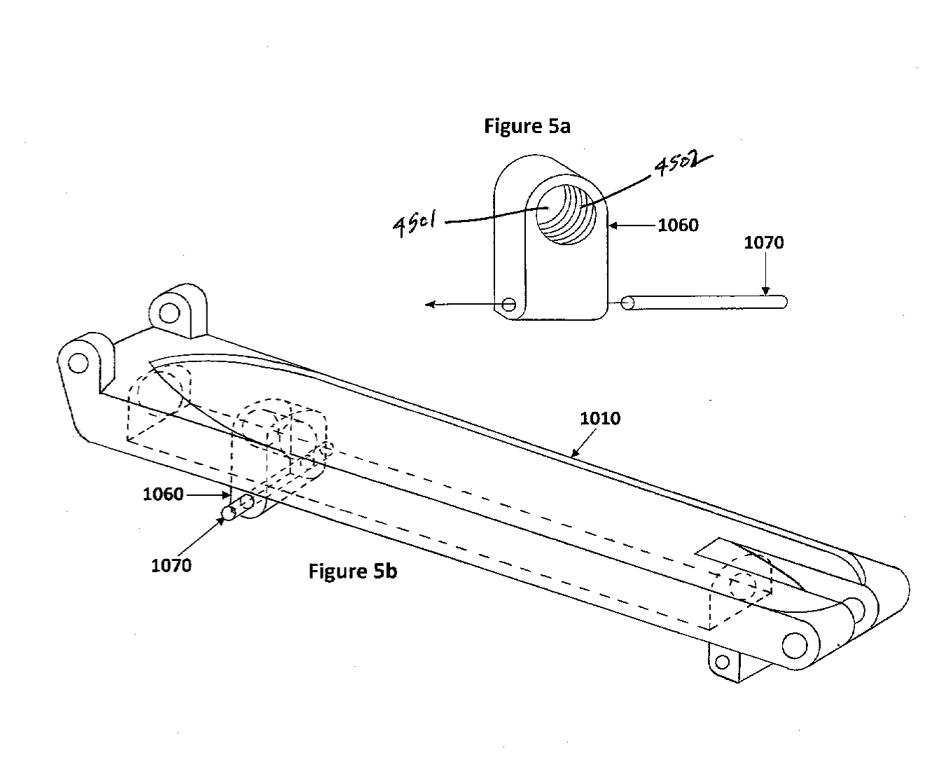

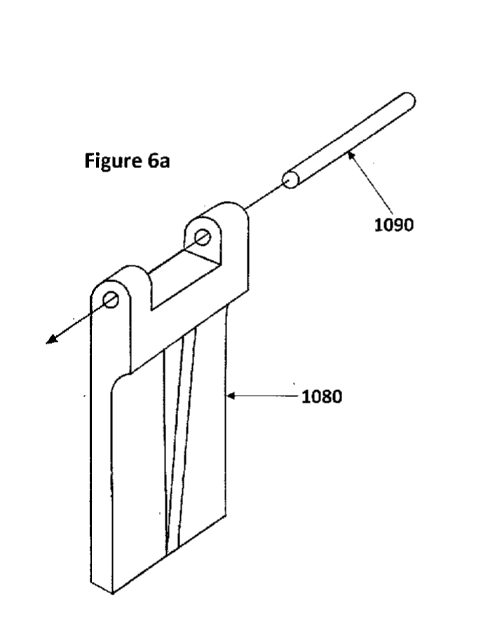

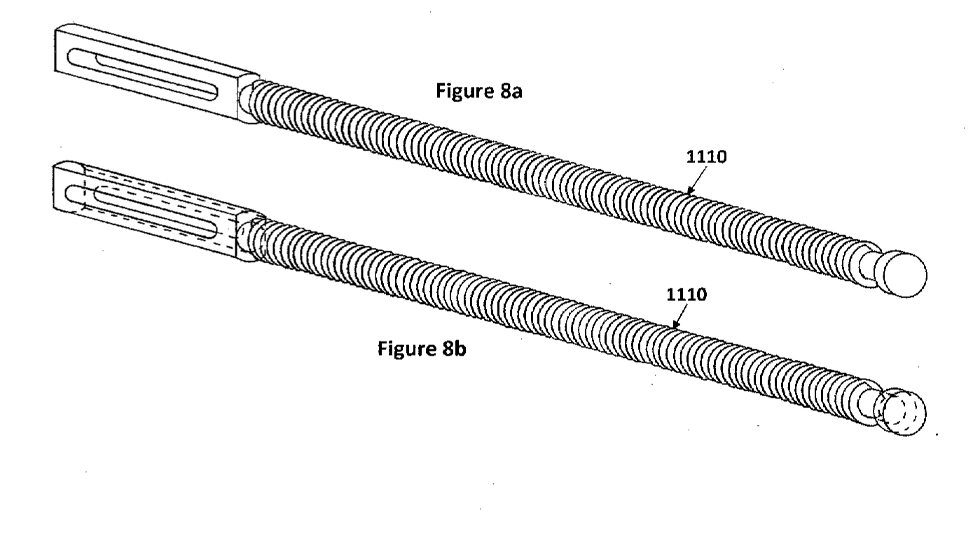

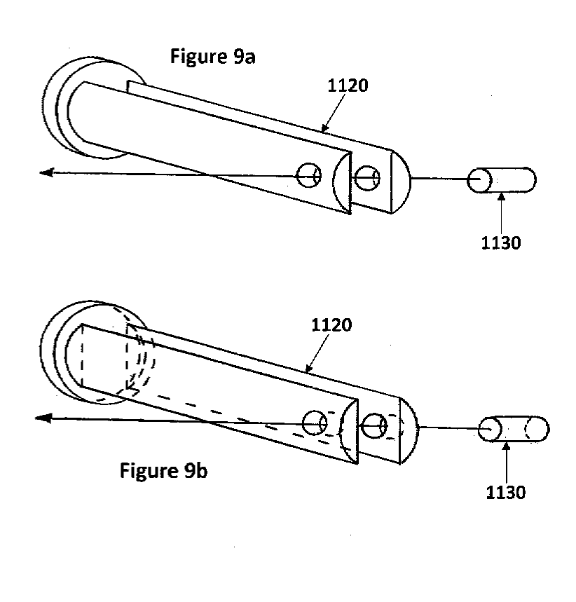

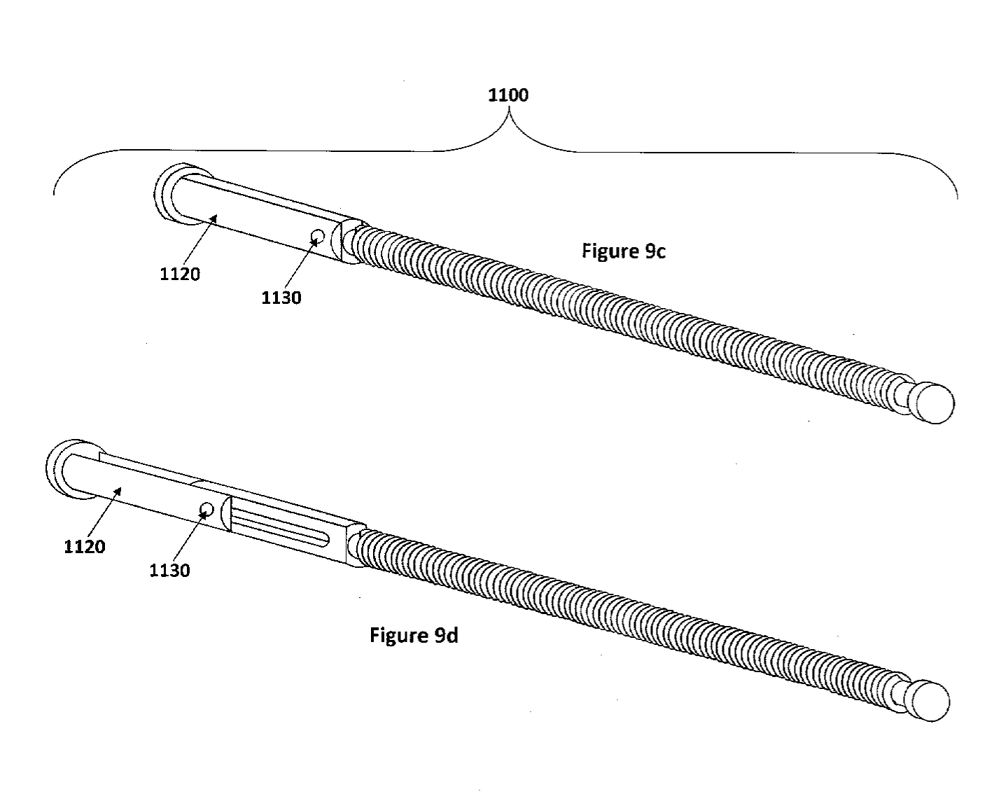

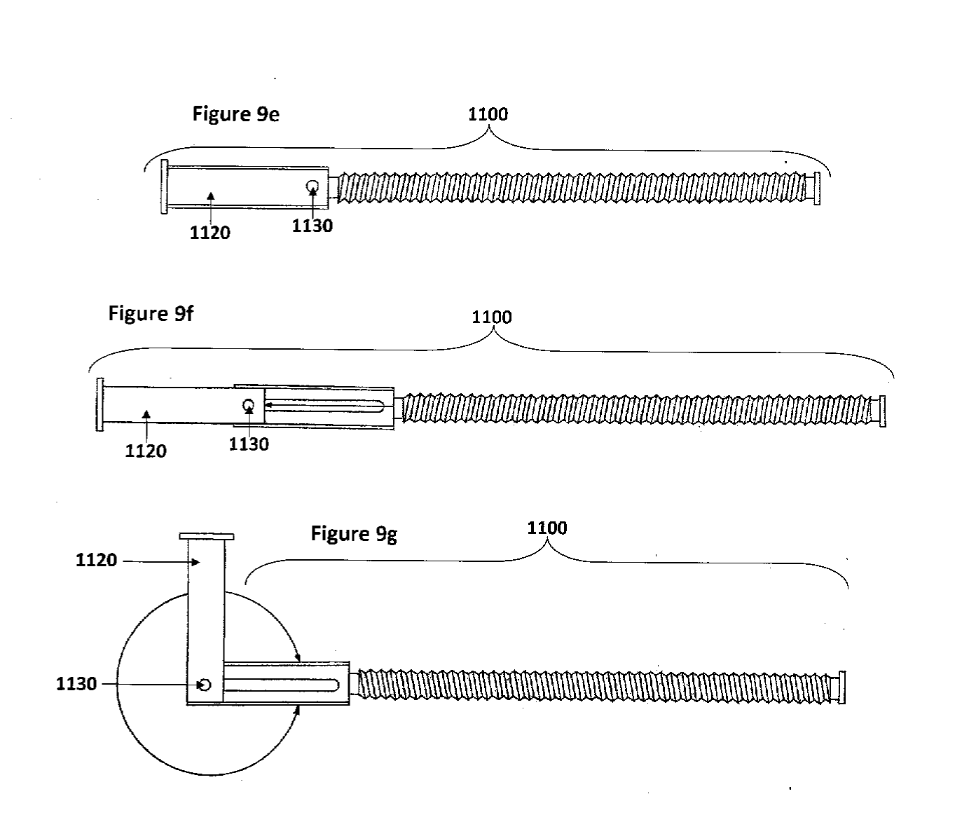

The second disclosed securing device is a clamping assembly 5000 comprising, for example, eight parts as shown in the figures. The first part is the threaded clamp rod 1110 shown in FIG. 8a. The second part is the clamp rod handle 1120 shown in FIG. 9a. The third part is the clamp rod handle hinge pin 1130 shown in FIG. 9a. The fourth part is the adjustable clamp lever hinge 1060 shown in FIG. 5a. The fifth part is the adjustable clamp lever 1050 shown in FIG. 4a. The sixth part is the adjustable clamp lever hinge pin 1070 shown in FIG. 5a. The seventh part is the static clamp lever 1080 shown in FIG. 6. The eighth part is the static clamp lever hinge pin 1090 shown in FIG. 6a.

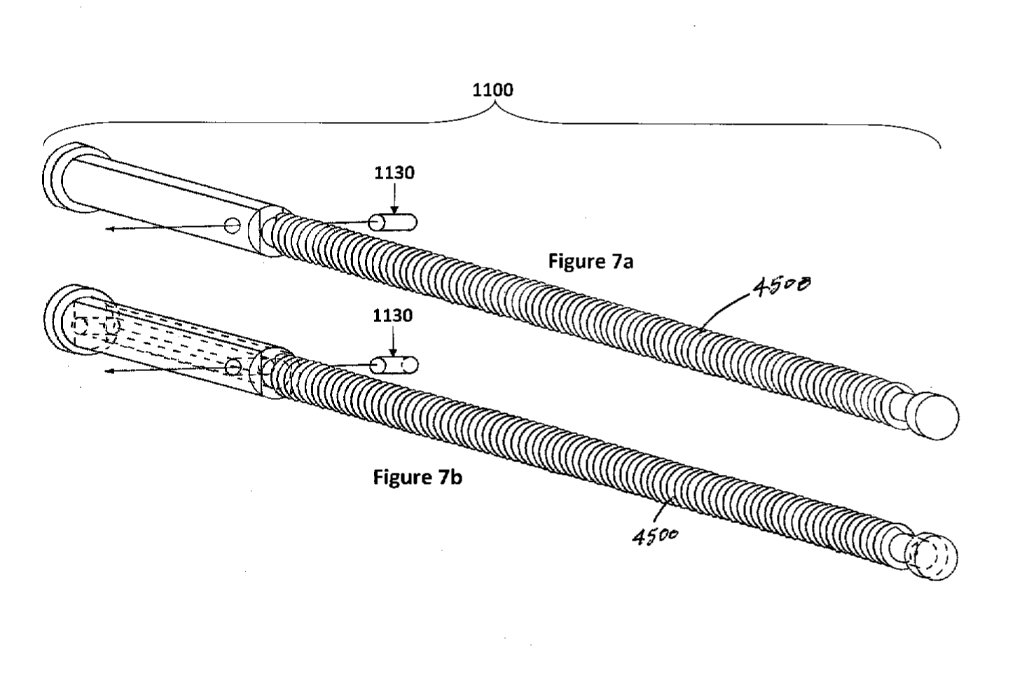

The first three parts, namely, threaded clamp rod 1110, clamp rod handle 1120, and clamp rod handle hinge pin 1130 together form the clamp screw 1100 shown in FIG. 7a.

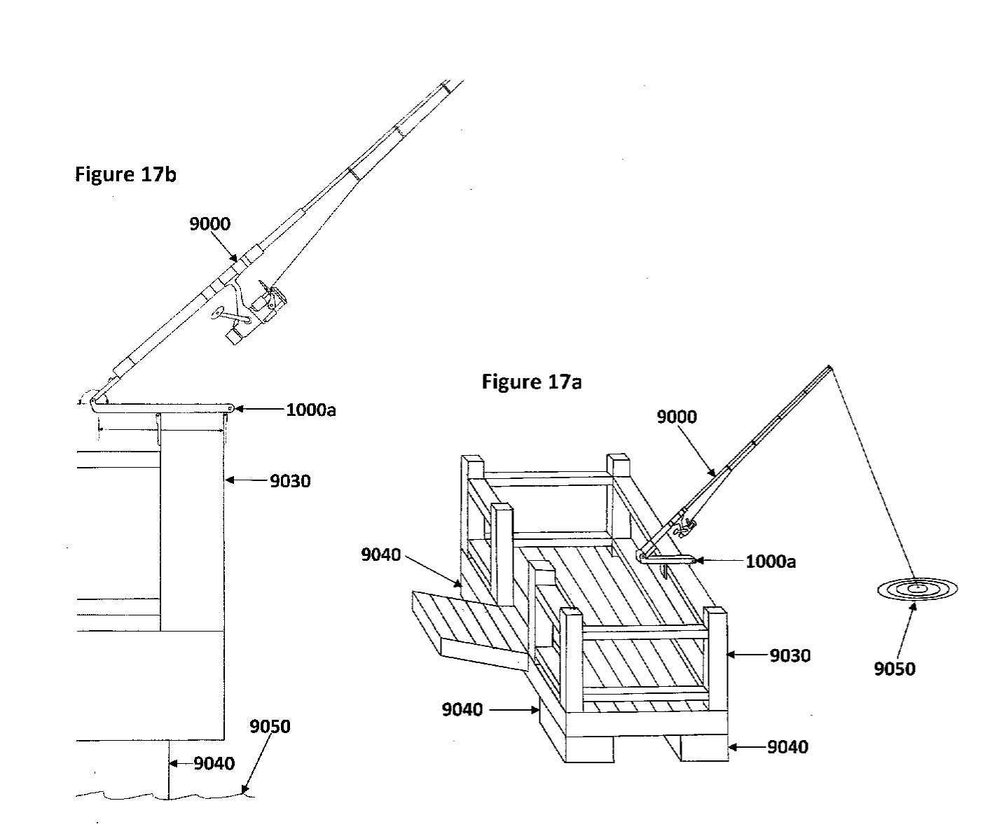

Threaded clamp rod 1110 may be substantially circular and elongated, or any other suitable shape. Threaded clamp rod 1110 may, if desired, be cut, formed, or molded together into one solid, seamless, and uniform piece. The length and width of threaded clamp rod 1110 may be of any desired dimension to accommodate the needs of securing clamp screw 1100 onto anchor chassis member 1010. Threaded clamp rod 1110 is threaded with threads 4500, to accept, but not limited to, standard and metric dimensions of all various sizes. Threaded clamp rod 1110 serves two purposes, namely, (1) to connect adjustable clamp lever hinge 1060, adjustable clamp lever/member 1050, and adjustable clamp lever hinge pin 1070 to anchor chassis member 1010, and (2) enable adjustable clamp lever hinge 1060 and adjustable clamp lever 1050 to traverse an entire horizontal length of anchor chassis member 1010 so as to (i) clamp onto an object positioned therebetween (see, for example, FIGS. 16a-17b) or (ii) disengage from an object positioned therebetween.

Clamp rod handle 1120 may be substantially round and elongated, or any other suitable shape. Clamp rod handle 1120 may, if desired, be cut, formed, or molded together into one solid, seamless, and uniform piece. The length and width of clamp rod handle 1120 may be of any desired dimension to accommodate threaded clamp rod 1110. Clamp rod handle 1120 serves to (i) retract backwards relative to threaded clamp rod 1110 (as illustrated in FIG. 9f), (ii) be positionable at the correct angle (e.g., usually 90° as illustrated in FIG. 9g), and (iii) be rotatable in a clockwise (or counterclockwise) direction so as to force adjustable clamp lever hinge 1060 and adjustable clamp lever 1050 to move forward (or backward) on threaded clamp rod 1110 to clamp onto an object (or disengage from an object).

Clamp rod handle hinge pin 1130 may be substantially round and elongated, or any other suitable shape. Clamp rod handle hinge pin 1130 may, if desired, be cut, formed, or molded together into one solid, seamless, and uniform piece. The length and width of the clamp rod handle hinge pin 1130 may be of any desired dimension to accommodate threaded clamp rod 1110 and clamp rod handle 1120. Clamp rod handle hinge pin 1130 serves two purposes, namely, (i) to connect clamp rod handle 1120 to threaded clamp rod 1110, and (ii) to allow clamp rod handle 1120 to move in a forward or backwards motion while connected to threaded clamp rod 1110 (see, for example, FIG. 9g).

Adjustable clamp lever hinge 1060 may be substantially round and elongated, or any other suitable shape. Adjustable clamp lever hinge 1060 may, if desired, be cut, formed, or molded together into one solid, seamless, and uniform piece. The length and width of adjustable clamp lever hinge 1060 may be of any desired dimension to accommodate threaded clamp rod 1110 and adjustable clamp lever 1050. Adjustable clamp lever hinge 1060 has a threaded hole 4501 with threads 4502 thereon to be engagable with threads 4500 on threaded clamp rod 1110. Threaded hole 4501 allows threaded clamp rod 1110 to pass therethrough so as to permit adjustable clamp Lever hinge 1060 to move along the horizontal axis of threaded clamp rod 1110 in a forward or backward motion (see, for example, FIG. 15). Adjustable clamp lever hinge 1060 serves two purposes, namely, (1) to connect adjustable clamp lever 1050 to threaded clamp rod 111 and indirectly to anchor chassis member 1010, and (2) enable adjustable clamp lever 1050 to move along the horizontal axis of threaded clamp rod 1110 in a forward or backward motion permitting it to clamp onto an object.

Adjustable clamp lever 1050 may be substantially rectangular and elongated, or any other suitable shape. Adjustable clamp lever 1050 may, if desired, be cut, formed, or molded together into one solid, seamless, and uniform piece. The length and width of adjustable clamp lever 1050 may be of any desired dimension to accommodate adjustable clamp lever hinge 1060. Adjustable clamp lever 1050 can rotate vertically from a fully closed position as shown in FIG. 4f to a fully open 90° position as shown in FIG. 4g. Adjustable clamp lever 1050 is typically stored in the closed position during transport or when not in use, and then is rotated to the open or 90° position when being used to clamp onto an object. Adjustable clamp lever 1050 also moves in a forward or backward motion along the horizontal axis of threaded clamp rod 1110 as shown in FIG. 15. Adjustable clamp lever 1050 permits fishing rod anchor (Type 1) 1000a or 1000b to clamp onto an object. Adjustable clamp lever 1050 is connected to adjustable clamp lever hinge 1060 by adjustable clamp lever hinge pin 1070 as shown in FIGS. 5a-5b and FIG. 15.

Adjustable clamp lever hinge pin 1070 may be substantially round and elongated, or any other suitable shape. Adjustable clamp lever hinge pin 1070 may, if desired, be cut, formed, or molded together into one solid, seamless, and uniform piece. The length and width of adjustable clamp lever hinge pin 1070 may be of any desired dimension to accommodate adjustable clamp lever 1050 and adjustable clamp lever hinge 1060. Adjustable clamp lever hinge pin 1070 has two purposes, namely, (1) to connect adjustable clamp lever 1050 to adjustable clamp lever hinge 1060, and (2) to allow adjustable clamp lever 1050 to rotate from a closed 0° position to a fully open 90° position.

Static clamp lever 1080 may be substantially rectangular and elongated, or any other suitable shape. Static clamp lever 1080 may, if desired, be cut, formed, or molded together into one solid, seamless, and uniform piece. The length and width of static clamp lever 1080 may be of any desired dimension. Static clamp lever 1080 can rotate vertically from a fully closed position shown in FIG. 4f to a fully open 90° position shown in FIG. 4g. Static clamp lever 1080 is typically stored in the closed position during transport or when not in use, and then is rotated to the open or 90° position when being used to clamp onto an object. °1080 remains stationary and does not move in a forward or backward motion along the horizontal axis of threaded clamp rod 1110. Static clamp lever 1080 enables Fishing Rod Anchor (Type 1) 1000a or 1000b to clamp onto an object. Static clamp lever 1080 is connected to anchor chassis member 1010 via static clamp lever hinge pin 1090.

Static clamp lever hinge pin 1090 may be substantially round and elongated, or any other suitable shape. Static clamp lever hinge pin 1090 may, if desired, be cut, formed, or molded together into one solid, seamless, and uniform piece. The length and width of static clamp lever hinge pin 1090 may be of any desired dimension to accommodate static clamp lever 1080 and anchor chassis member 1010. Static clamp lever hinge pin 1090 has two purposes, namely, (1) to connect static clamp lever 1080 to anchor chassis member 1010, and (2) to allow static clamp lever 1080 to rotate from a closed 0° position to a fully open 90° position.

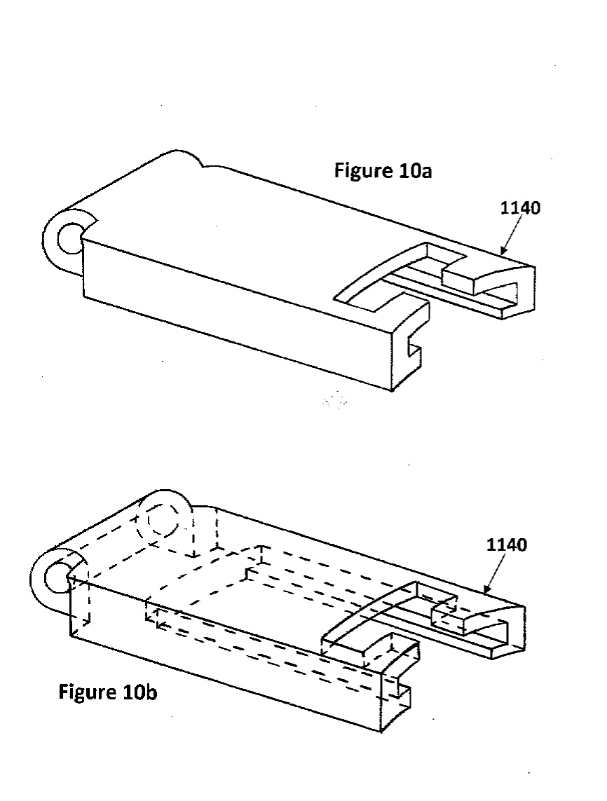

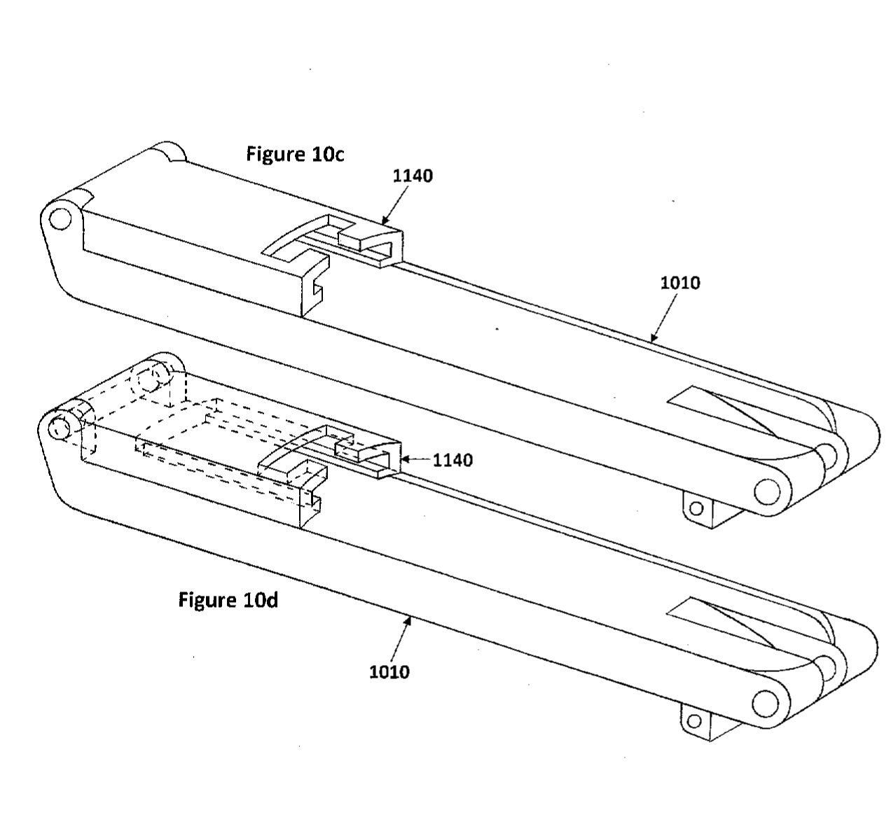

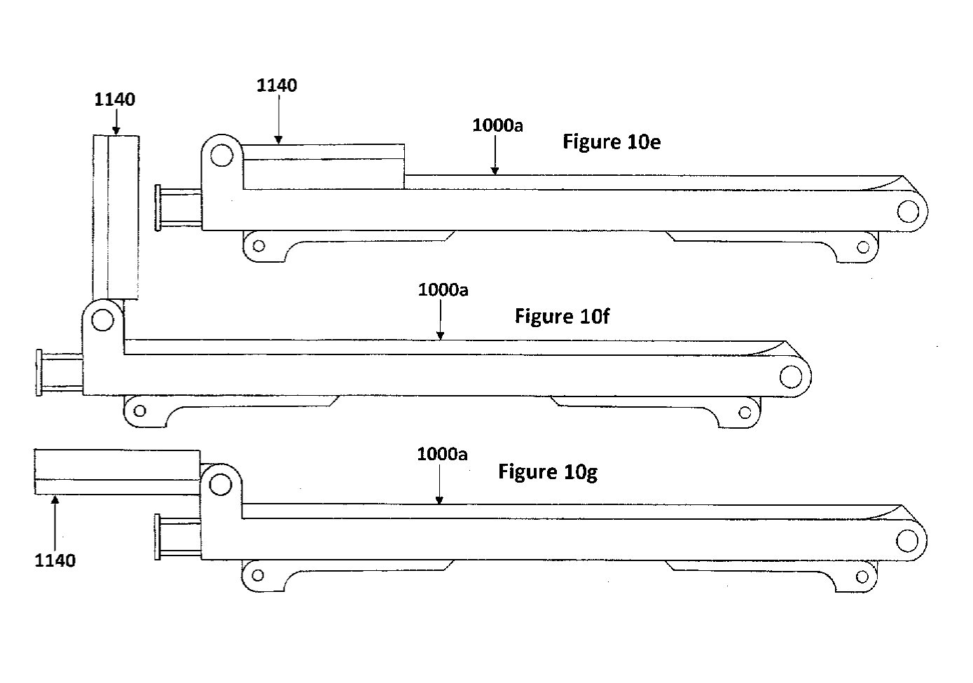

Fishing Rod Anchors (Type 1) 1000a and 1000b are similar in all respects except for the upper portion that connects Fishing Rod Anchor (Type 1) 1000a or 1000b to a fishing rod handle. This upper portion may consist of one of two types of receivers. The first receiver, the rod tongue receiver (Type 1) 1140 is shown in FIG. 10a (and also in FIGS. 1a, 1c and 1e).

Rod tongue receiver (Type 1) 1140 may be substantially rectangular and elongated, or any other suitable shape. Rod tongue receiver (Type 1) 1140 may, if desired, be cut, formed, or molded together into one solid, seamless, and uniform piece. The length and width of rod tongue receiver (Type 1) 1140 may be of any desired dimension to accommodate anchor chassis member 1010. Rod tongue receiver (Type 1) 1140 can rotate vertically from a fully closed position of 0° as shown in FIG. 10e to a fully open 180° position as shown in FIG. 10g. Rod tongue receiver (Type 1) 1140 is typically stored in the closed position during transport or when not in use, and then is rotated anywhere between 0° and 180° depending on the desired position as determined by the user when ready to be used. Rod tongue receiver (Type 1) 1140 permits Fishing Rod Anchor (Type 1) 1000a to be attached to a fishing rod handle. Rod tongue receiver (Type 1) 1140 is connected to anchor chassis member 1010 by rod tongue receiver hinge pin 1020 as shown in FIG. 2a).

Rod tongue receiver hinge pin 1020 may be substantially round and elongated, or any other suitable shape. Rod tongue receiver hinge pin 1020 may, if desired, be cut, formed, or molded together into one solid, seamless, and uniform piece. The length and width of rod tongue receiver hinge pin 1020 may be of any desired dimension to accommodate rod tongue receiver (Type 1) 1140 and anchor chassis member 1010. Rod tongue receiver hinge pin 1020 has two purposes, namely, (1) to connect rod tongue receiver (Type 1) 1140 to anchor chassis member 1010, and (2) to allow rod tongue receiver (Type 1) 1140 to rotate from a closed 0° position to a fully open 180° position (or any position therebetween).

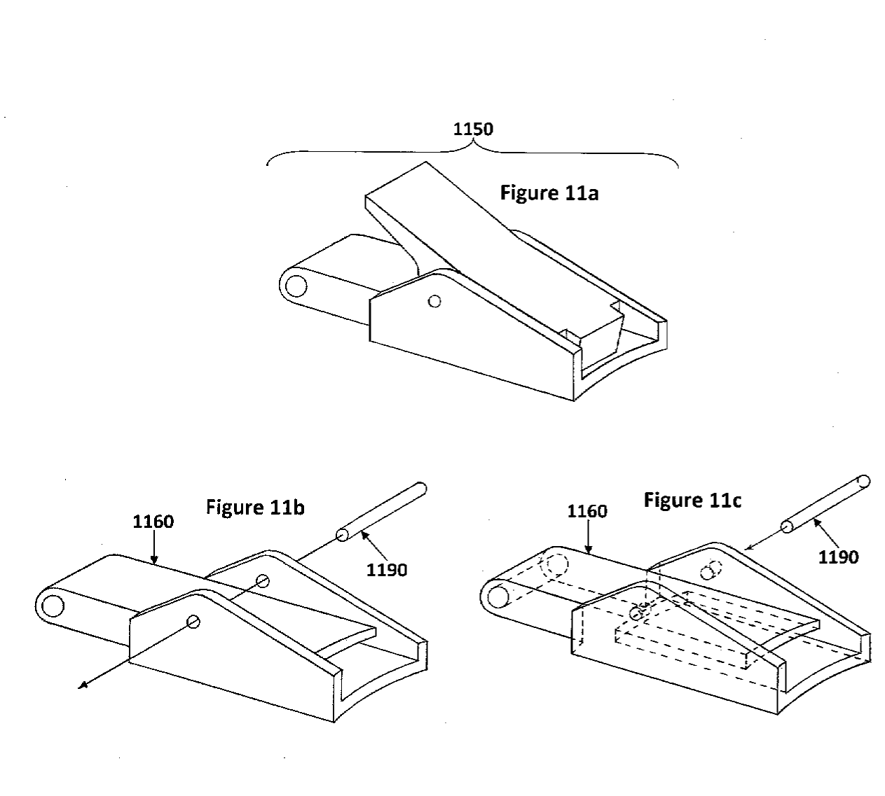

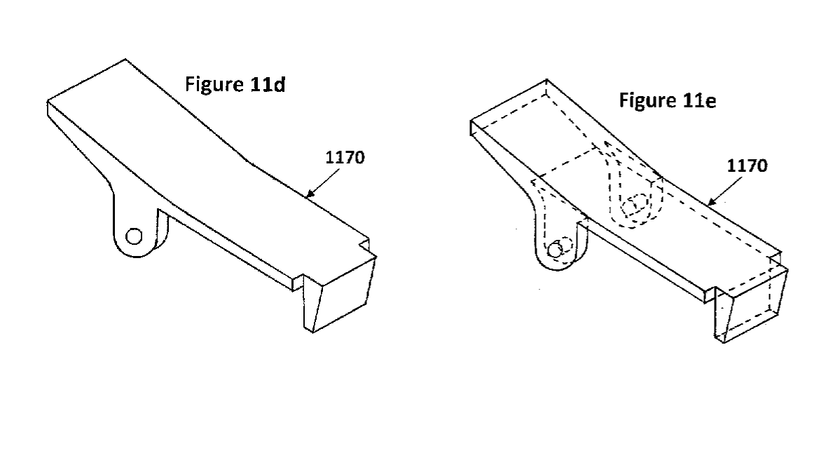

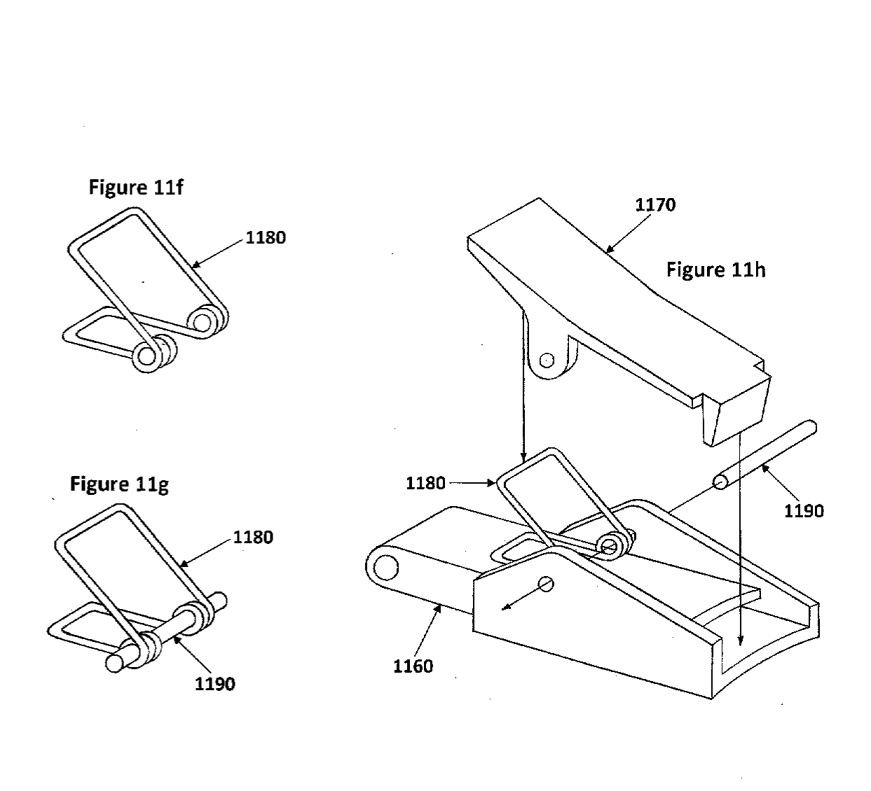

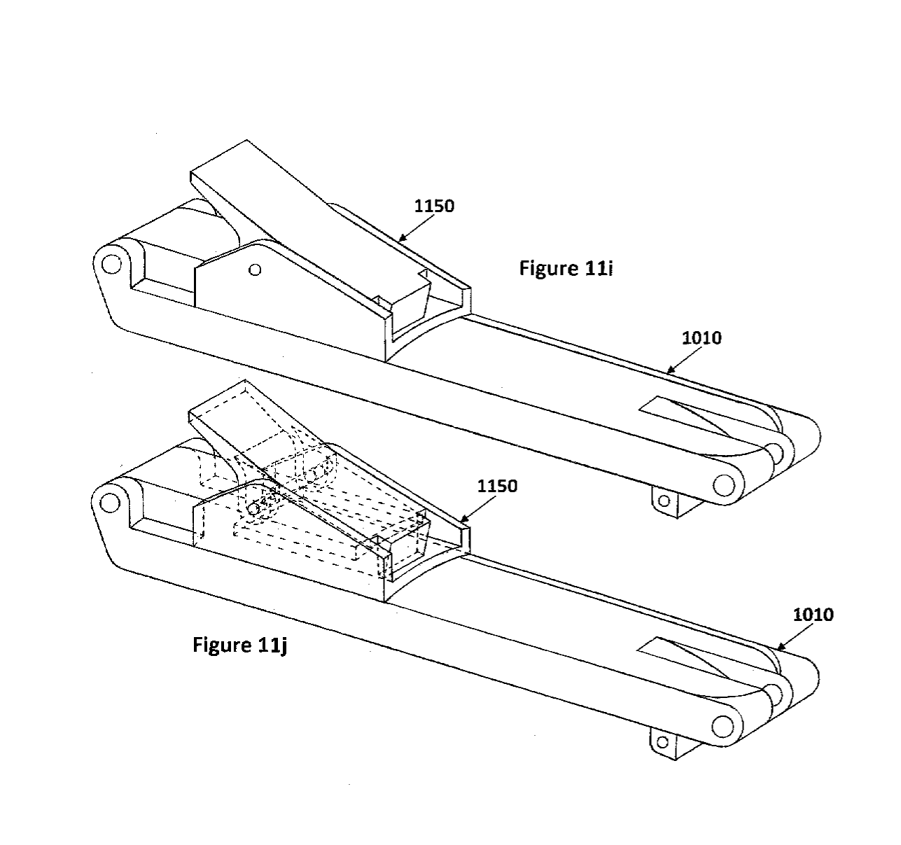

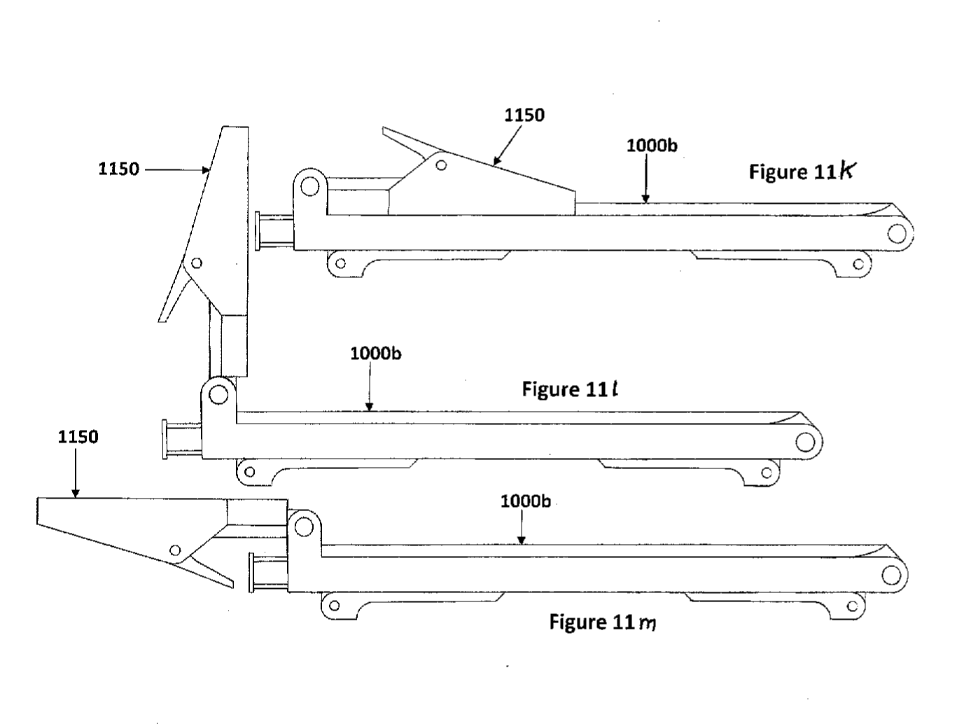

The second receiver, the rod tongue receiver (Type 2) 1150 is shown in FIGS. 11a, 1b, 1d and 1f. Rod tongue receiver (Type 2) 1150 can rotate vertically from a fully closed position of 0° as shown in FIG. 11k to a fully open 180° position as shown in FIG. 11m. Rod tongue receiver (Type 2) 1150 is typically stored in the closed position during transport or when not in use, and then is rotated anywhere between 0° and 180° depending on the desired position as determined by the user when ready to be used. Rod tongue receiver (Type 2) 1150 permits Fishing Rod Anchor 1000b to be attached to a fishing rod handle.

Rod tongue receiver (Type 2) 1150 typically comprises four parts. The first part is rod tongue receiver (Type 2) chassis 1160 shown in FIG. 11h. The second part is rod tongue receiver (Type 2) quick release 1170 shown in FIG. 11h. The third part is rod tongue receiver (Type 2) quick release spring 1180 shown in FIG. 11h. The fourth part is rod tongue receiver (Type 2) quick release hinge pin 1190 shown in FIG. 11h.

Rod tongue receiver (Type 2) chassis 1160 may be substantially rectangular and elongated, or any other suitable shape. Rod tongue receiver (Type 2) chassis 1160 may, if desired, be cut, formed, or molded together into one solid, seamless, and uniform piece. The length and width of rod tongue receiver (Type 2) chassis 1160 may be of any desired dimension to accommodate rod tongue receiver (Type 2) quick release 1170, rod tongue receiver (Type 2) quick release spring 1180, rod tongue receiver (Type 2) quick release hinge pin 1190, and anchor chassis member 1010. Rod tongue receiver (Type 2) chassis 1160 serves three purposes, namely, (1) to form the central point or main structure from which the rod tongue receiver (Type 2) quick release 1170, rod tongue receiver (Type 2) quick release spring 1180, and rod tongue receiver (Type 2) quick release hinge pin 1190 are connected, (2) to form a structure that allows rod tongue receiver (Type 2) quick release 1170, rod tongue receiver (Type 2) quick release spring 1180, and rod tongue receiver (Type 2) quick release hinge pin 1190 to be connected to anchor chassis member 1010, and (3) to form the point at which a fishing rod handle can be connected to Fishing Rod Anchor (Type 1) 1000b.

Rod tongue receiver (Type 2) quick release 1170 may be substantially rectangular and elongated, or any other suitable shape. Rod tongue receiver (Type 2) quick release 1170 may, if desired, be cut, formed, or molded together into one solid, seamless, and uniform piece. The length and width of Rod tongue receiver (Type 2) quick release 1170 may be of any desired dimension to accommodate rod tongue receiver (Type 2) chassis 1160, rod tongue receiver (Type 2) quick release spring 1180, and rod tongue receiver (Type 2) quick release hinge pin 1190. Rod tongue receiver (Type 2) quick release 1170 allows rod tongue receiver (Type 2) chassis 1160 to be easily separated and connected to a fishing rod handle.

Rod tongue receiver (Type 2) quick release spring 1180 may be substantially round and elongated, or any other suitable shape. Rod tongue receiver (Type 2) quick release spring 1180 may, if desired, be cut, formed, or molded together into one solid, seamless, and uniform piece. The length and width of rod tongue receiver (Type 2) quick release spring 1180 may be of any desired dimension to accommodate rod tongue receiver (Type 2) chassis 1160, rod tongue receiver (Type 2) quick release 1170, and rod tongue receiver (Type 2) quick release hinge pin 1190. Rod tongue receiver (Type 2) quick release spring 1180 allows rod tongue receiver (Type 2) quick release 1170 to move up and down with the slightest bit of tension so it can easily separate and connect to a fishing rod handle. Rod tongue receiver (Type 2) quick release 1170 and rod tongue receiver (Type 2) quick release spring 1180 are both connected to rod tongue receiver (Type 2) chassis by rod tongue receiver (Type 2) quick release hinge pin 1190.

Rod tongue receiver (Type 2) quick release hinge pin 1190 may be substantially round and elongated, or any other suitable shape. Rod tongue receiver (Type 2) quick release hinge pin 1190 may, if desired, be cut, formed, or molded together into one solid, seamless, and uniform piece. The length and width of rod tongue receiver (Type 2) quick release hinge pin 1190 may be of any desired dimension to accommodate rod tongue receiver (Type 2) chassis 1160, rod tongue receiver (Type 2) quick release 1170, and rod tongue receiver (Type 2) quick release spring 1180. Rod tongue receiver (Type 2) quick release hinge pin 1190 connects rod tongue receiver (Type 2) quick release 1170 and rod tongue receiver (Type 2) quick release spring 1180 to rod tongue receiver (Type 2) chassis 1160.

Rod tongue receiver (Type 2) 1150 is connected to anchor chassis member 1010 by the same rod tongue receiver hinge pin 1020 that connects rod tongue receiver (Type 1) 1140 to anchor chassis member 1010. The length and width of rod tongue receiver hinge pin 1020 may be of any desired dimension to accommodate rod tongue receiver (Type 2) 1150 and anchor chassis member 1010. Rod tongue receiver hinge pin 1020 has two purposes, namely, (1) to connect rod tongue receiver (Type 2) 1150 to anchor chassis member 1010, and (2) to allow rod tongue receiver (Type 2) 1150 to rotate from a closed 0° position to a fully open 180° position (or any position therebetween).

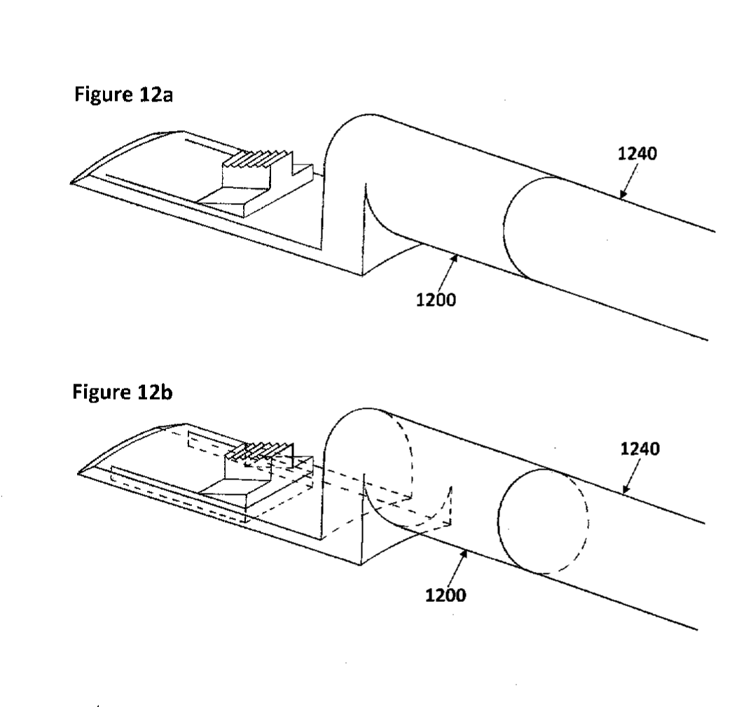

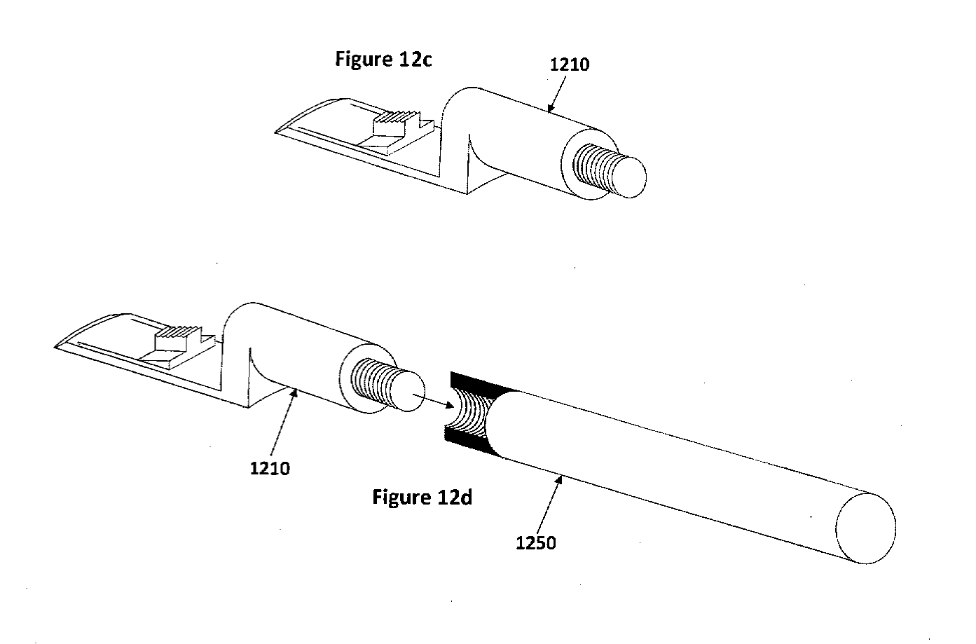

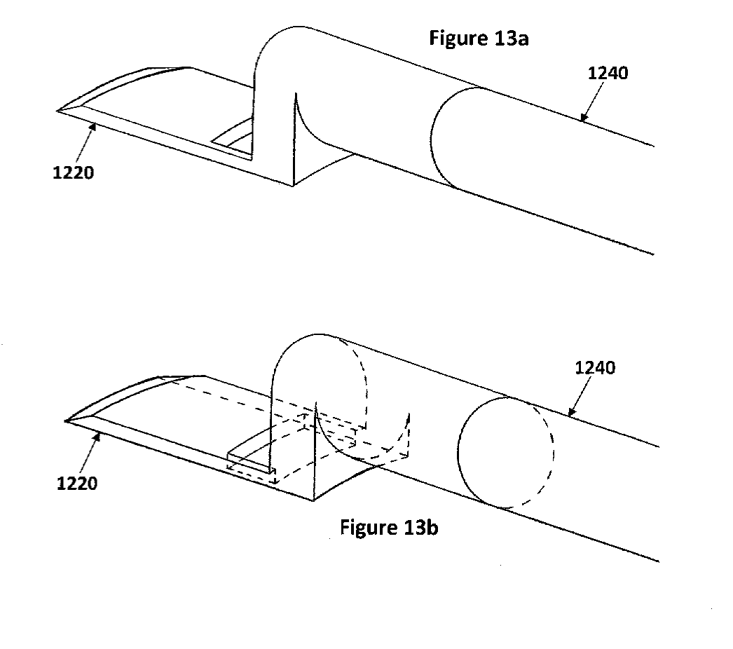

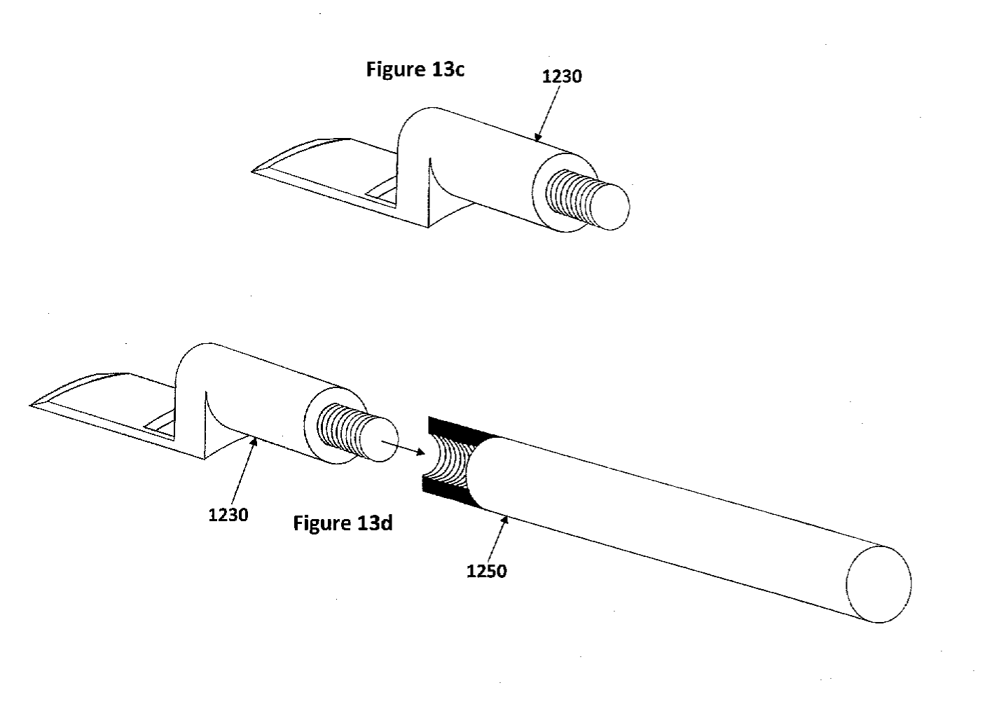

Fishing Rod Anchors (Type 1) 1000a and 1000b may be connected to a fishing rod handle via one or more attachments connected to the end of a fishing rod handle. The present invention discloses four possible attachments: (1) an integrated rod tongue (Type 1) 1200 shown in FIG. 12a; (2) a removable rod tongue (Type 1) 1210 shown in FIG. 12c; (3) an integrated rod tongue (Type 2) 1220 shown in FIG. 13a; and (4) a removable rod tongue (Type 2) 1230 shown in FIG. 13c. These four exemplary attachments are not connected to Fishing Rod Anchor (Type 1) 1000a or 1000b, but instead are connected to a fishing rod handle, and come into contact with Fishing Rod Anchor (Type 1) 1000a or 1000b via rod tongue receiver (Type 1) 1140 or rod tongue receiver (Type 2) 1150.

As shown in the figures, integrated rod tongue (Type 1) 1200 and removable rod tongue (Type 1) 1210 are the same in all respects and serve the same purpose except that removable rod tongue (Type 1) 1210 has a threaded forward section and integrated rod tongue (Type 1) 1200 does not. The same is true for integrated rod tongue (Type 2) 1220 and removable rod tongue (Type 2) 1230. Removable rod tongue (Type 2) 1230 has a threaded forward section and integrated rod tongue (Type 2) 1220 does not.

Integrated rod tongue (Type 1) 1200 and integrated rod tongue (Type 2) 1220 are both integrated into the fishing rod handle itself, forming one solid and continuous part. Removable rod tongue (Type 1) 1210 and removable rod tongue (Type 2) 1230 are not integrated into the fishing rod handle but are removable so as to give the user more options and allowing the user to change out different rod tongues without having to purchase an entirely new fishing rod.

Integrated rod tongue (Type 1) 1200 and removable rod tongue (Type 1) 1210, although different, both are Type 1and therefore can connect to the same Type 1 receiver, for example, rod tongue receiver (Type 1) 1140 shown in FIG. 1c. The same is true for integrated rod tongue (Type 2) 1220 and removable rod tongue (Type 2) 1230, namely, both are Type 2 and therefore can connect to the Type 2 receiver, for example, rod tongue receiver (Type 2) 1150 shown in FIG. 1d.

Integrated rod tongue (Type 1) 1200 may be substantially rectangular (at one end)/round (at the opposite end) and elongated, or any other suitable shape. Integrated rod tongue (Type 1) 1200 may, if desired, be cut, formed, or molded together into one solid, seamless, and uniform piece. The length and width of integrated rod tongue (Type 1) 1200 may be of any desired dimension to accommodate rod tongue receiver (Type 1) 1140, and integrated fishing rod handle 1240. Integrated rod tongue (Type 1) 1200 connects Fishing Rod Anchor (Type 1) 1000a to integrated fishing rod handle 1240 as shown in FIG. 1c.

Removable rod tongue (Type 1) 1210 may be substantially rectangular (at one end)/round (at the opposite end) and elongated, or any other suitable shape. Removable rod tongue (Type 1) 1210 may, if desired, be cut, formed, or molded together into one solid, seamless, and uniform piece. The length and width of removable rod tongue (Type 1) 1210 may be of any desired dimension to accommodate rod tongue receiver (Type 1) 1140, and threaded fishing rod handle 1250. Removable rod tongue (Type 1) 1210 connects Fishing Rod Anchor (Type 1) 1000a to threaded fishing rod handle 1250 as shown in FIG. 1e.

Integrated rod tongue (Type 2) 1220 may be substantially rectangular (at one end)/round (at the opposite end) and elongated, or any other suitable shape. Integrated rod tongue (Type 2) 1220 may, if desired, be cut, formed, or molded together into one solid, seamless, and uniform piece. The length and width of integrated rod tongue (Type 2) 1220 may be of any desired dimension to accommodate rod tongue receiver (Type 2) 1150, and integrated fishing rod handle 1240. Integrated rod tongue (Type 2) 1220 connects Fishing Rod Anchor (Type 1) 1000b to integrated fishing rod handle 1240 as shown in FIG. 1d.

Removable rod tongue (Type 2) 1230 may be substantially rectangular (at one end)/round (at the opposite end) and elongated, or any other suitable shape. Removable rod tongue (Type 2) 1230 may, if desired, be cut, formed, or molded together into one solid, seamless, and uniform piece. The length and width of removable rod tongue (Type 2) 1230 may be of any desired dimension to accommodate rod tongue receiver (Type 2) 1150, and threaded fishing rod handle 1250. Removable rod tongue (Type 2) 1230 connects Fishing Rod Anchor (Type 1) 1000b to threaded fishing rod handle 1250 as shown in FIG. 1f.

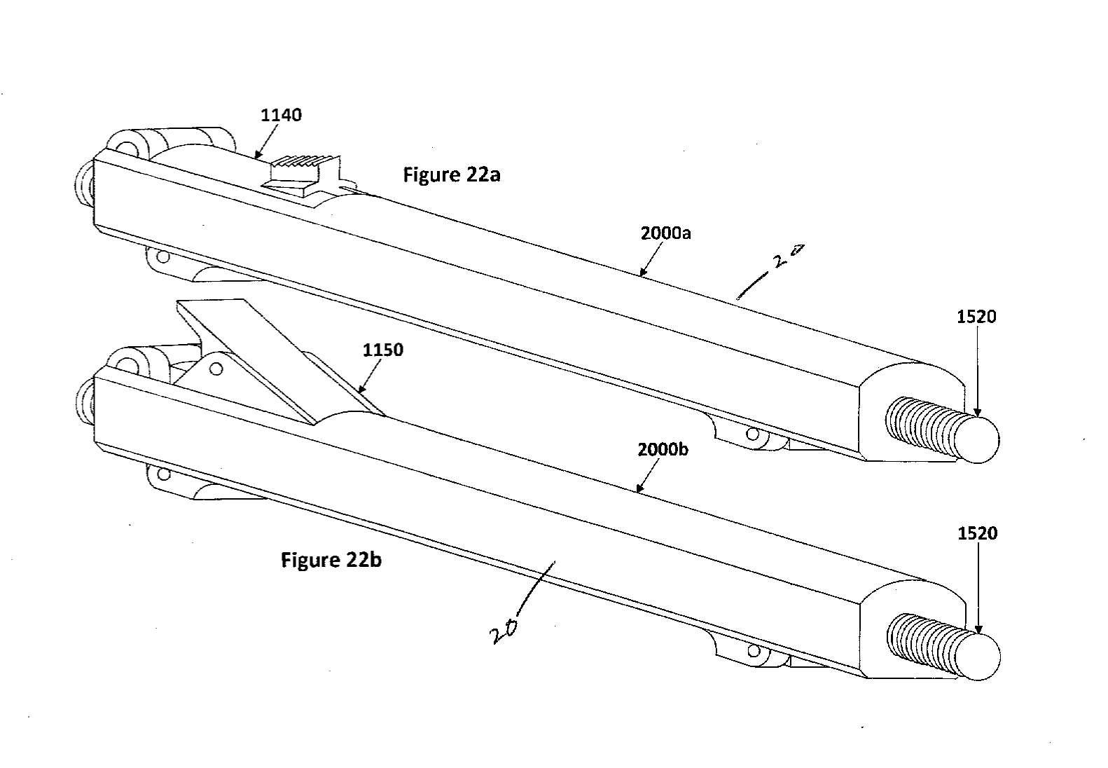

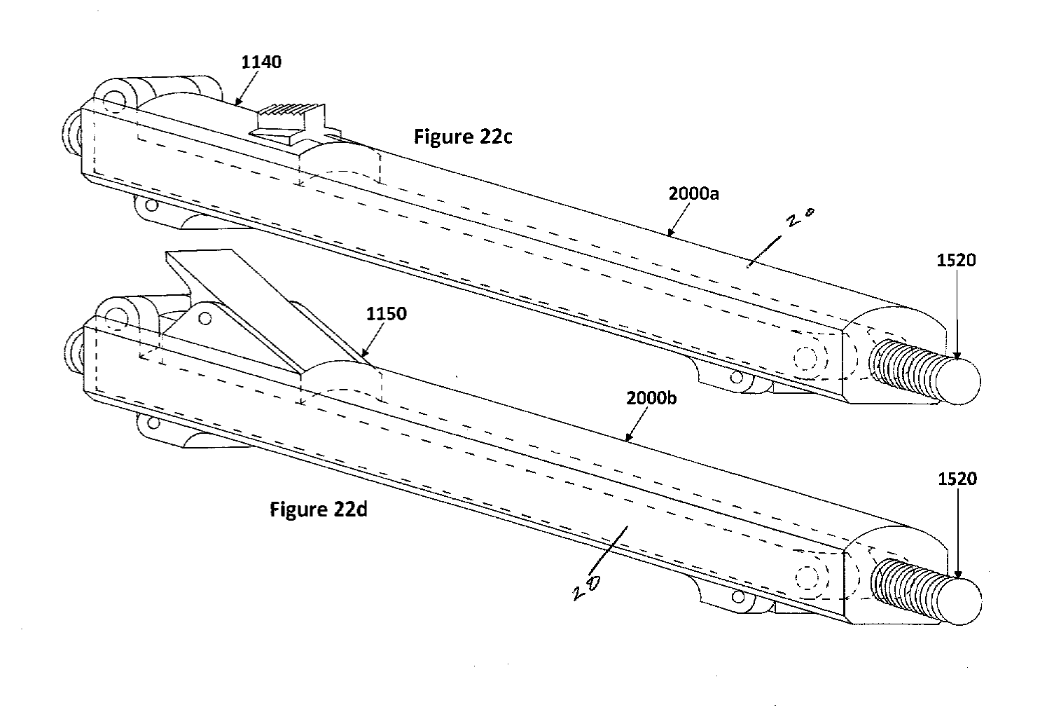

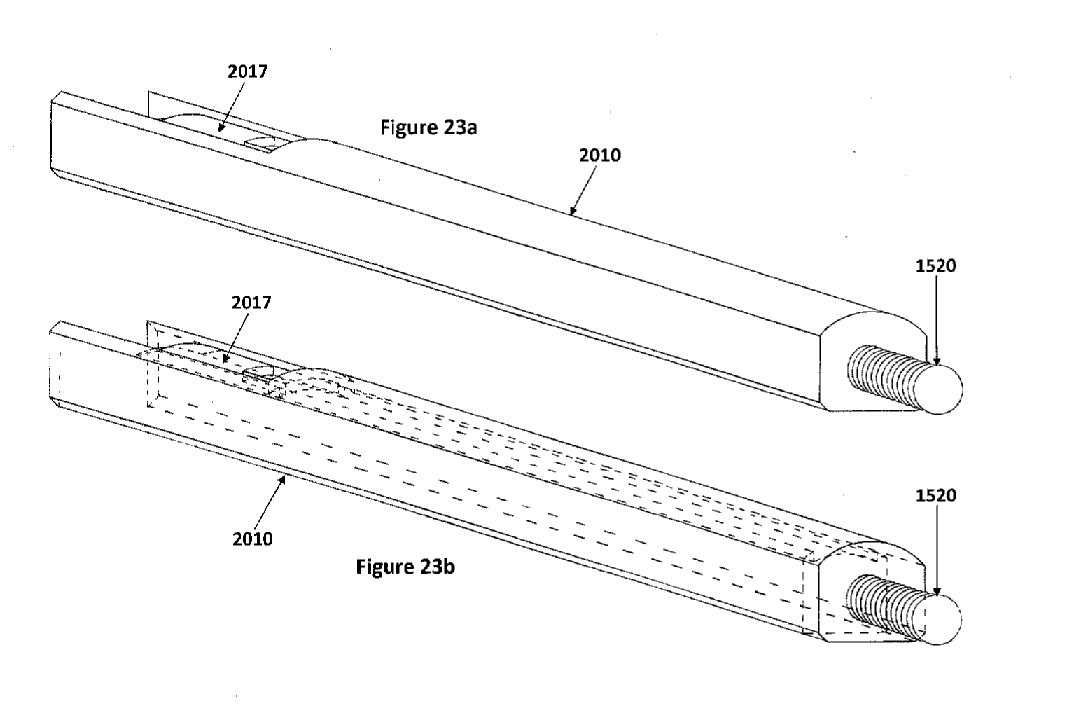

In another embodiment, the fishing rod anchoring device of the present invention comprises Fishing Rod Anchor (Type 2) 2000a or 2000b as shown in FIGS. 22a-22b. Fishing Rod Anchors (Type 2) 2000a and 2000b are also referred to herein as “the Concealed Fishing Rod Anchor” because these FRAs recess into and form a removable handle of a fishing rod, concealing the FRA from view. Fishing Rod Anchor (Type 2) 2000a and 2000b comprise Fishing Rod Anchors (Type 1) 1000a and 1000b within an outer shell so as to form removable fishing rod handles 20 as shown in FIGS. 22c-22d. This outer shell is referred to as the fishing rod anchor (Type 2) handle shell 2010 as shown in FIG. 23a. Fishing rod anchor (Type 2) handle shell 2010 can accommodate both Fishing Rod Anchor (Type 1) 1000a or 1000b.

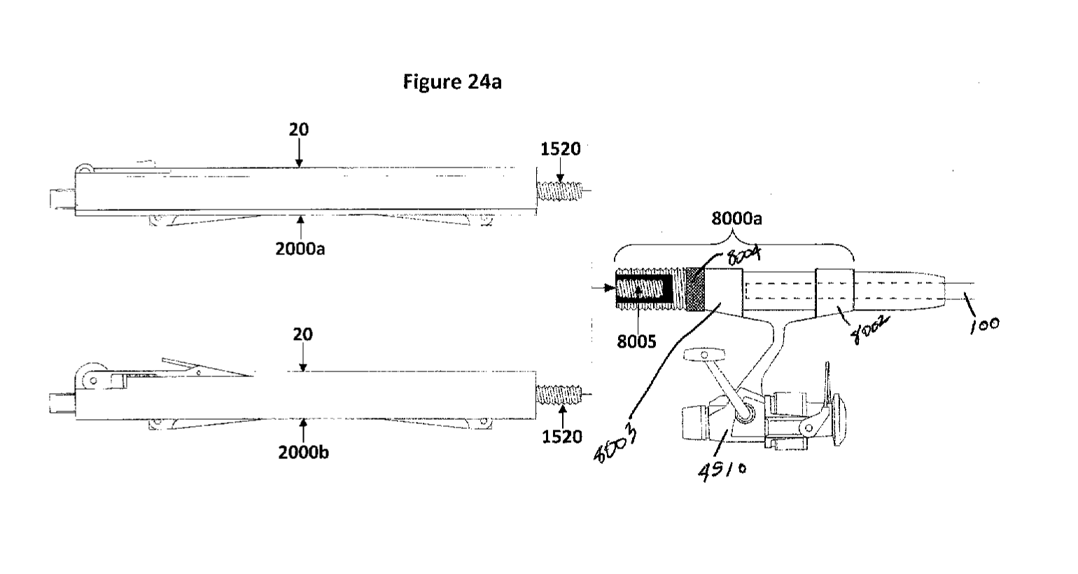

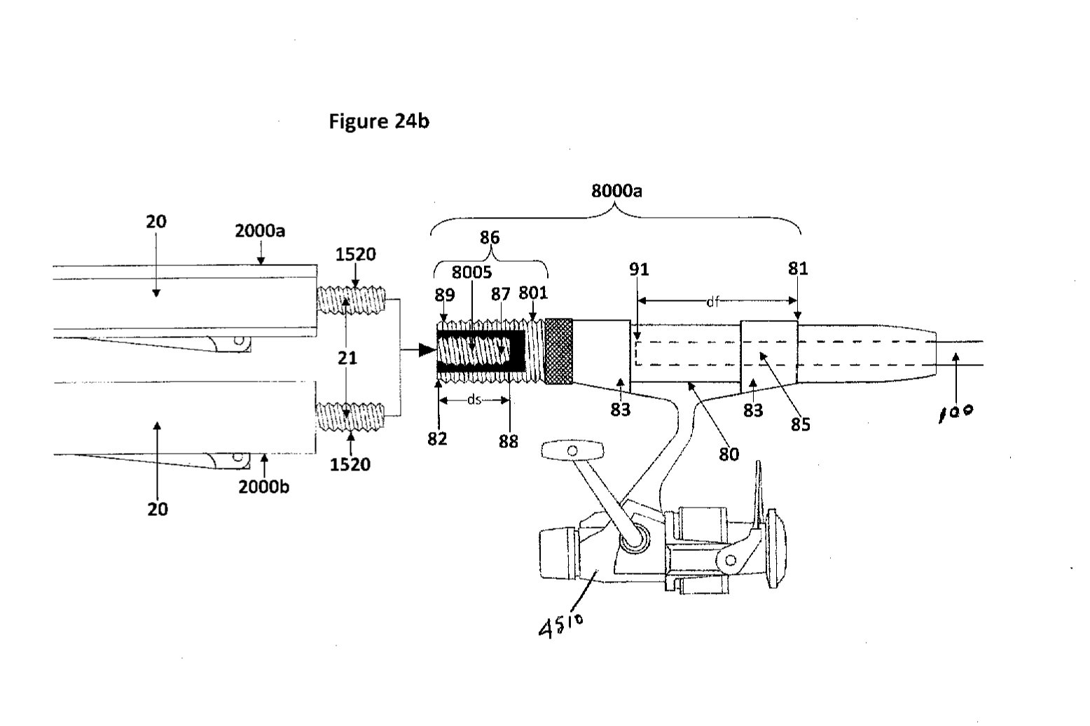

Fishing rod anchor (Type 2) handle shell 2010 may be substantially round and elongated, or any other suitable shape. Fishing rod anchor (Type 2) handle shell 2010 may, if desired, be cut, formed, or molded together into one solid, seamless, and uniform piece. The length and width of fishing rod anchor (Type 2) handle shell 2010 may be of any desired dimension to accommodate Fishing Rod Anchor (Type 1) 1000a or 1000b. Fishing rod anchor (Type 2) handle shell 2010 serves three purposes, namely, (1) to conceal and protect Fishing Rod Anchor (Type 1) 1000a or 1000b therein; (2) to form the connecting point between (i) Fishing Rod Anchor (Type 1) 1000a or 1000b and (ii) a specially designed threaded fishing rod (in particular, a fishing rod reel seat thereof) shown in FIGS. 24a-24b; and (3) to allow for the interchangeability of fishing rod handles for a single rod and reel.

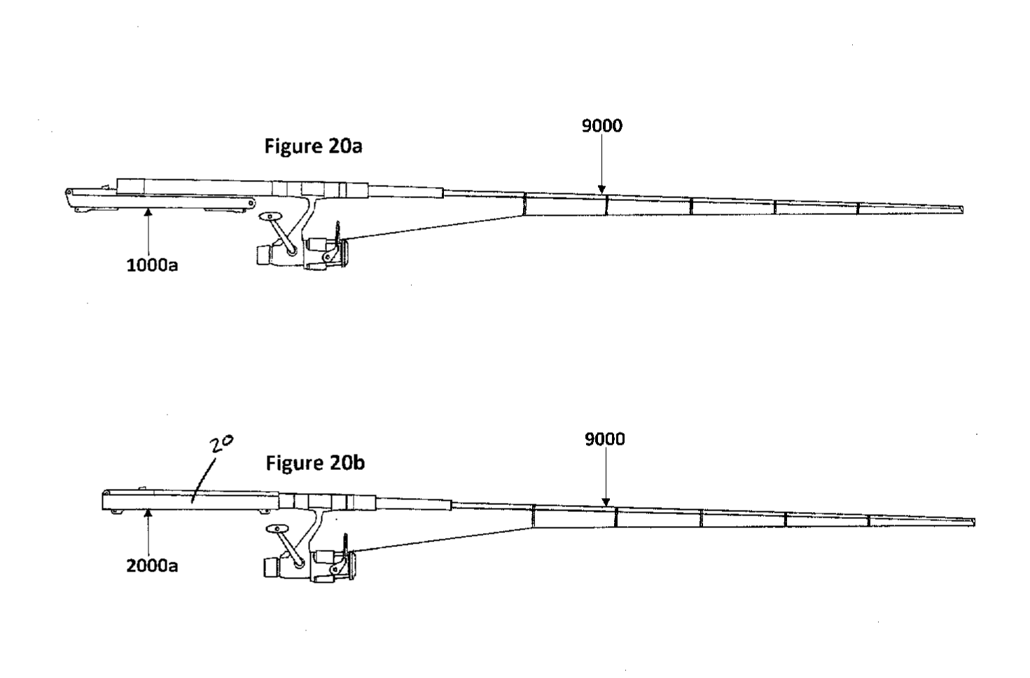

Exemplary fishing rod anchor (Type 2) handle shell 2010 has a threaded protrusion 1520 on the forward end that connects to an opposing threaded end on the specially designed fishing rod (in particular, a fishing rod reel seat thereof) allowing exemplary fishing rod anchor (Type 2) handle shell 2010 to be taken on and off the fishing rod as shown in FIGS. 24a-24b. This design allows a user to change out fishing rod handles and switch between, for example, (1) Fishing Rod Anchor (Type 1) 1000a or 1000b, which sits beneath the fishing rod handle as shown in FIG. 20a, and which is not concealed to (2) Fishing Rod Anchor (Type 2) 2000a or 2000b as shown in FIG. 20b, which forms the fishing rod handle and is concealed.

As shown in FIGS. 24a-24b and 53a-56, the present invention is further directed to fishing rod reel seats that may be used with removable fishing rod handles. In one exemplary embodiment, the fishing rod reel seat (such as exemplary fishing rod reel seat 8000a shown in FIGS. 24a-24b) of the present invention comprises a reel seat member 80 having a first end 81, a second end 82 opposite first end 81, and a reel connecting member 83 positioned along reel seat member 80 between first end 81 and second end 82; a first cavity 85 extending a first depth d_{f} into reel seat member 80 from first end 81, first cavity 85 being sized to house a connecting end 91 of a fishing rod 100 therein; and a fishing rod handle connecting member 86 comprising (i) internal threads 87 extending along a second cavity 88 that extends a second depth dₛ into reel seat member 80 from second end 82, (ii) external threads 89 extending along an outer surface 801 of reel seat member 80 proximate second end 82, or (iii) both (i) and (ii), wherein fishing rod handle connecting member 86 is sized and configured to be attachable to one or more removable fishing rod handles 20.

In some embodiments, fishing rod handle connecting member 86 comprises internal threads 87 extending along second cavity 88 that extends second depth dₛ into reel seat member 80 from second end 82. Internal threads 87 are sized and configured to attach to corresponding external threads 21 of one or more removable fishing rod handles 20. In this embodiment, exemplary fishing rod reel seat 8000a can be matched with a removable fishing rod handle 20 comprising external threads 21 that engage with internal threads 87 of reel seat member 80.

In other embodiments, fishing rod handle connecting member 86 comprises external threads 89 extending along outer surface 801 of reel seat member 80 proximate second end 82. External threads 89 are sized and configured to attach to corresponding internal threads 22 of one or more removable fishing rod handles 20. In this embodiment, exemplary fishing rod reel seat 8000a can be matched with a removable fishing rod handle 20 comprising internal threads 22 that engage with external threads 89 of reel seat member 80.

In yet other embodiments, fishing rod handle connecting member 86 comprises (i) internal threads 87 extending along second cavity 88 that extends second depth dₛ into reel seat member 80 from second end 82, and (ii) external threads 89 extending along outer surface 801 of reel seat member 80 proximate second end 82. In this embodiment, internal threads 87 are sized and configured to attach to corresponding external threads 21 of one or more removable fishing rod handles 20, while external threads 89 are sized and configured to attach to corresponding internal threads 22 of one or more removable fishing rod handles 20. In this embodiment, exemplary fishing rod reel seat 8000a can be matched with either (1) a removable fishing rod handle 20 comprising external threads 21 that engage with internal threads 87 of reel seat member 80 or (2) a removable fishing rod handle 20 comprising internal threads 22 that engage with external threads 89 of reel seat member 80.

As shown in FIGS. 24a-24b and 53a-56, fishing rod reel seat 8000a may further comprise, in combination, a removable fishing rod handle 20. In some embodiments, removable fishing rod handle 20 may comprise fishing rod anchoring device 2000a or 2000b comprising (i) anchor chassis member 1010; (ii) adjustable clamping assembly 1050 attached to anchor chassis member 1010, adjustable clamping assembly 1050 being operatively adapted and sized to clamp onto an object (e.g., a dock); and (iii) fishing rod attaching component 1520 operatively adapted and sized so as to releasably attach fishing rod anchoring device 2000a or 2000b to fishing rod reel seat 8000a.

In other embodiments, removable fishing rod handle 20 may comprise fishing rod anchoring device 2000a or 2000b comprising (i) anchor chassis member 1010; (ii) spike member 1040 attached to anchor chassis member 1010, spike member 1040 being operatively adapted and sized to extend into soil (e.g., ground 9010 in FIG. 19); and (iii) fishing rod attaching component 1520 operatively adapted and sized so as to releasably attach fishing rod anchoring device 2000a or 2000b to fishing rod reel seat 8000a.

In yet other embodiments, removable fishing rod handle 20 may comprise fishing rod anchoring device 2000a or 2000b comprising (i) anchor chassis member 1010; (ii) adjustable clamping assembly 1050 attached to anchor chassis member 1010, adjustable clamping assembly 1050 being operatively adapted and sized to clamp onto an object (e.g., a dock); (iii) spike member 1040 attached to anchor chassis member 1010, spike member 1040 being operatively adapted and sized to extend into soil (e.g., ground 9010 in FIG. 19); and (iv) fishing rod attaching component 1520 operatively adapted and sized so as to releasably attach fishing rod anchoring device 2000a or 2000b to fishing rod reel seat 8000a.

As shown in FIGS. 24a-24b and 53a-56, fishing rod reel seat 8000a may further comprise, in combination, (i) fishing rod 100 with connecting end 91 of fishing rod 100 positioned within first cavity 85 and a tip end (not shown) opposite connecting end 91; (ii) a reel 4510 positioned along and connected to reel seat member 8000a via reel connecting member 83.

The present invention is even further directed to removable fishing rod handles suitable for use with the herein disclosed fishing rod reel seats (e.g., fishing rod reel seat 8000a). In one exemplary embodiment, removable fishing rod handle 20 comprises a fishing rod anchor, such as one of the fishing rod anchors described herein (e.g., fishing rod anchoring device 2000a or 2000b). Further, in some embodiments, removable fishing rod handle 20 further comprises a threaded protrusion 1520 at a front end for the purpose of attaching removable fishing rod handle 20 in a non-permanent fashion to a second device with a receiving threaded end (e.g., a fishing rod reel seat disclosed herein, (e.g., fishing rod reel seat 8000a)).

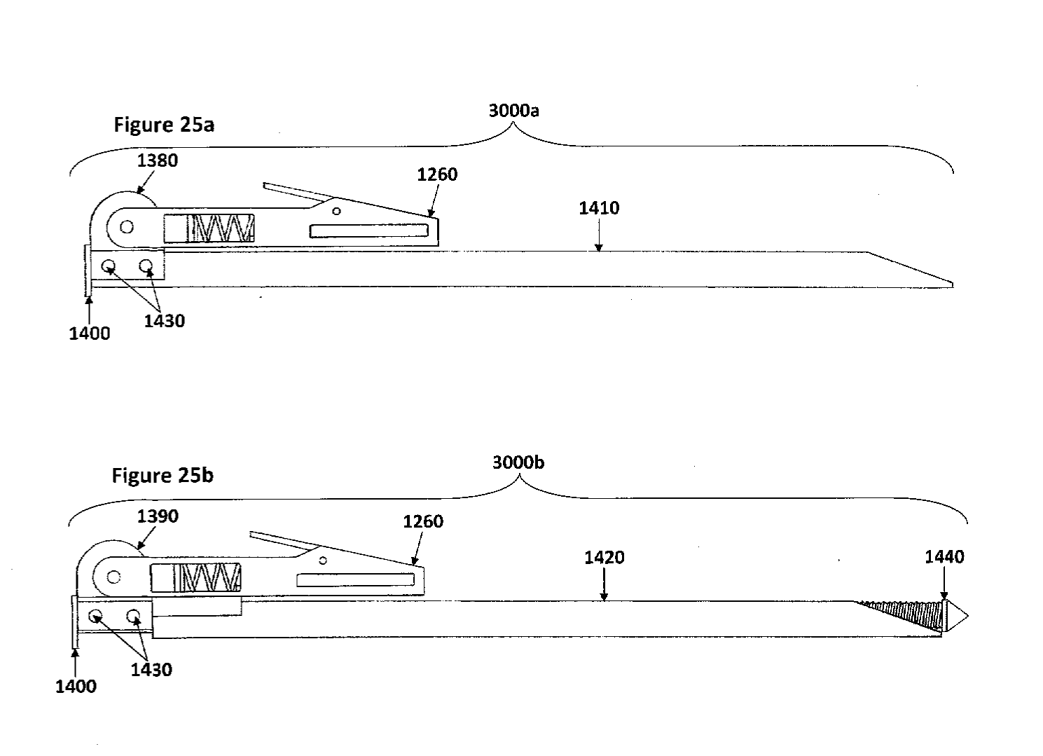

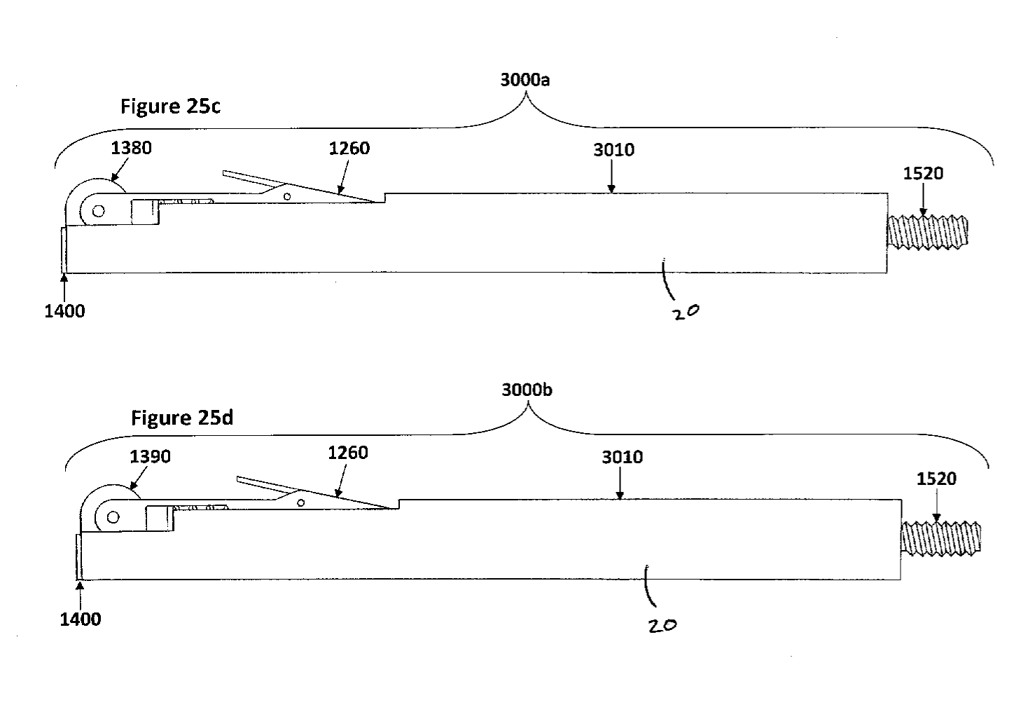

Removable fishing rod handles 20 of the present invention further include Fishing Rod Anchor (Type 3—Model A) 3000a and Fishing Rod Anchor (Type 3—Model B) 3000b shown in FIGS. 25a-25d. Fishing Rod Anchor (Type 3—Model A) 3000a and Fishing Rod Anchor (Type 3—Model B) 3000b are concealed fishing rod anchors given that they are recessed into the handle of a fishing rod. Fishing Rod Anchor (Type 3—Model A) 3000a is concealed within an outer shell, which forms the fishing rod handle shown in FIG. 25c. Fishing Rod Anchor (Type 3—Model B) 3000b is also concealed within an outer shell, which forms the fishing rod handle shown in FIG. 25d. The outer shell is referred to herein as the fishing rod anchor (Type 3) handle shell 3010 as shown in FIGS. 25c-25d.

Fishing rod anchor (Type 3) handle shell 3010 can accommodate Fishing Rod Anchor (Type 3—Model A) 3000a or Fishing Rod Anchor (Type 3—Model B) 3000b. Fishing Rod Anchor (Type 1) 1000a and 1000b and Fishing Rod Anchor (Type 2) 2000a and 2000b are considered combination anchors as they combine the use of a ground spike 1040 and clamp 1050 for dual purpose use. Fishing Rod Anchor (Type 3—Model A) 3000a and Fishing Rod Anchor (Type 3—Model B) 3000b both perform the same functions as Fishing Rod Anchor (Type 1) 1000a and 1000b and Fishing Rod Anchor (Type 2) 2000a and 2000b but without the use of the clamping portion 1050. Fishing Rod Anchor (Type 3—Model A) 3000a and Fishing Rod Anchor (Type 3—Model B) 3000b are both used primarily for fishing from the bank using ground spike 1040 similar in function to ground spike 1040 used on Fishing Rod Anchor (Type 1) 1000a and 1000b and Fishing Rod Anchor (Type 2) 2000a and 2000b.

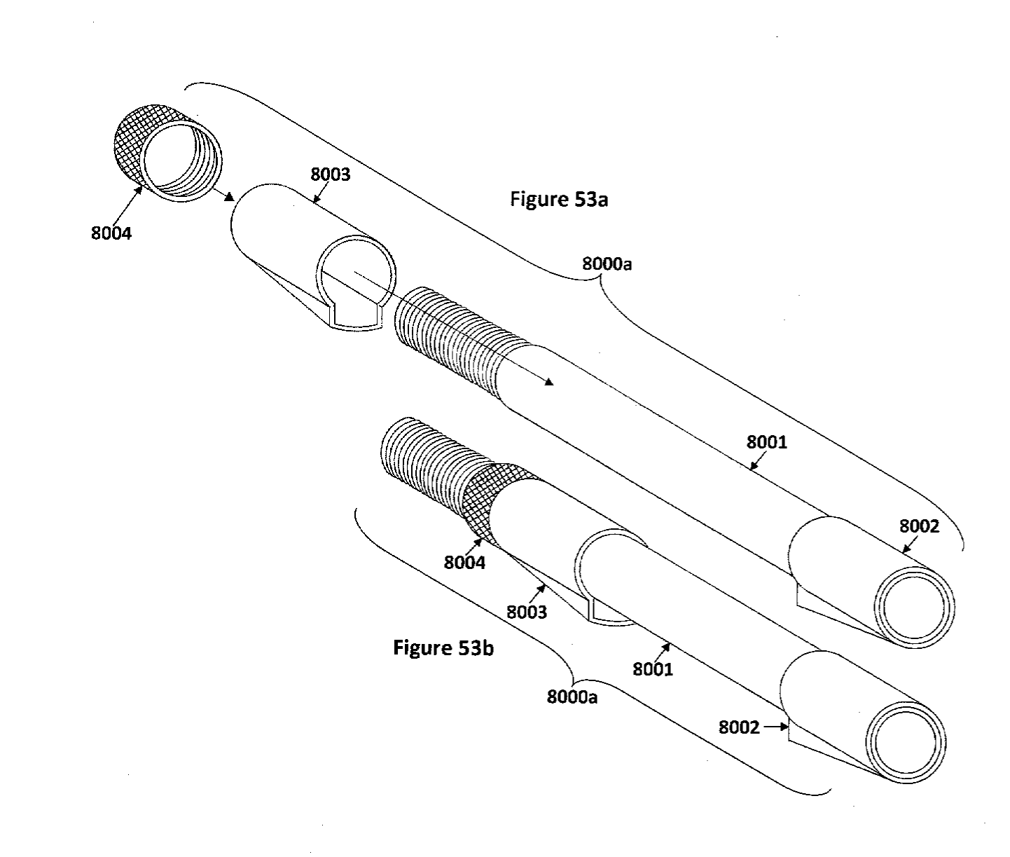

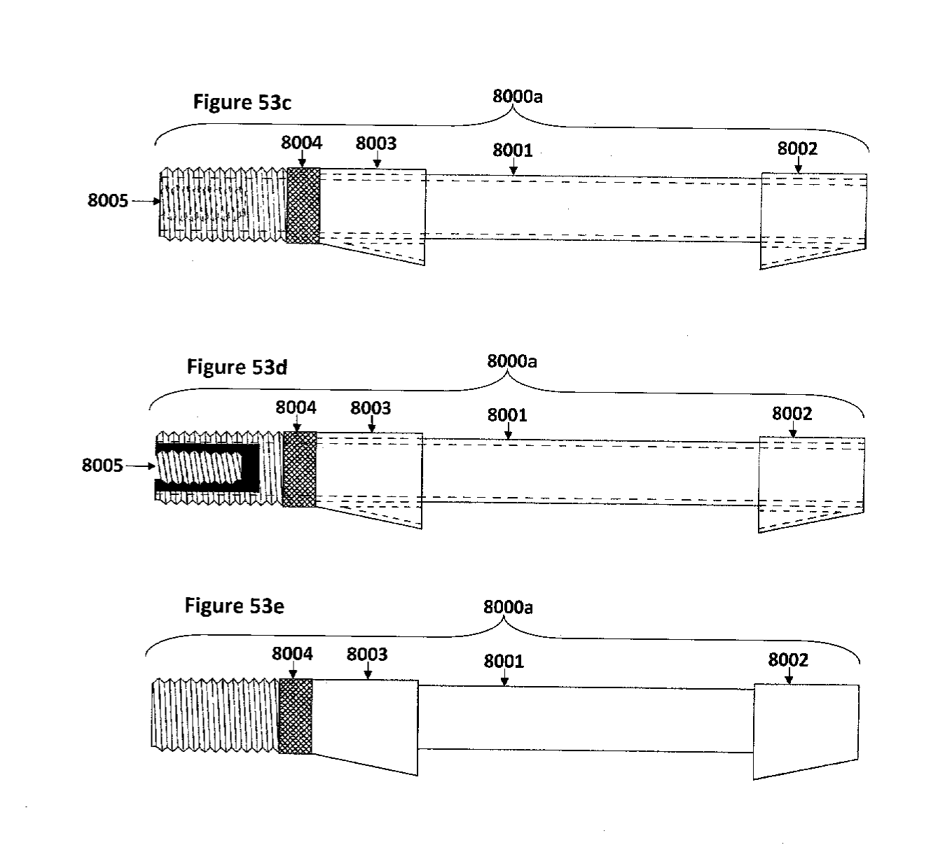

Fishing Rod Anchor (Type 3—Model A) 3000a and Fishing Rod Anchor (Type 3—Model B) 3000b give a user a choice of using ground spike 1040 due to the interchangeability of a given removable fishing rod handle 20 simply by unscrewing a given removable fishing rod handle 20 from fishing rod reel seat 8000a or 8000b shown in FIGS. 53a-54d and 56. The advantage of using just ground spike 1040 on Fishing Rod Anchor (Type 3—Model A) 3000a or Fishing Rod Anchor (Type 3—Model B) 3000b is that it takes away the extra weight and size of the combination anchors such as Fishing Rod Anchor (Type 1) 1000a and 1000b and Fishing Rod Anchor (Type 2) 2000a and 2000b.

Fishing Rod Anchor (Type 3—Model A) 3000a and Fishing Rod Anchor (Type 3—Model B) 3000b are essentially streamlined versions of Fishing Rod Anchor (Type 1) 1000a and 1000b and Fishing Rod Anchor (Type 2) 2000a and 2000b. Although similar in function to Fishing Rod Anchor (Type 1) 1000a and 1000b and Fishing Rod Anchor (Type 2) 2000a and 2000b, Fishing Rod Anchor (Type 3—Model A) 3000a and Fishing Rod Anchor (Type 3—Model B) 3000b differ in appearance. Fishing Rod Anchor (Type 3—Model A) 3000a and Fishing Rod Anchor (Type 3—Model B) 3000b do not have as many parts as Fishing Rod Anchor (Type 1) 1000a and 1000b and Fishing Rod Anchor (Type 2) 2000a and 2000b because they serve the sole purpose of using a ground spike instead of using a ground spike and clamp combination.

Exemplary fishing rod anchor (Type 3—Model A) 3000a comprises five main parts: rod tongue receiver (Type 3) 1260 shown in FIGS. 25a-25d, elevation dial (Type 3a) 1380 shown in FIGS. 25a and 25c, kick plate 1400 shown in FIGS. 25a-25d, ground spike (Type 3a) 1410 shown in FIG. 25a, and fishing rod anchor (Type 3) handle shell 3010 shown in FIGS. 25c-25d. Exemplary fishing rod anchor (Type 3—Model B) 3000b comprises six main parts: rod tongue receiver (Type 3) 1260 shown in FIGS. 25a-25d, elevation dial (Type 3b) 1390 shown in FIG. 25b and FIG. 25d, kick plate 1400 shown in FIGS. 25a-25d, ground spike (Type 3b) 1420 further comprising ground spike extension rod 1440 shown in FIG. 25b, and fishing rod anchor (Type 3) handle shell 3010 shown in FIGS. 25c-25d. With the addition of ground spike extension rod 1440, fishing rod anchor (Type 3—Model B) 3000b differs from fishing rod anchor (Type 3—Model A) 3000a because it allows ground spike (Type 3b) 1420 to go deeper into the ground (e.g., when used in loose soils such as mud or sand).

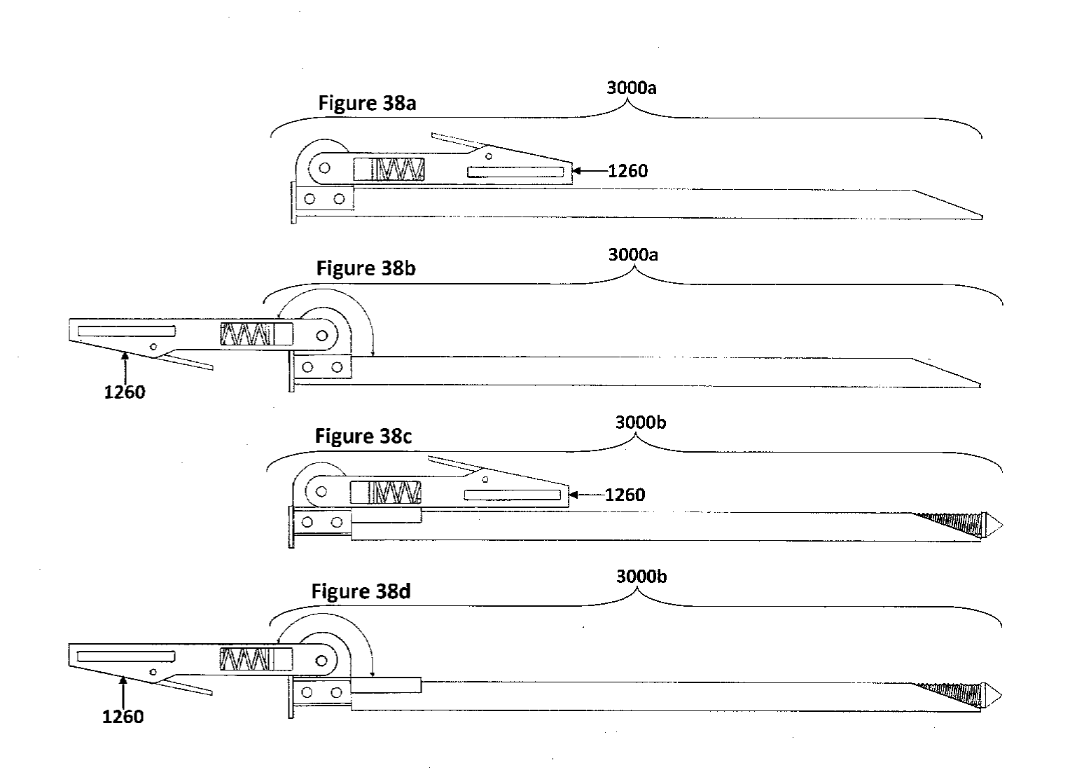

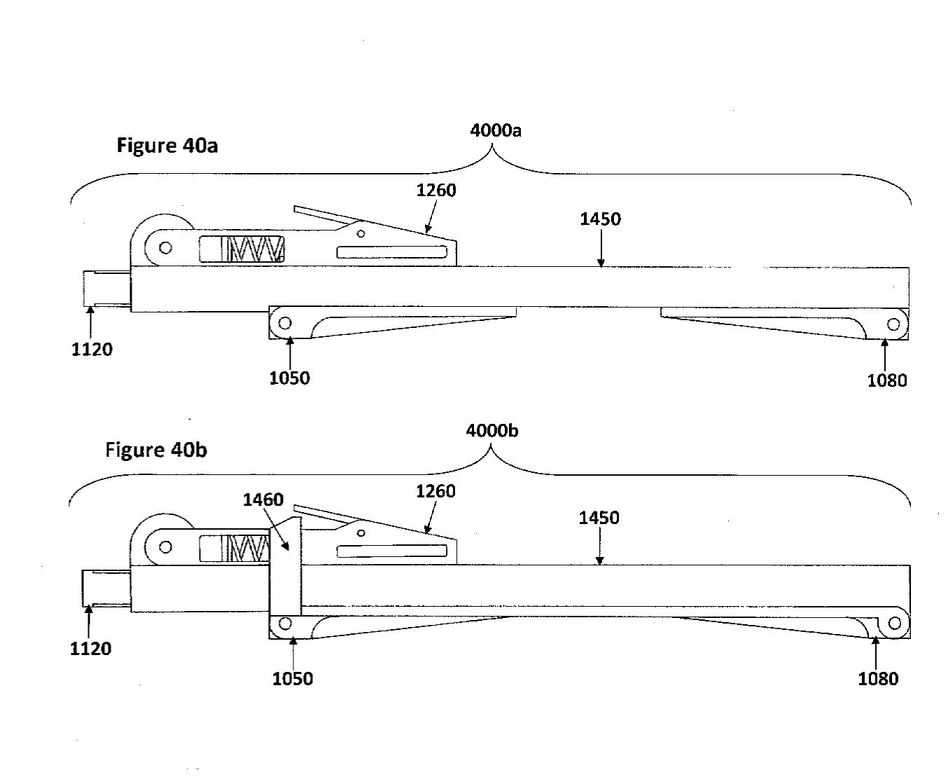

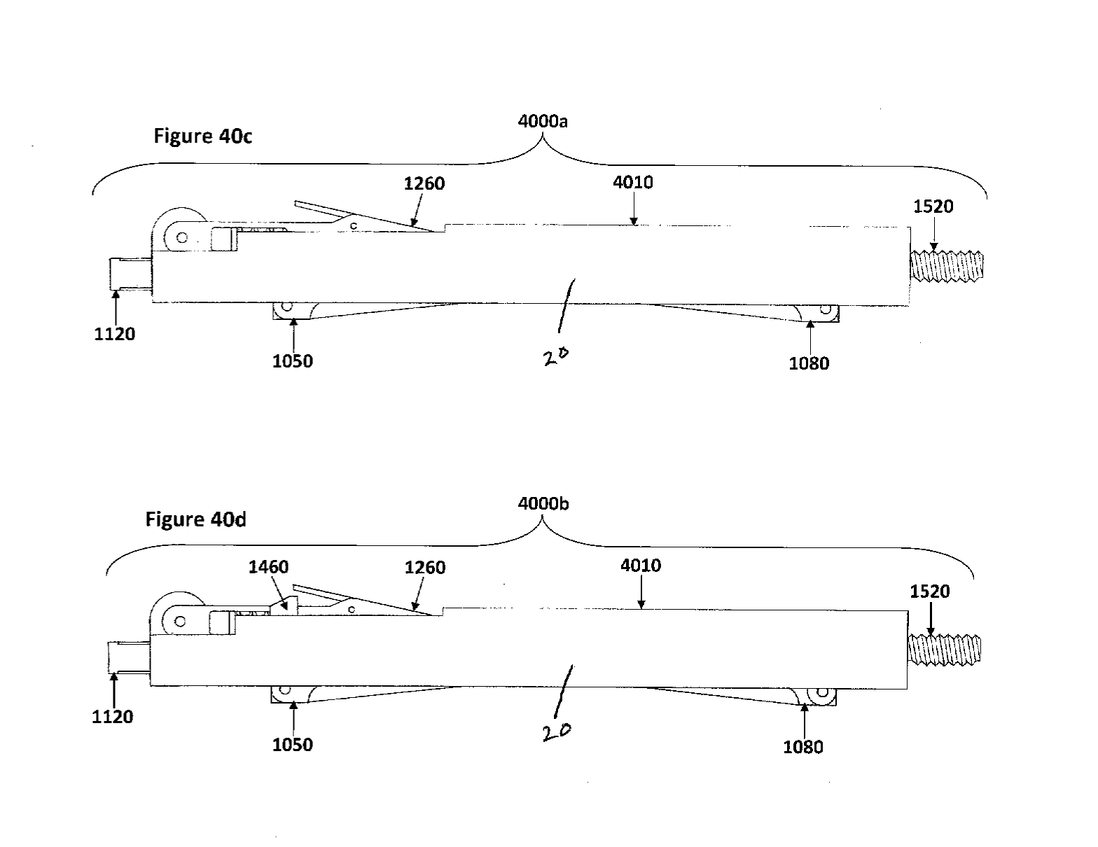

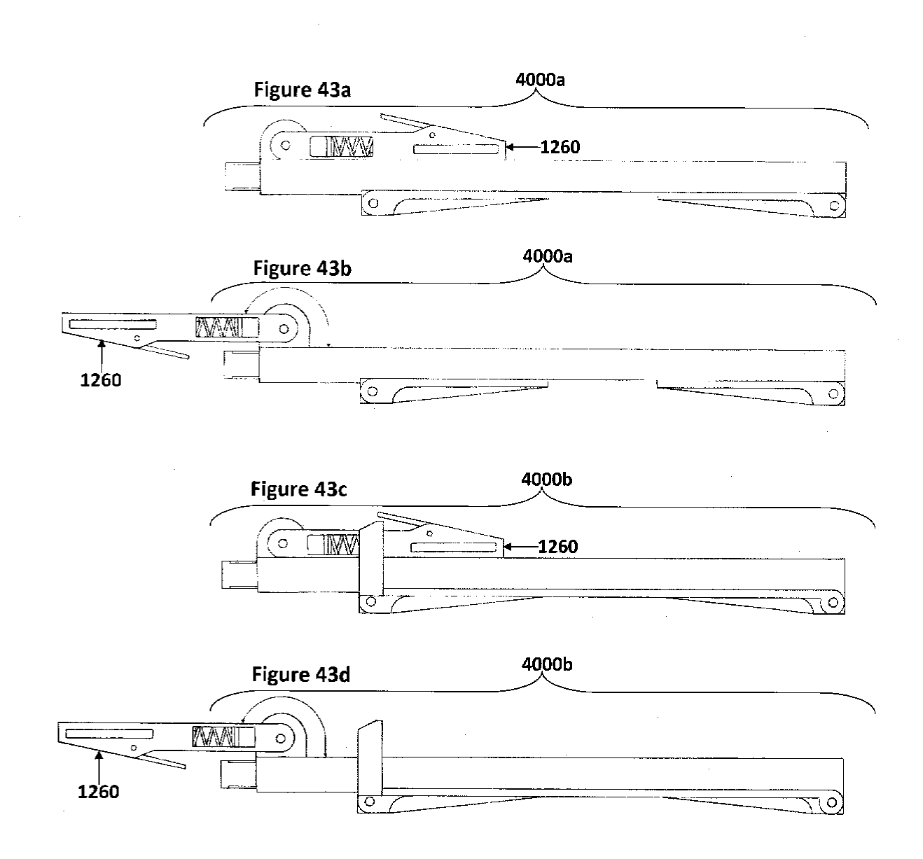

Rod tongue receiver (Type 3) 1260 is similar in function and design to rod tongue receiver (Type 2) 1150. Rod tongue receiver (Type 3) 1260 can rotate vertically from a fully closed position of 0° (shown in FIG. 38a) to a fully open 180° position (shown in FIG. 38b). Rod tongue receiver (Type 3) 1260 is typically stored in the closed position during transport or when not in use, and then is rotated anywhere between 0° and 180° depending on the desired position as determined by a user when ready to be used. Rod tongue receiver (Type 3) 1260 may be used on both fishing rod anchor (Type 3—Model A) 3000a and fishing rod anchor (Type 3—Model B) 3000b as shown in FIGS. 25a-25d and 38a-38d, as well as exemplary fishing rod anchor (Type 4—Model A) 4000a and fishing rod anchor (Type 4—Model B) 4000b shown in FIGS. 40a-40d and 43a-43d. Rod tongue receiver (Type 3) 1260 can also be used on fishing rod anchor (Type 1) 1000a and 1000b and fishing rod anchor (Type 2) 2000a and 2000b.

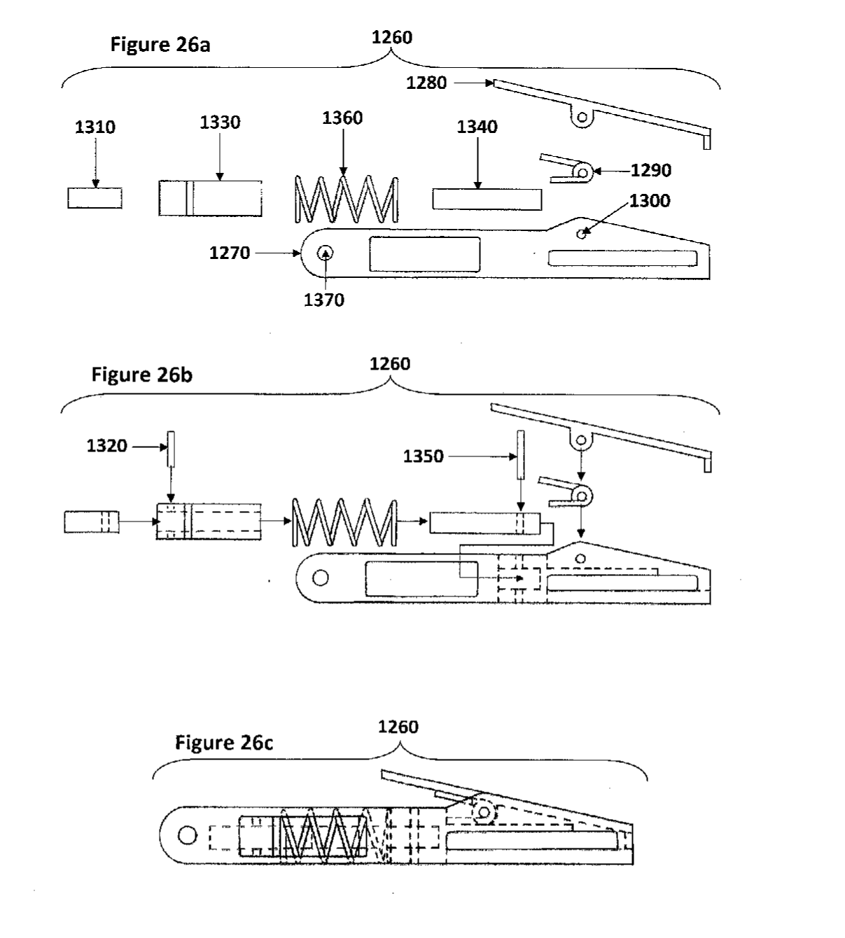

Rod tongue receiver (Type 3) 1260 permits fishing rod anchor (Type 3—Model A) 3000a, fishing rod anchor (Type 3—Model B) 3000b, fishing rod anchor (Type 4—Model A) 4000a, and fishing rod anchor (Type 4—Model B) 4000b to be attached to a fishing rod via fishing rod anchor (Type 3) handle shell 3010 and fishing rod anchor (Type 4) handle shell 4010. Rod tongue receiver (Type 3) 1260 comprises ten total components: rod tongue receiver (Type 3) chassis 1270, rod tongue receiver (Type 3) quick release 1280, rod tongue receiver (Type 3) quick release spring 1290, rod tongue receiver (Type 3) quick release hinge pin 1300, rod tongue receiver (Type 3) elevation adjustment rod 1310, rod tongue receiver (Type 3) elevation adjustment wing slide rod pin 1320, rod tongue receiver (Type 3) elevation adjustment wing 1330, rod tongue receiver (Type 3) elevation adjustment wing slide rod 1340, rod tongue receiver (Type 3) elevation adjustment rod pin 1350, and rod tongue receiver (Type 3) elevation adjustment wing slide rod spring 1360, all of which are shown in FIGS. 26a-26b.

Rod tongue receiver (Type 3) chassis 1270 may be substantially rectangular and elongated, or any other suitable shape. Rod tongue receiver (Type 3) chassis 1270 may, if desired, be cut, formed, or molded together into one solid, seamless, and uniform piece. The length and width of rod tongue receiver (Type 3) chassis 1270 may be of any desired dimension to accommodate rod tongue receiver (Type 3) quick release 1280, rod tongue receiver (Type 3) quick release spring 1290, rod tongue receiver (Type 3) quick release hinge pin 1300, rod tongue receiver (Type 3) elevation adjustment rod 1310, rod tongue receiver (Type 3) elevation adjustment rod pin 1320, rod tongue receiver (Type 3) elevation adjustment wing 1330, rod tongue receiver (Type 3) elevation adjustment wing slide rod 1340, rod tongue receiver (Type 3) elevation adjustment wing slide rod pin 1350, and rod tongue receiver (Type 3) elevation adjustment wing slide rod spring 1360.

Rod tongue receiver (Type 3) chassis 1270 serves three purposes, namely, (1) to form the central point or main structure from which rod tongue receiver (Type 3) quick release 1280, rod tongue receiver (Type 3) quick release spring 1290, rod tongue receiver (Type 3) quick release hinge pin 1300, rod tongue receiver (Type 3) elevation adjustment rod 1310, rod tongue receiver (Type 3) elevation adjustment rod pin 1320, rod tongue receiver (Type 3) elevation adjustment wing 1330, rod tongue receiver (Type 3) elevation adjustment wing slide rod 1340, rod tongue receiver (Type 3) elevation adjustment wing slide rod pin 1350, and rod tongue receiver (Type 3) elevation adjustment wing slide rod spring 1360 are connected to form rod tongue receiver (Type 3) 1260, (2) to form the structure that allows rod tongue receiver (Type 3) quick release 1280, rod tongue receiver (Type 3) quick release spring 1290, rod tongue receiver (Type 3) quick release hinge pin 1300, rod tongue receiver (Type 3) elevation adjustment rod 1310, rod tongue receiver (Type 3) elevation adjustment rod pin 1320, rod tongue receiver (Type 3) elevation adjustment wing 1330, rod tongue receiver (Type 3) elevation adjustment wing slide rod 1340, rod tongue receiver (Type 3) elevation adjustment wing slide rod pin 1350, and rod tongue receiver (Type 3) elevation adjustment wing slide rod spring 1360 to be connected to elevation dial (Type 3a) on fishing rod anchor (Type 3—Model A) 3000a or elevation dial (Type 3b) 1390 on fishing rod anchor (Type 3—Model B) 3000b and also anchor chassis member (Type 2) 1450 as shown in FIGS. 40a-40b on fishing rod anchor (Type 4—Model A) 4000a, and fishing rod anchor (Type 4—Model B) 4000b, and (3) to form the point at which a fishing rod connects to fishing rod anchor (Type 3—Model A) 3000a, fishing rod anchor (Type 3—Model B) 3000b, fishing rod anchor (Type 4—Model A) 4000a, or fishing rod anchor (Type 4—Model B) 4000b via fishing rod anchor (Type 3) handle shell 3010 or fishing rod anchor (Type 4) handle shell 4010.

Rod tongue receiver (Type 3) quick release 1280 may be substantially rectangular and elongated, or any other suitable shape. Rod tongue receiver (Type 3) quick release 1280 may, if desired, be cut, formed, or molded together into one solid, seamless, and uniform piece. The length and width of rod tongue receiver (Type 3) quick release 1280 may be of any desired dimension to accommodate rod tongue receiver (Type 3) chassis 1270, rod tongue receiver (Type 3) quick release spring 1290, and rod tongue receiver (Type 3) quick release hinge pin 1300. Rod tongue receiver (Type 3) quick release 1280 allows rod tongue receiver (Type 3) 1260 to be easily separate from and connect to a fishing rod via fishing rod anchor (Type 3) handle shell 3010 or fishing rod anchor (Type 4) handle shell 4010.

Rod tongue receiver (Type 3) quick release spring 1290 may be substantially round and elongated, or any other suitable shape. Rod tongue receiver (Type 3) quick release spring 1290 may, if desired, be cut, formed, or molded together into one solid, seamless, and uniform piece. The length and width of rod tongue receiver (Type 3) quick release spring 1290 may be of any desired dimension to accommodate rod tongue receiver (Type 3) chassis 1270, rod tongue receiver (Type 3) quick release 1280, and rod tongue receiver (Type 3) quick release hinge pin 1300. Rod tongue receiver (Type 3) quick release spring 1290 allows rod tongue receiver (Type 3) quick release 1280 to move up and down with the slightest bit of tension so that rod tongue receiver (Type 3) 1260 can be easily separate from and connect to a fishing rod via fishing rod anchor (Type 3) handle shell 3010 or fishing rod anchor (Type 4) handle shell 4010.

Rod tongue receiver (Type 3) quick release hinge pin 1300 may be substantially round and elongated, or any other suitable shape. Rod tongue receiver (Type 3) quick release hinge pin 1300 may, if desired, be cut, formed, or molded together into one solid, seamless, and uniform piece. The length and width of rod tongue receiver (Type 3) quick release hinge pin 1300 may be of any desired dimension to accommodate rod tongue receiver (Type 3) chassis 1270, rod tongue receiver (Type 3) quick release 1280, and rod tongue receiver (Type 3) quick release spring 1290. Rod tongue receiver (Type 3) quick release hinge pin 1300 connects rod tongue receiver (Type 3) quick release 1280 and rod tongue receiver (Type 3) quick release spring 1290 to rod tongue receiver (Type 3) chassis 1270. Rod tongue receiver (Type 3) quick release 1280 and rod tongue receiver (Type 3) quick release spring 1290 are both connected to rod tongue receiver (Type 3) chassis 1270 by rod tongue receiver (Type 3) quick release hinge pin 1300.

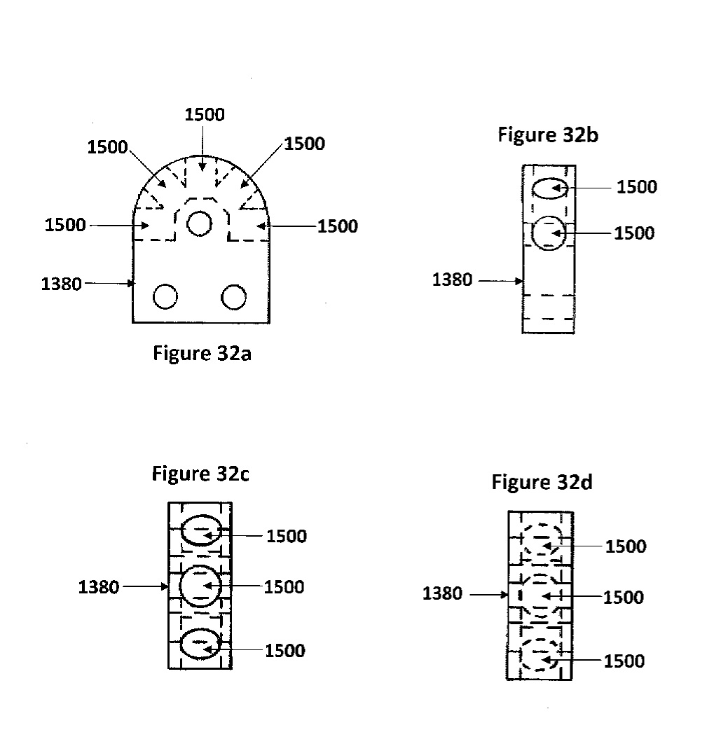

Rod tongue receiver (Type 3) elevation adjustment rod 1310 may be substantially round and elongated, or any other suitable shape. Rod tongue receiver (Type 3) elevation adjustment rod 1310 may, if desired, be cut, formed, or molded together into one solid, seamless, and uniform piece. The length and width of rod tongue receiver (Type 3) elevation adjustment rod 1310 may be of any desired dimension to accommodate rod tongue receiver (Type 3) elevation adjustment wing 1330, rod tongue receiver (Type 3) elevation adjustment rod pin 1320 and elevation dial (Type 3a) 1380 on fishing rod anchor (Type 3—Model A) 3000a or elevation dial (Type 3b) 1390 on fishing rod anchor (Type 3—Model B) 3000b and also anchor chassis member (Type 2) 1450 on fishing rod anchor (Type 4—Model A) 4000a and fishing rod anchor (Type 4—Model B) 4000b. Rod tongue receiver (Type 3) elevation adjustment rod 1310 serves one purpose, namely, to rest into one of several elevation holes 1500 shown, for example, in FIGS. 32a-33d and 41a-41e within elevation dial (Type 3a) 1380 on fishing rod anchor (Type 3—Model A) 3000a, elevation dial (Type 3b) 1390 on fishing rod anchor (Type 3—Model B) 3000b, and anchor chassis member (Type 2) 1450 on fishing rod anchor (Type 4—Model A) 4000a and fishing rod anchor (Type 4—Model B) 4000b locking rod tongue receiver (Type 3) 1260 into an elevated position as determined by the user.

Rod tongue receiver (Type 3) elevation adjustment rod pin 1320 may be substantially round and elongated, or any other suitable shape. Rod tongue receiver (Type 3) elevation adjustment rod pin 1320 may, if desired, be cut, formed, or molded together into one solid, seamless, and uniform piece. The length and width of rod tongue receiver (Type 3) elevation adjustment rod pin 1320 may be of any desired dimension to accommodate rod tongue receiver (Type 3) elevation adjustment wing 1330, and rod tongue receiver (Type 3) elevation adjustment rod 1310. Rod tongue receiver (Type 3) elevation adjustment rod pin 1320 connects rod tongue receiver (Type 3) elevation adjustment rod 1310 to rod tongue receiver (Type 3) elevation adjustment wing 1330.

Rod tongue receiver (Type 3) elevation adjustment wing 1330 may be substantially rectangular and elongated, or any other suitable shape. Rod tongue receiver (Type 3) elevation adjustment wing 1330 may, if desired, be cut, formed, or molded together into one solid, seamless, and uniform piece. The length and width of rod tongue receiver (Type 3) elevation adjustment wing 1330 may be of any desired dimension to accommodate rod tongue receiver (Type 3) chassis 1270, rod tongue receiver (Type 3) elevation adjustment rod 1310, rod tongue receiver (Type 3) elevation adjustment rod pin 1320, rod tongue receiver (Type 3) elevation adjustment wing slide rod 1340, rod tongue receiver (Type 3) elevation adjustment wing slide rod pin 1350, and rod tongue receiver (Type 3) elevation adjustment wing slide rod spring 1360. Rod tongue receiver (Type 3) elevation adjustment wing 1330 serves two purposes, namely, (1) to securely hold rod tongue receiver (Type 3) elevation adjustment rod 1310 using rod tongue receiver (Type 3) elevation adjustment rod pin 1320, and (2) to slide in a forward motion along the longitudinal axis of rod tongue receiver (Type 3) elevation adjustment wing slide rod 1340, moving rod tongue receiver (Type 3) elevation adjustment rod 1310 away from elevation dial (Type 3a) 1380 on fishing rod anchor (Type 3—Model A) 3000a or elevation dial (Type 3b) 1390 on fishing rod anchor (Type 3—Model B) 3000b and also anchor chassis member (Type 2) 1450 on fishing rod anchor (Type 4—Model A) 4000a and fishing rod anchor (Type 4—Model B) 4000b thereby releasing rod tongue receiver (Type 3) 1260 and allowing it to move freely in a circular motion around elevation dial (Type 3a) 1380 shown in FIG. 38b, elevation dial (Type 3b) 1390 shown in FIG. 38d, and anchor chassis member (Type 2) 1450 shown in FIGS. 43b and 43d.

Rod tongue receiver (Type 3) elevation adjustment wing slide rod 1340 may be substantially round and elongated, or any other suitable shape. Rod tongue receiver (Type 3) elevation adjustment wing slide rod 1340 may, if desired, be cut, formed, or molded together into one solid, seamless, and uniform piece. The length and width of rod tongue receiver (Type 3) elevation adjustment wing slide rod 1340 may be of any desired dimension to accommodate rod tongue receiver (Type 3) chassis 1270, rod tongue receiver (Type 3) elevation adjustment wing 1330, rod tongue receiver (Type 3) elevation adjustment wing slide rod pin 1350, and rod tongue receiver (Type 3) elevation adjustment wing slide rod spring 1360. Rod tongue receiver (Type 3) elevation adjustment wing slide rod 1340 forms a stable platform for rod tongue receiver (Type 3) elevation adjustment wing 1330 to reside and perform its intended function.

Rod tongue receiver (Type 3) elevation adjustment wing slide rod pin 1350 may be substantially round and elongated or any other suitable shape. Rod tongue receiver (Type 3) elevation adjustment wing slide rod pin 1350 may, if desired, be cut, formed, or molded together into one solid, seamless, and uniform piece. The length and width of rod tongue receiver (Type 3) elevation adjustment wing slide rod pin 1350 may be of any desired dimension to accommodate rod tongue receiver (Type 3) chassis 1270 and rod tongue receiver (Type 3) elevation adjustment wing slide rod 1340. Rod tongue receiver (Type 3) elevation adjustment wing slide rod pin 1350 attaches rod tongue receiver (Type 3) elevation adjustment wing slide rod 1340 to rod tongue receiver (Type 3) chassis 1270.

Rod tongue receiver (Type 3) elevation adjustment wing slide rod spring 1360 may be substantially round and elongated, or any other suitable shape. Rod tongue receiver (Type 3) elevation adjustment wing slide rod spring 1360 may, if desired, be cut, formed, or molded together into one solid, seamless, and uniform piece. The length and width of rod tongue receiver (Type 3) elevation adjustment wing slide rod spring 1360 may be of any desired dimension to accommodate rod tongue receiver (Type 3) elevation adjustment wing 1330 and rod tongue receiver (Type 3) elevation adjustment wing slide rod 1340. Rod tongue receiver (Type 3) elevation adjustment wing slide rod spring 1360 serves one purpose, namely, to push rod tongue receiver (Type 3) elevation adjustment wing 1330 back along the longitudinal axis of rod tongue receiver (Type 3) elevation adjustment wing slide rod 1340 forcing rod tongue receiver (Type 3) elevation adjustment rod 1310 toward elevation dial (Type 3a) 1380 on fishing rod anchor (Type 3—Model A) 3000a or elevation dial (Type 3b) 1390 on fishing rod anchor (Type 3—Model B) 3000b and also anchor chassis member (Type 2) 1450 on fishing rod anchor (Type 4—Model A) 4000a and fishing rod anchor (Type 4—Model B) 4000b and into one of several elevation holes 1500 locking rod tongue receiver (Type 3) 1260 into an elevated position as determined by the user.

Rod tongue receiver (Type 3) hinge pin 1370 shown in FIG. 26a is the point at which rod tongue receiver (Type 3) 1260 connects to elevation dial (Type 3a) 1380 on fishing rod anchor (Type 3—Model A) 3000a, elevation dial (Type 3b) 1390 on fishing rod anchor (Type 3—Model B) 3000b, or anchor chassis member (Type 2) 1450 on fishing rod anchor (Type 4—Model A) 4000a and fishing rod anchor (Type 4—Model B) 4000b. Rod Tongue Receiver (Type 3) Hinge Pin 1370 may be substantially round and elongated, or any other suitable shape. Rod tongue receiver (Type 3) hinge pin 1370 may, if desired, be cut, formed, or molded together into one solid, seamless, and uniform piece. The length and width of rod tongue receiver (Type 3) hinge pin 1370 may be of any desired dimension to accommodate rod tongue receiver (Type 3) 1260, elevation dial (Type 3a) 1380, elevation dial (Type 3b) 1390, and anchor chassis member (Type 2) 1450. Rod tongue receiver (Type 3) hinge pin 1370 serves two purposes, namely, (1) to connect rod tongue receiver (Type 3) 1260 to elevation dial (Type 3a) 1380, elevation dial (Type 3b) 1390, and anchor chassis member (Type 2) 1450, and (2) to allow rod tongue receiver (Type 3) 1260 to travel in a 180° circular motion around elevation dial (Type 3a) 1380, elevation dial (Type 3b) 1390, and anchor chassis member (Type 2) 1450.

As discussed above, the elevation dial comes in two types, Type 3a and Type 3b. Elevation dial (Type 3a) 1380 is used specifically on fishing rod anchor (Type 3—Model A) 3000a and elevation dial (Type 3b) 1390 is used specifically on fishing rod anchor (Type 3—Model B) 3000b. Both elevation dial (Type 3a) 1380 and elevation dial (Type 3b) 1390 have several holes or depressions 1500 along their top surface. Elevation holes 1500 are set at any desired predetermined positions and rod tongue receiver (Type 3) 1260 locks into one of these holes via rod tongue receiver (Type 3) elevation adjustment rod 1310 allowing fishing rod anchor (Type 3—Model A) 3000a or fishing rod anchor (Type 3—Model B) 3000b to be positioned at different elevations as determined by the user.

Although elevation dial (Type 3a) 1380 and elevation dial (Type 3b) 1390 are the same in function, they vary slightly in design. Both elevation dial (Type 3a) 1380 and elevation dial (Type 3b) 1390 typically have five or more elevation holes 1500, one rod tongue receiver (Type 3) hinge pin 1370 hole, and two ground spike connector pin 1430 holes. The main difference between elevation dial (Type 3a) 1380 and elevation dial (Type 3b) 1390 is the addition of ground spike extension rod 1440 hole located only on elevation dial (Type 3b) 1390.

Elevation dial (Type 3a) 1380 may be substantially rectangular and elongated, or any other suitable shape. Elevation dial (Type 3a) 1380 may, if desired, be cut, formed, or molded together into one solid, seamless, and uniform piece. The length and width of elevation dial (Type 3a) 1380 may be of any desired dimension to accommodate the rod tongue receiver (Type 3) 1260, rod tongue receiver (Type 3) hinge pin 1370, kick plate 1400, ground spike (Type 3a) 1410 and ground spike connector pins 1430. Elevation dial (Type 3a) 1380 serves two purposes, namely, (1) to provide an attachment point for all of the main components of fishing rod anchor (Type 3—Model A) 3000a including rod tongue receiver (Type 3) 1260, rod tongue receiver (Type 3) hinge pin 1370, kick plate 1400, ground spike (Type 3a) 1410 and ground spike connector pin 1430, and (2) to provide the user a mechanism (e.g., elevation holes 1500) so as to elevate fishing rod anchor (Type 3—Model A) 3000a to a desired position for fishing.

Elevation dial (Type 3b) 1390 may be substantially rectangular and elongated, or any other suitable shape. Elevation dial (Type 3b) 1390 may, if desired, be cut, formed, or molded together into one solid, seamless, and uniform piece. The length and width of elevation dial (Type 3b) 1390 may be of any desired dimension to accommodate rod tongue receiver (Type 3) 1260, rod tongue receiver (Type 3) hinge pin 1370, kick plate 1400, ground spike (Type 3b) 1420, ground spike connector pins 1430, and ground spike extension rod 1440. Elevation dial (Type 3b) 1390 serves two purposes, namely, (1) to provide an attachment point for all of the main components of fishing rod anchor (Type 3—Model B) 3000b including rod tongue receiver (Type 3) 1260, rod tongue receiver (Type 3) hinge pin 1370, kick plate 1400, ground spike (Type 3b) 1420, ground spike connector pins 1430, and ground spike extension rod 1440, and (2) to provide the user a mechanism (e.g., elevation holes 1500) so as to elevate fishing rod anchor (Type 3—Model B) 3000b to a desired position for fishing.

Kick plate 1400 is located at the aft end of fishing rod anchor (Type 3—Model A) 3000a and fishing rod anchor (Type 3—Model B) 3000b. Kick plate 1400 is connected to elevation dial (Type 3a) 1380 or elevation dial (Type 3b) 1390 via ground spike connector pins 1430. Kick plate 1400 usually has a flat surface on its aft end and is used by the user to push or kick against and force a downward motion on either ground spike (Type 3a) 1410 or ground spike (Type 3b) 1420 so as to penetrate hard ground.

Kick Plate 1400 may be substantially rectangular and elongated, or any other suitable shape. Kick plate 1400 may, if desired, be cut, formed, or molded together into one solid, seamless, and uniform piece. The length and width of kick plate 1400 may be of any desired dimension to accommodate elevation dial (Type 3a) 1380, elevation dial (Type 3b) 1390, ground spike (Type 3a) 1410, ground spike connector pins 1430, and ground spike extension rod 1440. Kick plate 1400 provides a user with a mechanism of forcing a downward motion on either ground spike (Type 3a) 1410 or ground spike (Type 3b) 1420 so as to penetrate hard ground.

As discussed above, ground spikes of the present invention comes in two types: Type 3a and Type 3b. Ground spike (Type 3a) 1410 is used specifically on fishing rod anchor (Type 3—Model A) 3000a while ground spike (Type 3b) 1420 is used specifically on fishing rod anchor (Type 3—Model B) 3000b. Ground spike (Type 3a) 1410 and ground spike (Type 3b) 1420 both serve to secure fishing rod anchor (Type 3—Model A) 3000a or fishing rod anchor (Type 3—Model B) 3000b into the ground allowing the user a platform in which to fish, while limiting the possibility of the grounded/anchored fishing rod being pulled into water. Although ground spike (Type 3a) 1410 and ground spike (Type 3b) 1420 are the same in function, they vary slightly in design.

Both ground spike (Type 3a) 1410 and ground spike (Type 3b) 1420 have elongated shafts suitable for penetrating the ground, but each one has different means of connecting to elevation dial (Type 3a) 1380 or elevation dial (Type 3b) 1390. Ground spike (Type 3a) 1410 connects directly to elevation dial (Type 3a) 1380 via ground spike connector pins 1430. Ground spike (Type 3b) 1420 connects to elevation dial (Type 3b) 1390 via ground spike extension rod 1440, which is then connected to elevation dial (Type 3b) 1390 via ground spike connector pins 1430.

Ground spike (Type 3a) 1410 may be substantially rectangular and elongated, or any other suitable shape. Ground spike (Type 3a) 1410 may, if desired, be cut, formed, or molded together into one solid, seamless, and uniform piece. The length and width of ground spike (Type 3a) 1410 may be of any desired dimension to accommodate elevation dial (Type 3a) 1380, kick plate 1400, ground spike connector pins 1430, and fishing rod anchor (Type 3) handle shell 3010. Ground spike (Type 3a) 1410 serves one purpose, namely, to secure fishing rod anchor (Type 3—Model A) 3000a into the ground.

Ground spike (Type 3b) 1420 may be substantially rectangular and elongated, or any other suitable shape. Ground spike (Type 3b) 1420 may, if desired, be cut, formed, or molded together into one solid, seamless, and uniform piece. The length and width of ground spike (Type 3b) 1420 may be of any desired dimension to accommodate ground spike extension rod 1440 and fishing rod anchor (Type 3) handle shell 3010. Ground spike (Type 3b) 1420 serves one purpose, namely, to secure fishing rod anchor (Type 3—Model B) 3000b into the ground.

Ground spike connector pins 1430 may be substantially round and elongated, or any other suitable shape. Ground spike connector pins 1430 may, if desired, be cut, formed, or molded together into one solid, seamless, and uniform piece. The length and width of each ground spike connector pin 1430 may be of any desired dimension to accommodate elevation dial (Type 3a) 1380, elevation dial (Type 3b) 1390, kick plate 1400, ground spike (Type 3a) 1410 and ground spike extension rod 1440. Ground spike connector pins 1430 serve one purpose, namely, to secure kick plate 1400 and ground spike (Type 3a) 1410 to elevation dial (Type 3a) 1380 on fishing rod anchor (Type 3—Model A) 3000a or kick plate 1400 and ground spike extension rod 1440 to elevation dial (Type 3b) 1390 on fishing rod anchor (Type 3—Model B) 3000b.

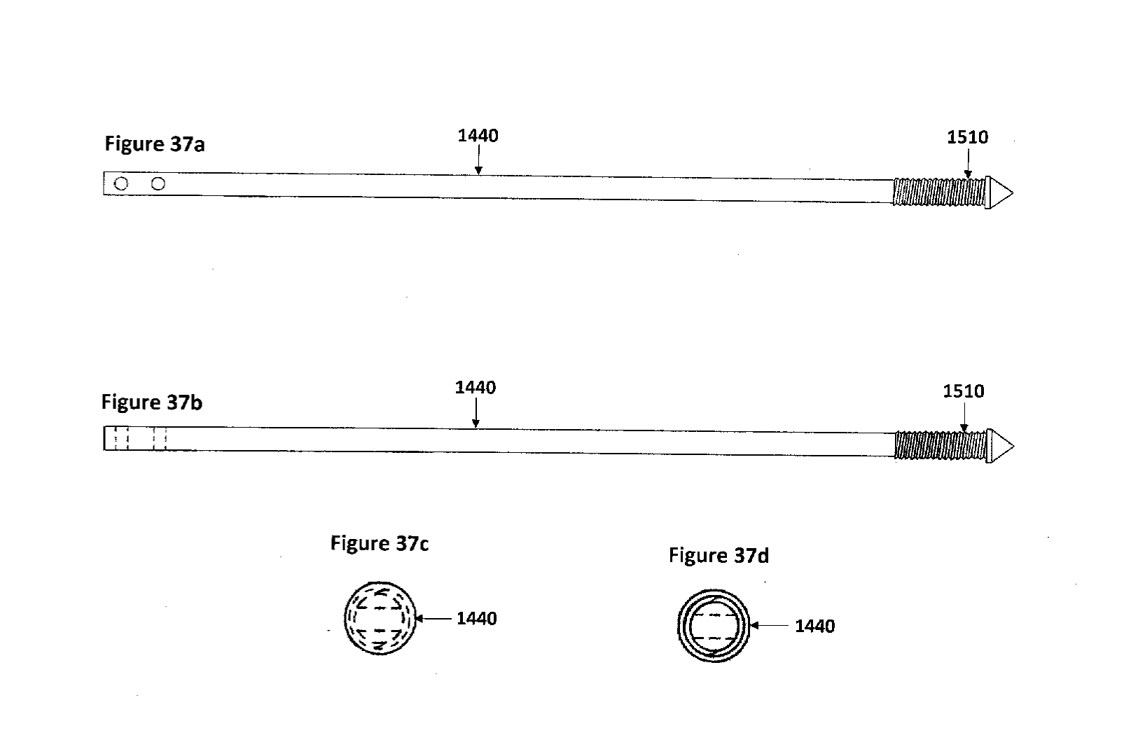

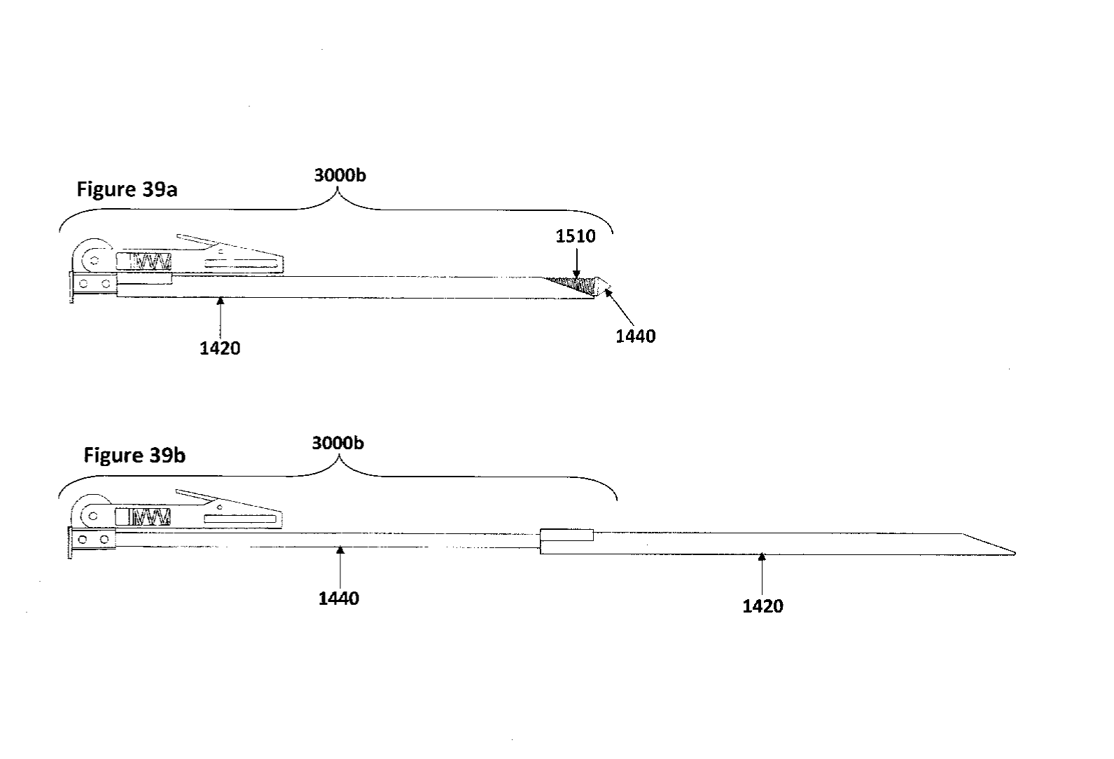

Ground spike extension rod 1440 is used specifically on fishing rod anchor (Type 3—Model B) 3000b. The aft end of ground spike extension rod 1440 is connected to elevation dial (Type 3b) 1390 by ground spike connector pins 1430. Ground spike (Type 3b) 1420 is connected to ground spike extension rod 1440 and slides along its lateral axis in a forward or backward direction. When stored, ground spike (Type 3b) 1420 typically slides to the aft of ground spike extension rod 1440 and when in use ground spike (Type 3b) 1420 slides forward and is locked into place by ground spike extension rod threads 1510 shown in FIGS. 37a-37b and 39a located on an outside circumference at the forward end of ground spike extension rod 1440.

Ground spike extension rod 1440 is static, does not move, and is permanently connected to elevation dial (Type 3b) 1390. While ground spike extension rod 1440 remains static, ground spike (Type 3b) 1420 is allowed to move along its axis. Ground spike extension rod 1440 doubles an overall length of fishing rod anchor (Type 3—Model B) 3000b and allows ground spike (Type 3b) 1420 to go deeper into the ground for a more secure platform from which to fish.

Ground spike extension rod 1440 may be substantially round and elongated, or any other suitable shape. Ground spike extension rod 1440 may, if desired, be cut, formed, or molded together into one solid, seamless, and uniform piece. The length and width of ground spike extension rod 1440 may be of any desired dimension to accommodate elevation dial (Type 3b) 1390, kick plate 1400, ground spike (Type 3b) 1420, ground spike connector pins 1430, and fishing rod anchor (Type 3) handle shell 3010. Ground spike extension rod 1440 serves two purposes, namely, (1) to act as an attachment so ground spike (Type 3b) 1420 can connect to elevation dial (Type 3b) 1390, and (2) to increase the length of ground spike (Type 3b) 1420, doubling the overall length of fishing rod anchor (Type 3—Model B) 3000b.

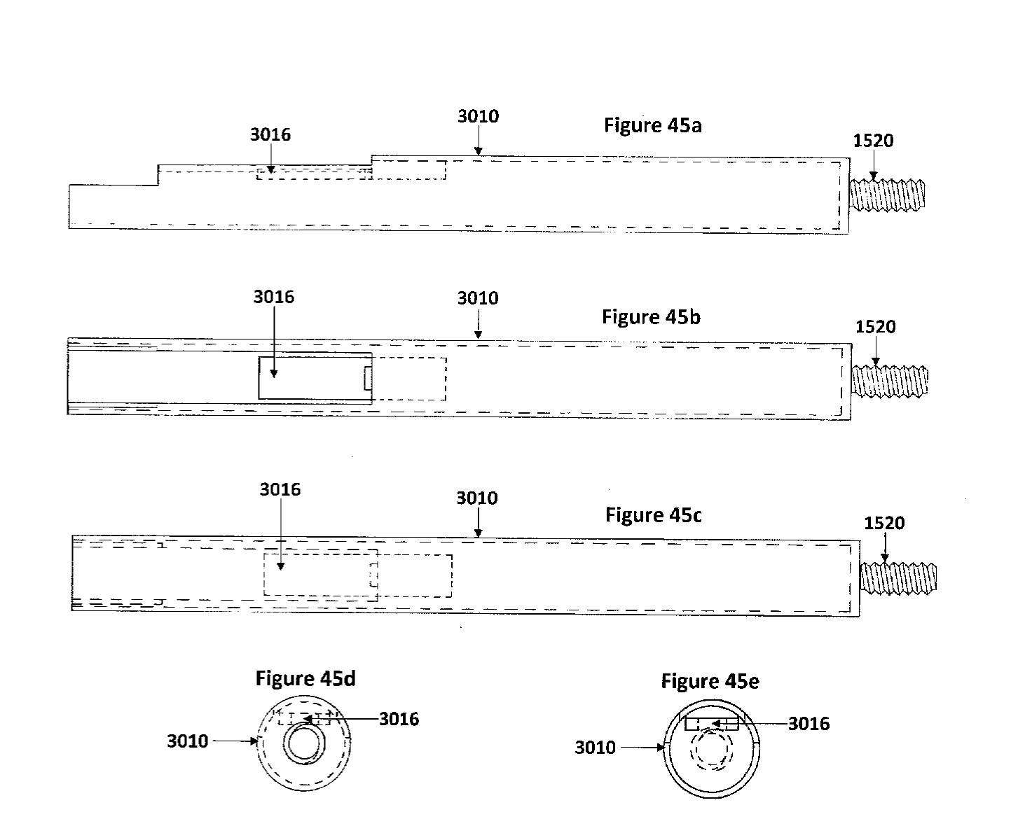

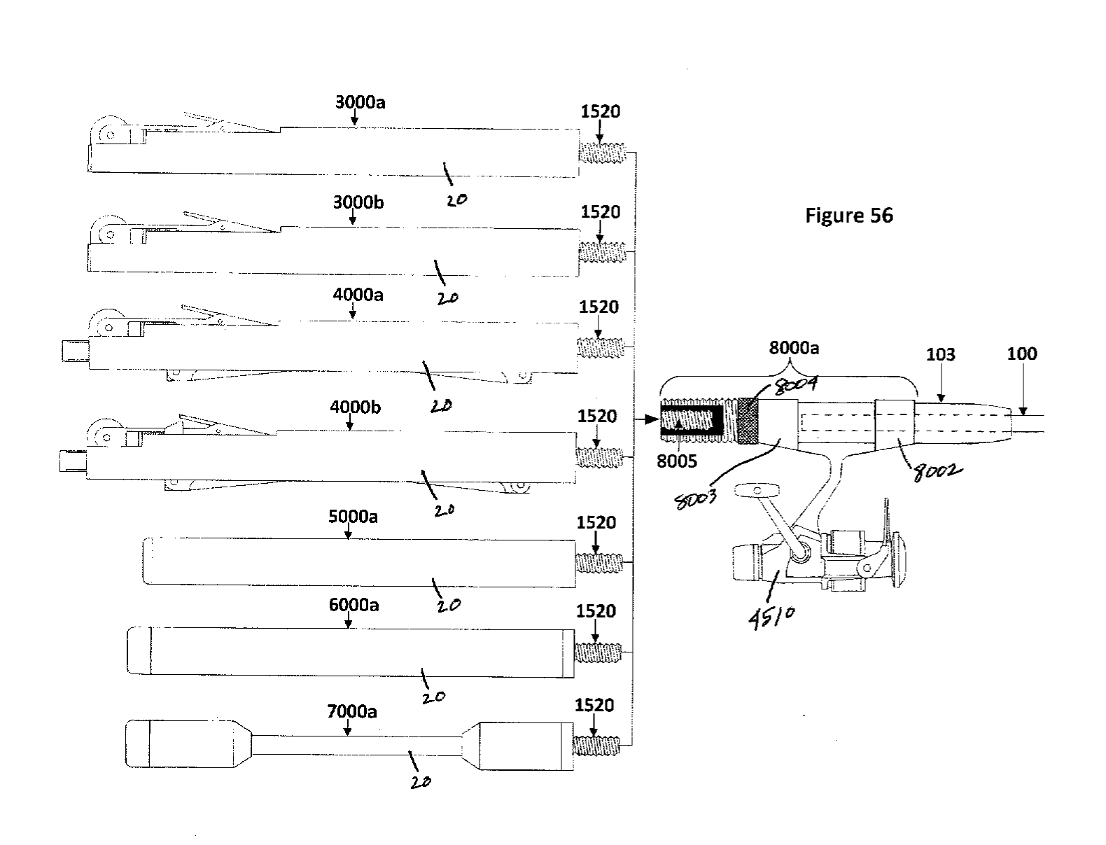

Fishing rod anchor (Type 3) handle shell 3010 conceals fishing rod anchor (Type 3—Model A) 3000a and fishing rod anchor (Type 3—Model B) 3000b and connects them both to a fishing rod via a fishing rod reel seat such as exemplary fishing rod reel seats 8000a and 8000b shown in FIG. 56. Similar to fishing rod anchor (Type 2) handle shell 2010, fishing rod anchor (Type 3) handle shell 3010 has threaded connector rod 1520 (shown in FIGS. 25c-25d) on its forward end so as to connect to a fishing rod reel seat such as exemplary fishing rod reel seats 8000a and 8000b. Toward the aft end of fishing rod anchor (Type 3) handle shell 3010 is a protrusion or tongue 3016 as shown in FIGS. 45a-45c, similar to tongue 2017 of fishing rod anchor (Type 2) handle shell 2010. Tongue 3016 connects to rod tongue receiver (Type 3) 1260 thereby forming fishing rod anchor (Type 3—Model A) 3000a or fishing rod anchor (Type 3—Model B) 3000b.

Fishing rod anchor (Type 3) handle shell 3010 may be substantially round and elongated, or any other suitable shape. Fishing rod anchor (Type 3) handle shell 3010 may, if desired, be cut, formed, or molded together into one solid, seamless, and uniform piece. The length and width of fishing rod anchor (Type 3) handle shell 3010 may be of any desired dimension to accommodate fishing rod anchor (Type 3—Model A) 3000a or fishing rod anchor (Type 3—Model B) 3000b. Fishing rod anchor (Type 3) handle shell 3010 serves three purposes, namely, (1) to conceal and protect fishing rod anchor (Type 3—Model A) 3000a or fishing rod anchor (Type 3—Model B) 3000b, (2) to form the connecting point for either fishing rod anchor (Type 3—Model A) 3000a or fishing rod anchor (Type 3—Model B) 3000b and a fishing rod reel seat, such as exemplary fishing rod reel seats 8000a and 8000b shown in FIG. 56, and (3) to allow for the interchangeability of fishing rod handles (e.g., exemplary interchangeable fishing rod handles 3000a to 7000a shown in FIG. 56).

Other fishing rod anchors of the present invention include (i) fishing rod anchor (Type 4—Model A) 4000a shown in FIGS. 40a and 40c, and (ii) fishing rod anchor (Type 4—Model B) 4000b shown in FIGS. 40b and 40d. Fishing rod anchor (Type 4—Model A) 4000a and fishing rod anchor (Type 4—Model B) 4000b are also referred to herein as concealed fishing rod anchors because they are recessed into and form a handle of a fishing rod. Fishing rod anchor (Type 4—Model A) 4000a is concealed within an outer shell, which forms the fishing rod handle 20 shown in FIG. 40c, while fishing rod anchor (Type 4—Model B) 4000b is concealed within an outer shell, which forms the fishing rod handle 20 shown in FIG. 40d. This outer shell is referred to herein as fishing rod anchor (Type 4) handle shell 4010.

Fishing rod anchor (Type 4) handle shell 4010 can usually accommodate either of fishing rod anchor (Type 4—Model A) 4000a or fishing rod anchor (Type 4—Model B) 4000b with just slight width modifications on the later. Fishing rod anchor (Type 4) handle shell 4010 is identical in function as both fishing rod anchor (Type 2) handle shell 2010 and fishing rod anchor (Type 3) handle shell 3010. The design of fishing rod anchor (Type 4) handle shell 4010 is almost identical to that of fishing rod anchor (Type 2) handle shell 2010 but differs slightly from that of fishing rod anchor (Type 3) handle shell 3010.

Fishing rod anchor (Type 4—Model A) 4000a and fishing rod anchor (Type 4—Model B) 4000b use many of the same components as fishing rod anchor (Type 1) 1000a and 1000b and fishing rod anchor (Type 2) 2000a and 2000b including: adjustable clamp lever 1050, adjustable clamp lever hinge 1060, adjustable clamp lever hinge pin 1070, static clamp lever 1080, static clamp lever hinge pin 1090, threaded clamp rod 1110, clamp rod handle 1120, and clamp rod handle hinge pin 1130. Fishing rod anchor (Type 4—Model A) 4000a and fishing rod anchor (Type 4—Model B) 4000b also use many of the same components as fishing rod anchor (Type 3—Model A) 3000a and fishing rod anchor (Type 3—Model B) 3000b including: rod tongue receiver (Type 3) chassis 1270, rod tongue receiver (Type 3) quick release 1280, rod tongue receiver (Type 3) quick release spring 1290, rod tongue receiver (Type 3) quick release hinge pin 1300, rod tongue receiver (Type 3) elevation adjustment rod 1310, rod tongue receiver (Type 3) elevation adjustment rod pin 1320, rod tongue receiver (Type 3) elevation adjustment wing 1330, rod tongue receiver (Type 3) elevation adjustment wing slide rod 1340, rod tongue receiver (Type 3) elevation adjustment wing slide rod pin 1350, rod tongue receiver (Type 3) elevation adjustment wing slide rod spring 1360, and rod tongue receiver (Type 3) hinge pin 1370.

Anchor chassis member (Type 2) 1450 appears on both fishing rod anchor (Type 4—Model A) 4000a and fishing rod anchor (Type 4—Model B) 4000b whereas swing clamp 1460 only appears on fishing rod anchor (Type 4—Model B) 4000b. Anchor chassis member (Type 2) 1450 is similar in design and function to anchor chassis member (Type 1) 1010 with a few modifications. Anchor chassis member (Type 2) 1450 comes with an elevation dial similar to elevation dial (Type 3a) 1380 and elevation dial (Type 3b) 1390. The elevation dial on anchor chassis member (Type 2) 1450 is mounted directly to the chassis unlike elevation dial (Type 3a) 1380 and elevation dial (Type 3b) 1390, which are separate units and are not connected to a chassis. The elevation dial on anchor chassis member (Type 2) 1450 has only elevation holes 1500 and rod tongue receiver (Type 3) hinge pin 1370 hole. Anchor chassis member (Type 1) 1010 does not show the elevation dial as on anchor chassis member (Type 2) 1450, but it can be easily modified to accept it. The elevation dial can be used on both anchor chassis member (Type 1) 1010 and anchor chassis member (Type 2) 1450. The main difference between anchor chassis member (Type 2) 1450 and anchor chassis member (Type 1) 1010 is that anchor chassis member (Type 2) 1450 is used specifically for clamping operations and it is not capable of accepting a ground spike.

Anchor chassis member (Type 2) 1450 may be substantially rectangular and elongated, or any other suitable shape. Anchor chassis member (Type 2) 1450 may, if desired, be cut, formed, or molded together into one solid, seamless, and uniform piece. The length and width of anchor chassis member (Type 2) 1450 may be of any desired dimension to accommodate fishing rod anchor (Type 4—Model A) 4000a or fishing rod anchor (Type 4—Model B) 4000b. Anchor chassis member (Type 2) 1450 serves one main purpose, namely, to form the central point or main structure from which all other pieces are connected to form fishing rod anchor (Type 4—Model A) 4000a or fishing rod anchor (Type 4—Model B) 4000b.

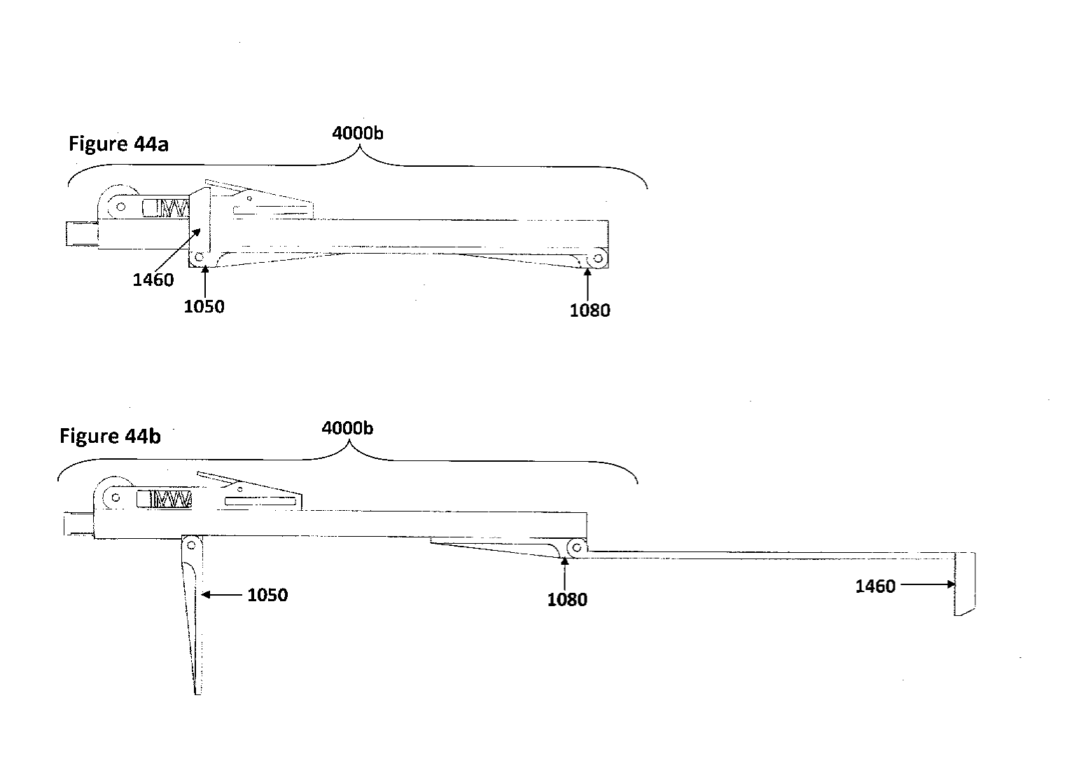

Swing clamp 1460 is the main component that distinguishes fishing rod anchor (Type 4—Model B) 4000b from fishing rod anchor (Type 4—Model A) 4000a. With the addition of swing clamp 1460, a clamping length of fishing rod anchor (Type 4—Model B) 4000b is doubled, permitting a user to attach to objects having a wider clamping dimension. Swing clamp 1460 can rotate 180° from a fully closed position shown in FIG. 44a to a fully open position shown in FIG. 44b, thus doubling the clamping capability of fishing rod anchor (Type 4—Model B) 4000b.

Swing Clamp 1460 allows fishing rod anchor (Type 4—Model B) 4000b to be attached to any side of a dock without rails or any vertical standing structures. Swing clamp 1460 may be substantially rectangular and elongated, or any other suitable shape. Swing clamp 1460 may, if desired, be cut, formed, or molded together into one solid, seamless, and uniform piece. The length and width of swing clamp 1460 may be of any desired dimension to accommodate anchor chassis member (Type 2) 1450. Swing clamp 1460 serves one main purpose, namely, to provide fishing rod anchor (Type 4—Model B) 4000b greater clamping capacity.

As shown in the figures, the present invention discloses a variety of interchangeable fishing rod handles (IFRHs) 20 (also referred to herein as “removable fishing rod handles 20”) and, in some embodiments, an internal thread reel seat (ITRS) specially designed to accept the IFRHs for the purpose of removably securing a given IFRH to a fishing rod, desirably, without the use of any tools. The disclosed IFRHs connect to a fishing rod via an ITRS (or some other handle connecting member) in the end of the fishing rod. The ITRS has a threaded receiving end that accepts all standard and/or metric threads of the IFRH. This allows the changing out of several different types of IFRHs that have an opposing threaded protrusion.

The advantage of having an IFRH and ITRS is that it allows the user to switch between a variety of multiple styles of fishing rod handles. This allows the user to modify his or her handle depending on the situation without having to use a different fishing rod. The IFRH and ITRS give the user the flexibility of having a functional and aesthetically appealing alternative to the current handles in the marketplace.

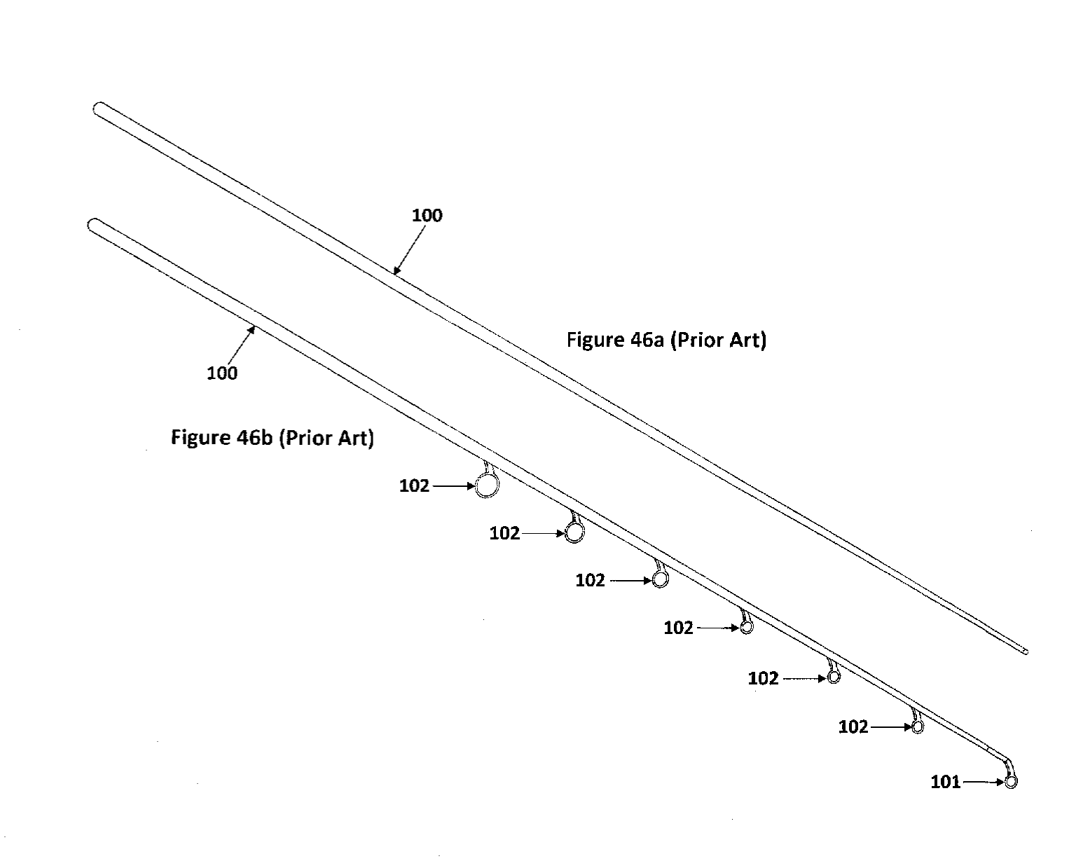

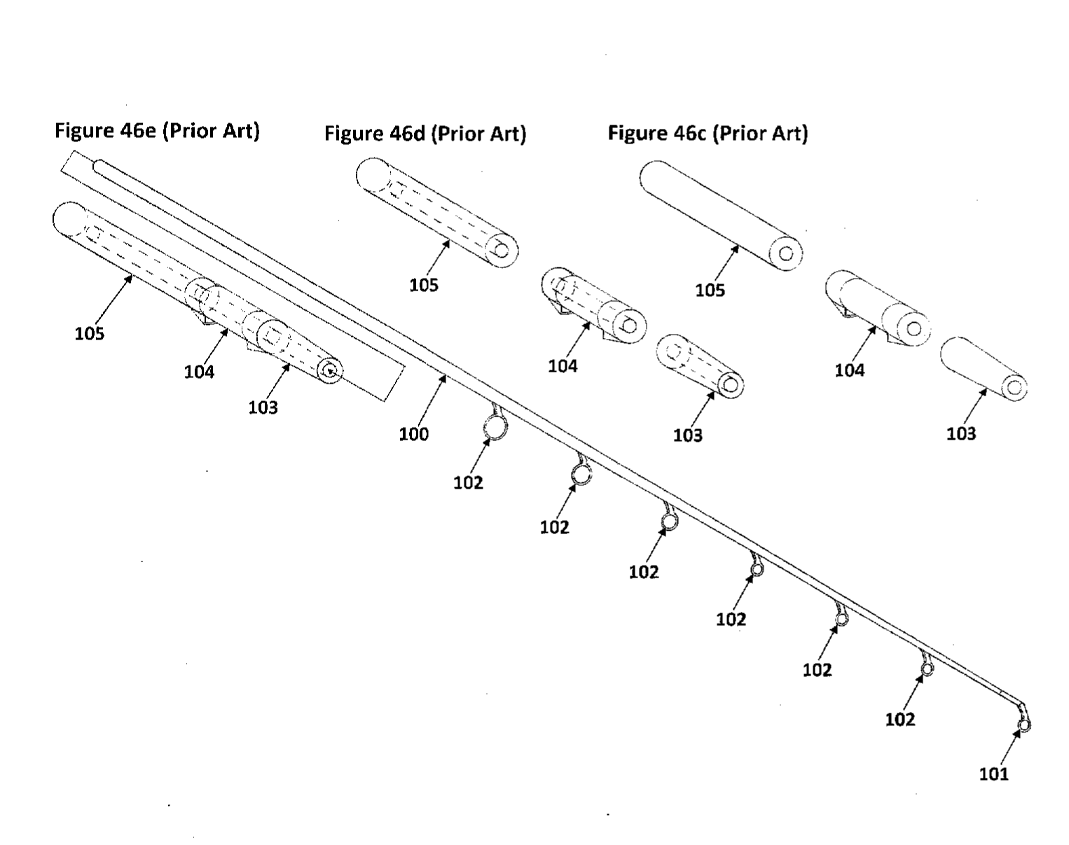

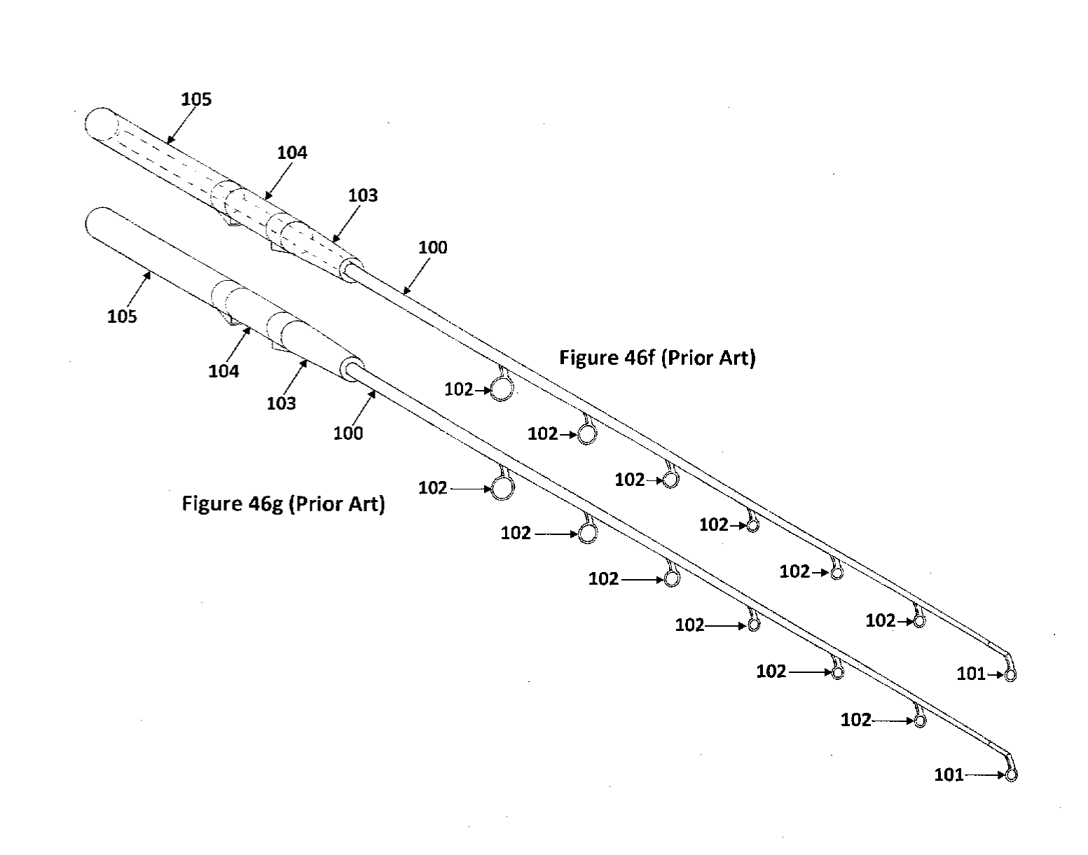

Prior to the present invention, various types of handles and reel seats have traditionally been mounted or secured directly and permanently to a fishing rod (i.e., a fishing rod blank as shown in FIG. 46a). These handles and reel seats have been secured directly to a fishing rod due to the construction and makeup of the fishing rod itself. All fishing rods are typically made using (1) standard rod blanks 100 as shown, for example, in FIGS. 46a-46b; (2) a standard rod tip eyelet 101 as shown, for example, in FIGS. 46a-46b; (3) standard eyelets 102 as shown, for example, in FIGS. 46a-46b; (4) a standard fore grip 103 as shown, for example, in FIGS. 46c-46e; (5) a reel seat 104 as shown, for example, in FIGS. 46c-46e; and (6) a standard rod handle 105 as shown, for example, in FIGS. 46c-46e. As shown in FIGS. 46c-46e, in prior art fishing rod and reels, standard rod blanks 100 form one continuous and unbroken connection that extends from standard rod tip eyelet 101 thru a standard fore grip 103, a reel seat 104, and the standard rod handle 105, ending at the aft of standard rod handle 105.

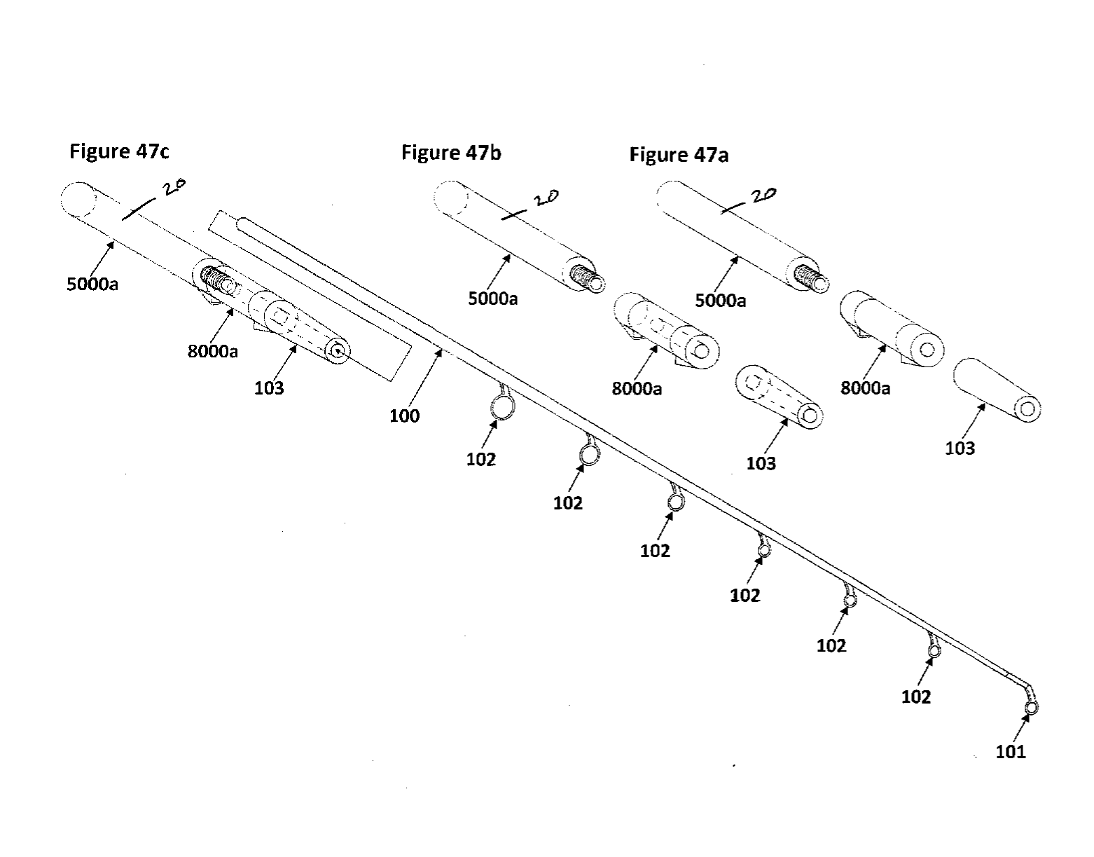

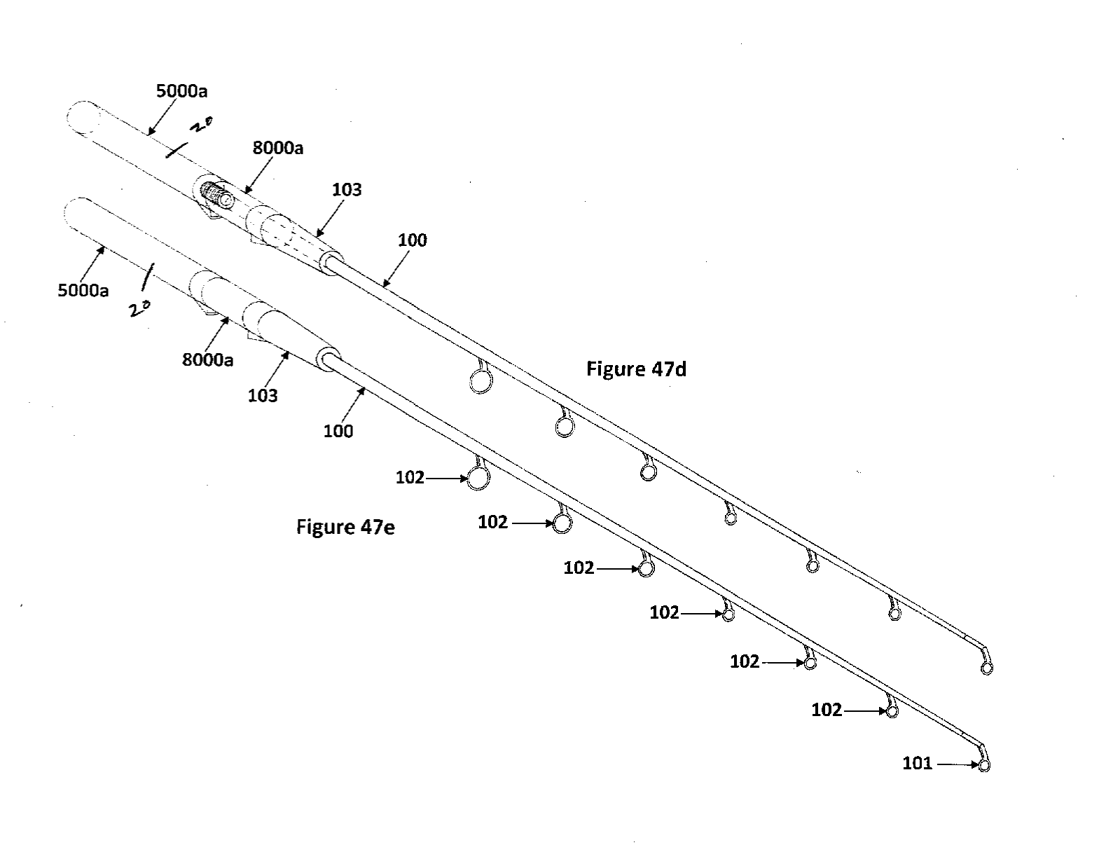

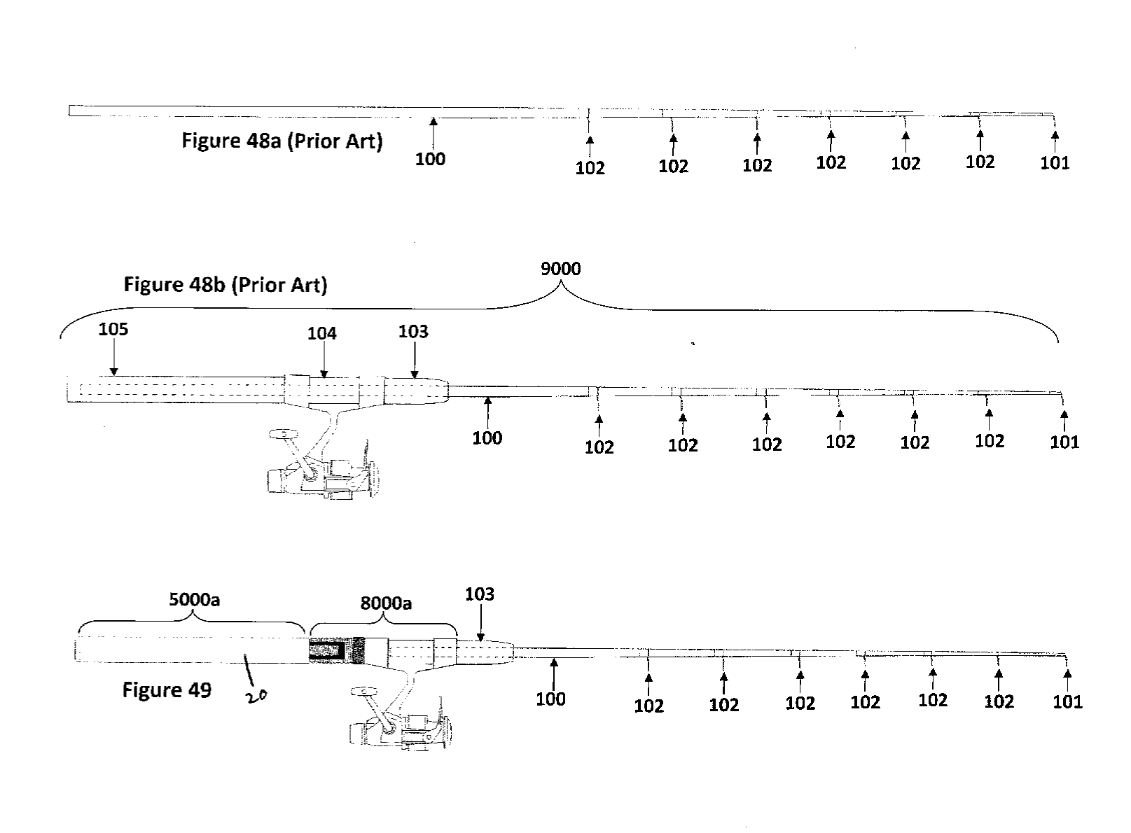

The present invention utilizes standard rod blank 100 starting at rod tip eyelet 101, continuing thru standard fore grip 103 and ending half way thru a specially designed fishing rod reel seat such as exemplary fishing rod reel seats 8000a and 8000b. The present invention allows a user to interchange various removable fishing rod handles 20. Examples of where standard rod blank 100 ends in the present invention are shown in FIGS. 47b-47d, 49 and 56.

Exemplary fishing rod handles of the present invention are referred to herein as interchangeable fishing rod handles (IFRHs) such as IFRHs 5000a, 6000a and 7000a shown in FIGS. 47a-47e, 49, 50a-52d, and 56. Exemplary fishing rod reel seats of the present invention are referred to herein as internal thread reel seats (ITRSs) such as ITRSs 8000a and 8000b shown in FIGS. 47a-47e, 49, 53a-54d and 56.

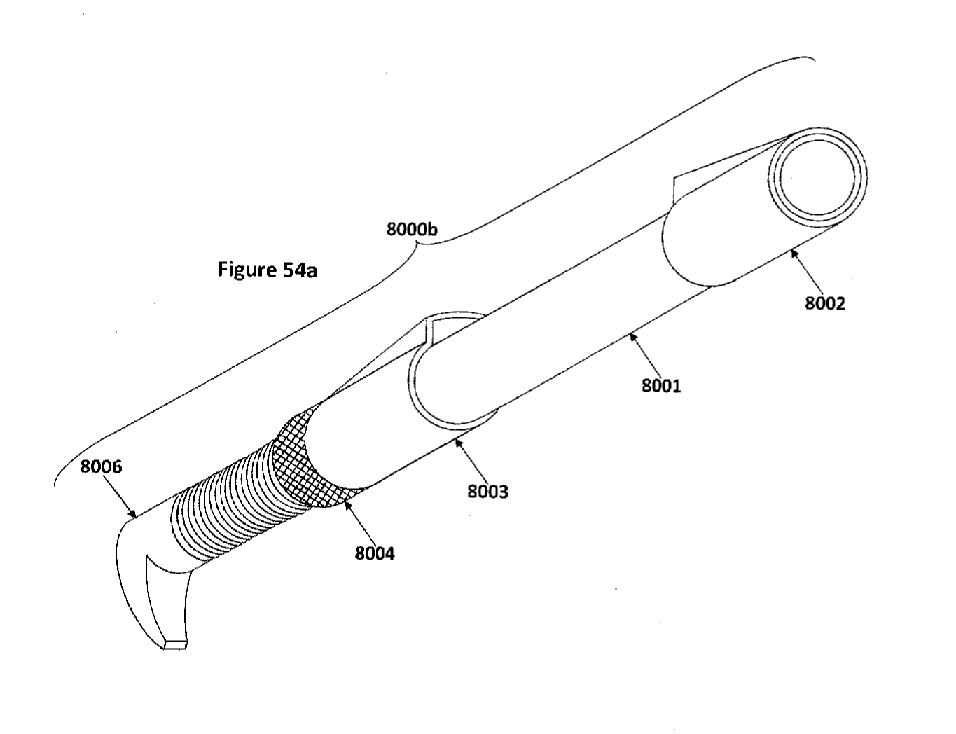

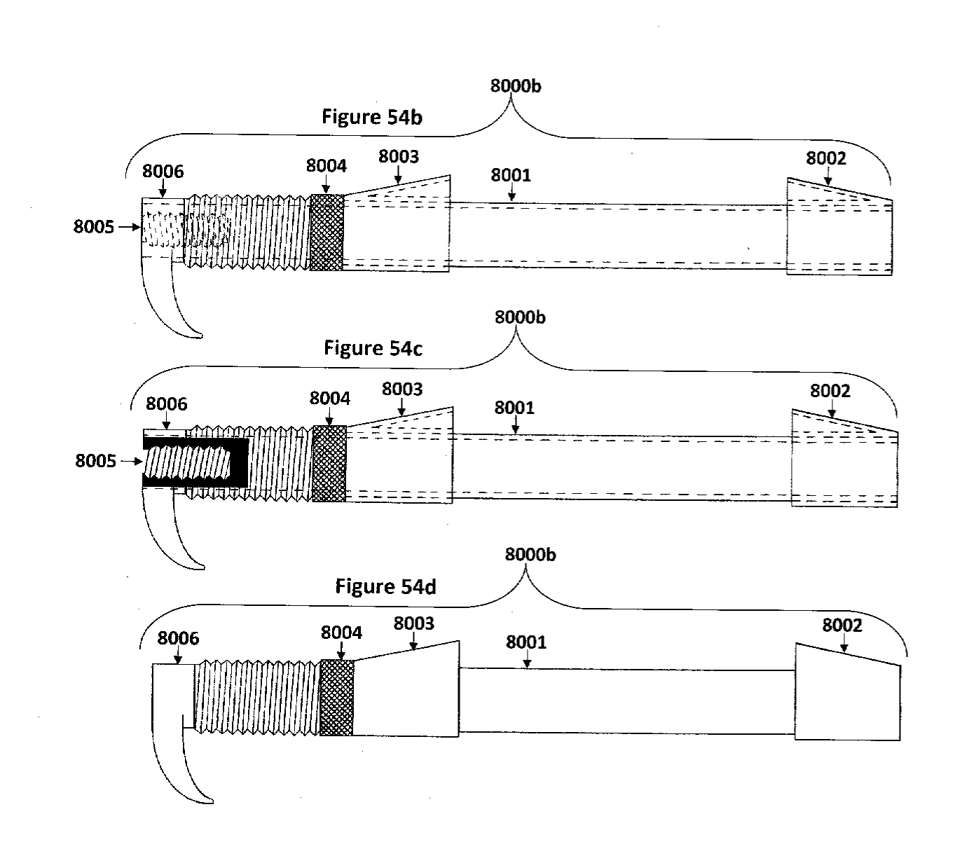

Unlike prior art reel seats, exemplary fishing rod reel seats 8000a and 8000b comprise a threaded receiving end 8005, as shown in FIGS. 53c-53d, 54b and 54c, which engages with one or more removable fishing rod handles 5000a, 6000a or 7000a. Removable fishing rod handles 5000a, 6000a, and 7000a may each independently be substantially round and elongated, or any other suitable shape. Removable fishing rod handles 5000a, 6000a, and 7000a, may, if desired, be cut, formed, or molded together into one solid, seamless, and uniform piece. The length and width of removable fishing rod handles 5000a, 6000a, and 7000a may be of any desired dimension to accommodate fishing rod reel seats 8000a or 8000b. Removable fishing rod handles 5000a, 6000a, and 7000a can come in various styles and shapes so as to include, but are not limited to, a hollow grip, a standard grip, a split-grip, etc.

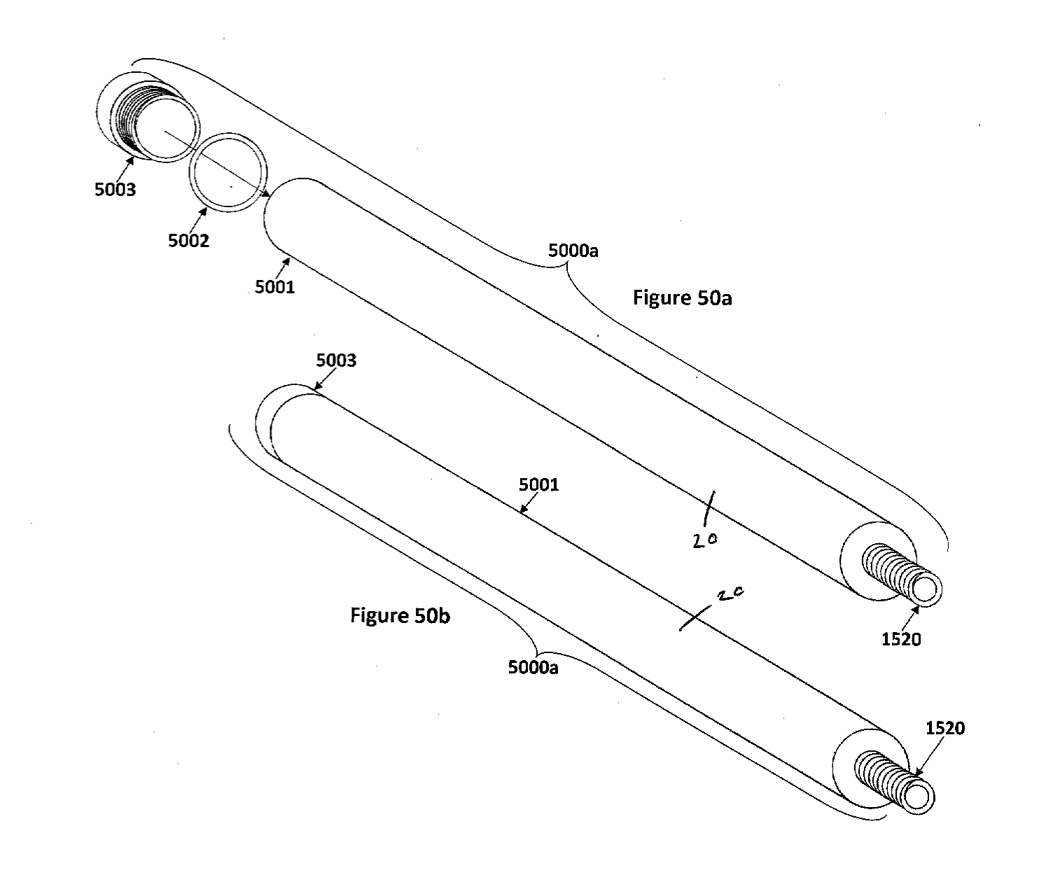

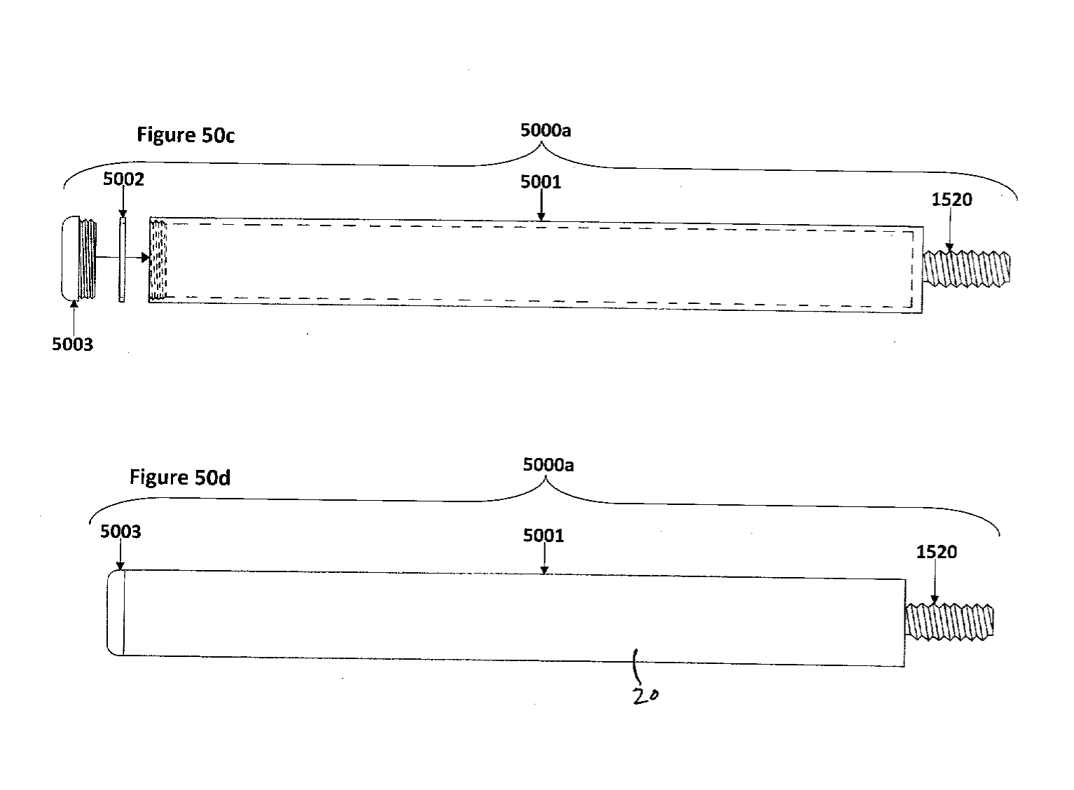

Hollow IFRH 5000a shown in FIGS. 47a-47e, 49, 50a-50d and 56 typically comprises four distinct parts: (1) threaded connector rod 1520, (2) handle body 5001, (3) O-ring 5002, and (4) end cap (Type 1) 5003, all of which are shown in FIG. 50a. Hollow IFRH 5000a may be substantially round and elongated, or any other suitable shape. Hollow IFRH 5000a may, if desired, be cut, formed, or molded together into one solid, seamless, and uniform piece. The length and width of hollow IFRH 5000a may be of any desired dimension to accommodate ITRS 8000a or 8000b.

Threaded connector rod 1520 may be substantially round and elongated, or any other suitable shape. Threaded connector rod 1520 may, if desired, be cut, formed, or molded together into one solid, seamless, and uniform piece. The length and width of threaded connector rod 1520 may be of any desired dimension to accommodate ITRS 8000a or 8000b. Threaded connector rod 1520 is the connection point at which hollow IFRH 5000a connects to ITRS 8000a or 8000b.

Handle body 5001 comprises the main part of hollow IFRH 5000a. Handle body 5001 may be substantially round and elongated, or any other suitable shape. Handle body 5001 may, if desired, be cut, formed, or molded together into one solid, seamless, and uniform piece. The length and width of handle body 5001 may be of any desired dimension to accommodate threaded connector rod 1520. Handle body 5001 starts at threaded connector rod 1520 and extends to end cap (Type 1) 5003. O-ring 5002 forms a water-tight seal between handle body 5001 and end cap (Type 1) 5003 thereby making the entire hollow IFRH 5000a waterproof.

O-ring 5002 may be substantially round and elongated, or any other suitable shape. O-ring 5002 may, if desired, be cut, formed, or molded together into one solid, seamless, and uniform piece. The length and width of O-ring 5002 may be of any desired dimension to accommodate handle body 5001. O-ring 5002 is placed between handle body 5001 and end cap (Type 1) 5003. 0-ring 5002 is compressed between handle body 5001 and end cap (Type 1) 5003 once end cap (Type 1) 5003 has been threaded onto handle body 5001.

The IFRHs of the present invention may comprise one of two types of end cap: (i) the type 1 used primarily on hollow IFRH 5000a and (ii) the type 2 used primarily on the standard and split-grip handles. End cap (Type 1) 5003 forms the end or aft of hollow IFRH 5000a. End cap (Type 1) 5003 may be substantially round and elongated, or any other suitable shape. End cap (Type 1) 5003 may, if desired, be cut, formed, or molded together into one solid, seamless, and uniform piece. The length and width of end cap (Type 1) 5003 may be of any desired dimension to accommodate handle body 5001. End cap (Type 1) 5003 is threaded on the forward end so as to be engagable with handle body 5001 to complete hollow IFRH 5000a.

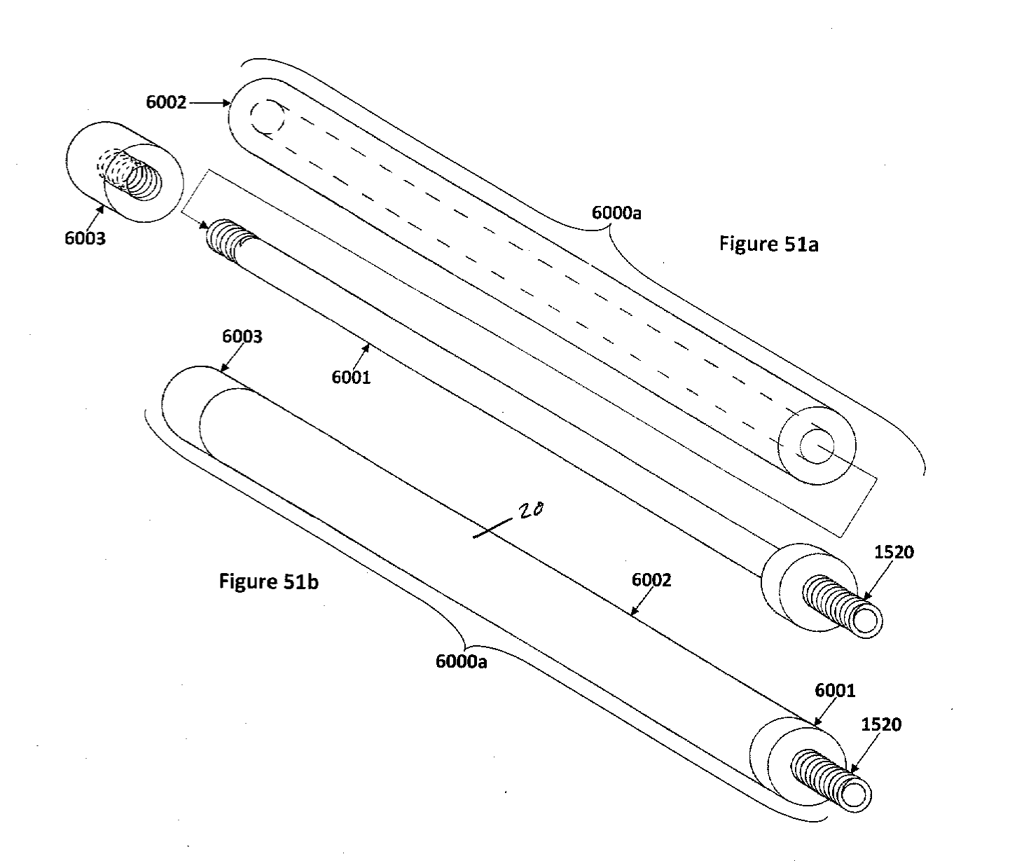

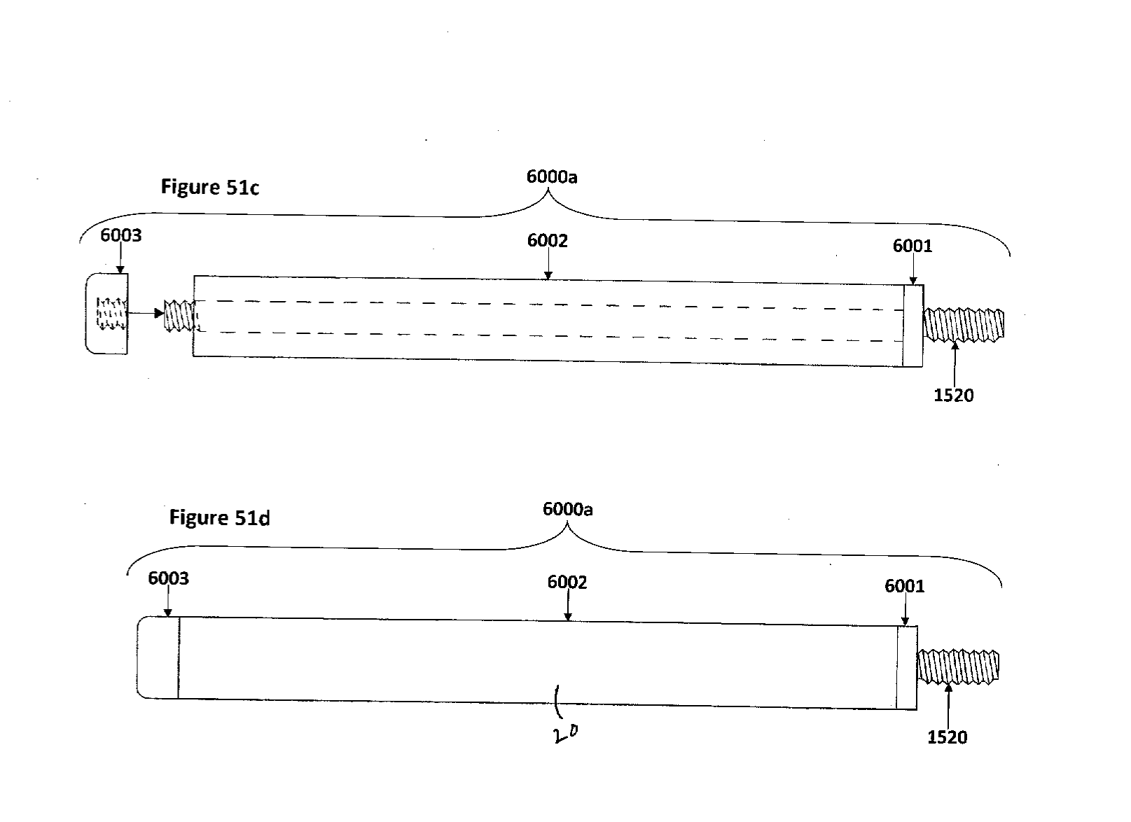

Standard IFRH 6000a, shown in FIGS. 51a-51d and 56, typically comprises four distinct parts: (1) threaded connector rod 1520, (2) handle spine 6001, (3) handle wrap 6002, and (4) end cap (Type 2) 6003, all of which are shown in FIG. 51a. Standard IFRH 6000a may be substantially round and elongated, or any other suitable shape. Standard IFRH 6000a may, if desired, be cut, formed, or molded together into one solid, seamless, and uniform piece. The length and width of standard IFRH 6000a may be of any desired dimension to accommodate ITRS 8000a or 8000b.

Handle spine 6001 comprises the inner part or spine of standard IFRH 6000a. Handle spine 6001 may be substantially round and elongated, or any other suitable shape. Handle spine 6001 may, if desired, be cut, formed, or molded together into one solid, seamless, and uniform piece. The length and width of handle spine 6001 may be of any desired dimension to accommodate handle wrap 6002. Handle spine 6001 starts at threaded connector rod 1520 and extends to end cap (Type 2) 6003.

Handle wrap 6002 forms the outer part of standard IFRH 6000a. Handle wrap 6002 may be substantially round and elongated, or any other suitable shape. Handle wrap 6002 may, if desired, be cut, formed, or molded together into one solid, seamless, and uniform piece. The length and width of handle wrap 6002 may be of any desired dimension to accommodate handle spine 6001. Handle wrap 6002 has a hole that runs its entire length from fore to aft. The hole is usually the same diameter as that of handle spine 6001 allowing handle wrap 6002 to be slid onto handle spine 6001. Handle wrap 6002 slides onto the aft end of handle spine 6001 and continues until it stops at the forward end. At least a portion of handle spine 6001 becomes concealed beneath handle wrap 6002.

Typically, once handle wrap 6002 is slid onto handle spine 6001, the only part of handle spine 6001 that is left exposed is the forward and aft end. Handle wrap 6002 can be, but is not limited to, permanently attached to handle spine 6001 by the use of glue or other compounds.

End cap (Type 2) 6003 forms the end or aft of standard IFRH 6000a. End cap (Type 2) 6003 may be substantially round and elongated, or any other suitable shape. End cap (Type 2) 6003 may, if desired, be cut, formed, or molded together into one solid, seamless, and uniform piece. The length and width of end cap (Type 2) 6003 may be of any desired dimension to accommodate handle wrap 6002. End cap (Type 2) 6003 is usually rounded on the aft end and threaded on the forward end. The threaded forward end of end cap (Type 2) 6003 threads onto the aft end of handle spine 6001 and stops once it comes into contact with handle wrap 6002 forming standard IFRH 6000a.

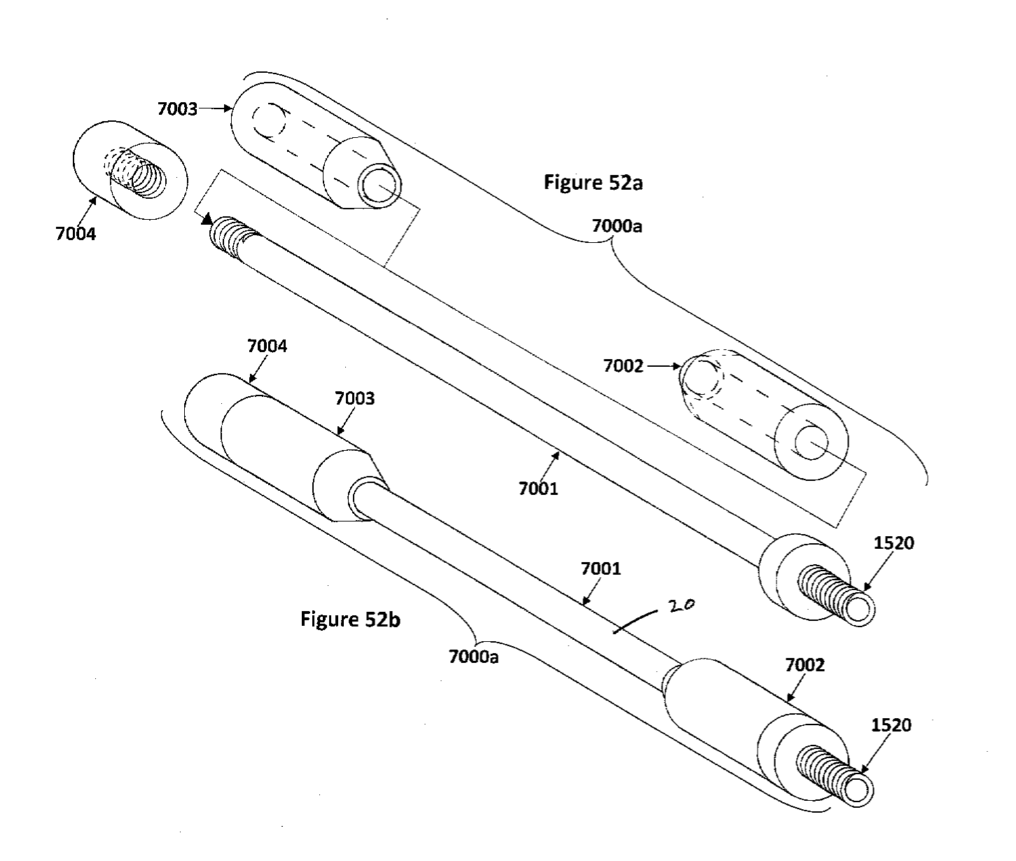

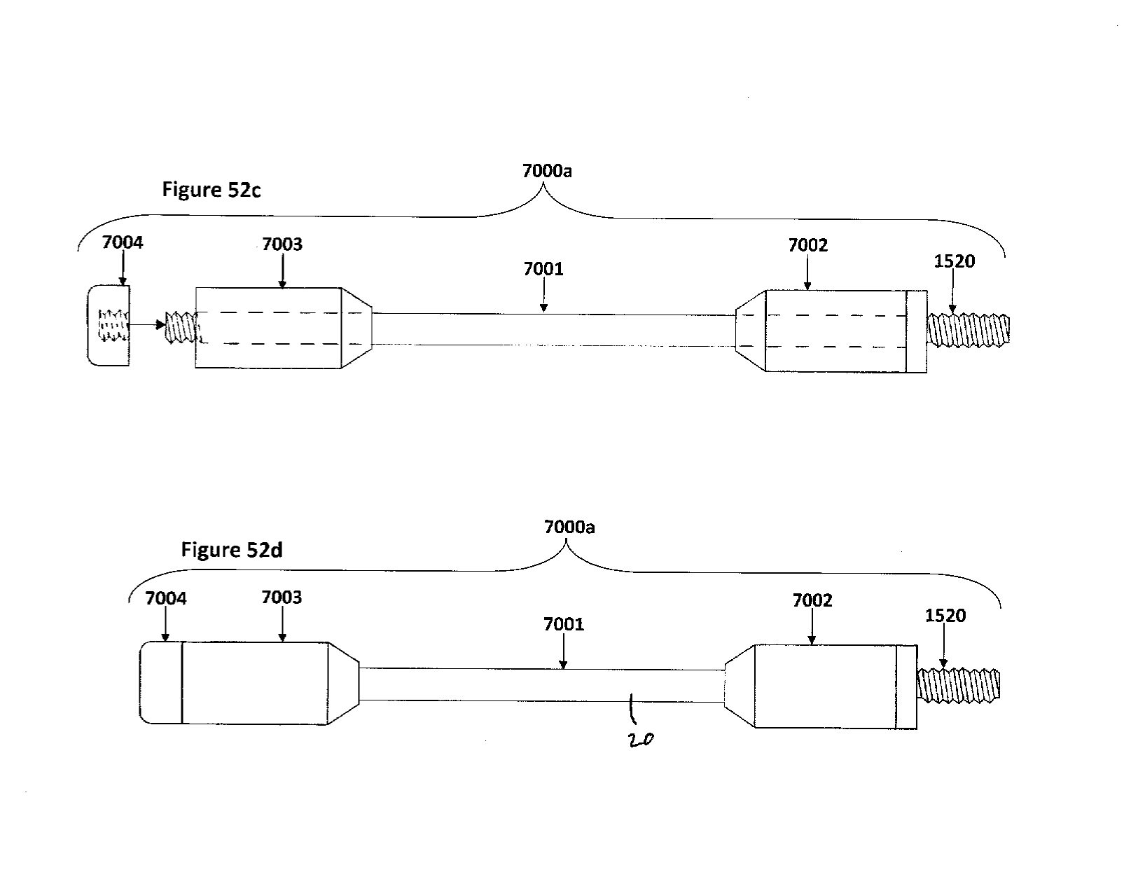

Split-grip IFRH 7000a, shown in FIGS. 52a-52d and 56, typically comprises five distinct parts: (1) threaded connector rod 1520, (2) handle spine 7001, (3) forward handle wrap 7002, (4) aft handle wrap 7003, and (5) end cap (Type 3) 7004, all of which are shown in FIG. 52a. Split-grip IFRH 7000a may be substantially round and elongated, or any other suitable shape. Split-grip IFRH 7000a may, if desired, be cut, formed, or molded together into one solid, seamless, and uniform piece. The length and width of split-grip IFRH 7000a may be of any desired dimension to accommodate ITRS 8000a or 8000b.

Handle spine 7001 comprises the inner part or spine of split-grip IFRH 7000a. Handle spine 7001 may if desired be substantially round and elongated, or any other suitable shape. Handle spine 7001 may, if desired, be cut, formed, or molded together into one solid, seamless, and uniform piece. The length and width of handle spine 7001 may be of any desired dimension to accommodate forward handle wrap 7002 and aft handle wrap 7003. Handle spine 7001 starts at threaded connector rod 1520 and extends to end cap (Type 3) 7004.

Forward handle wrap 7002 forms an outer part of split-grip IFRH 7000a. Forward handle wrap 7002 may be substantially round and elongated, or any other suitable shape. Forward handle wrap 7002 may, if desired, be cut, formed, or molded together into one solid, seamless, and uniform piece. The length and width of forward handle wrap 7002 may be of any desired dimension to accommodate handle spine 6001. Forward handle wrap 7002 has a hole that runs its entire length from fore to aft. The hole is usually the same diameter as that of handle spine 7001, allowing forward handle wrap 7002 to be slid onto handle spine 7001. Forward handle wrap 7002 slides onto the aft end of handle spine 7001 and continues until it stops at the forward end. Forward handle wrap 7002 can be, but is not limited to, permanently attached to handle spine 7001 by the use of glue or other compounds.

Aft handle wrap 7003 also forms an outer part of split-grip IFRH 7000a. Aft handle wrap 7003 may be substantially round and elongated, or any other suitable shape. Aft handle wrap 7003 may, if desired, be cut, formed, or molded together into one solid, seamless, and uniform piece. The length and width of aft handle wrap 7003 may be of any desired dimension to accommodate handle spine 7001. Aft handle wrap 7003 has a hole that runs its entire length from fore to aft. The hole is usually the same diameter as that of handle spine 7001, allowing aft handle wrap 7003 to be slid onto handle spine 7001. Aft handle wrap 7003 slides onto the aft end of handle spine 7001 and continues until it stops at a predetermined point allowing a gap between itself and forward handle wrap 7002. The distance or gap between forward handle wrap 7002 and aft handle wrap 7003 can be of any desired length. Aft handle wrap 7003 can be, but is not limited to, permanently attached to handle spine 7001 by the use of glue or other compounds.

End cap (Type 3) 7004 forms the end or aft of split-grip IFRH 7000a. End cap (Type 3) 7004 may be substantially round and elongated, or any other suitable shape. End cap (Type 3) 7004 may, if desired, be cut, formed, or molded together into one solid, seamless, and uniform piece. The length and width of end cap (Type 3) 7004 may be of any desired dimension to accommodate aft handle wrap 7003. End cap (Type 3) 7004 is typically rounded on the aft end and threaded on the forward end. The threaded forward end of end cap (Type 3) 7004 threads onto the aft end of handle spine 7001 and stops once it comes into contact with aft handle wrap 7003.

ITRSs 8000a and 8000b may each independently be substantially round and elongated, or any other suitable shape. ITRSs 8000a and 8000b may, if desired, be cut, formed, or molded together into one solid, seamless, and uniform piece. The length and width of ITRSs 8000a and 8000b may be of any desired dimension to accommodate any removable fishing rod handle 20, such as IFRHs 5000a, 6000a and 7000a.

Standard ITRS 8000a, shown in FIGS. 47a-47e, 49, 53a-53e, and 56, typically comprises five distinct parts: (1) forward clamp 8002, (2) reel seat chassis member (also referred to herein as “reel seat member”) 8001, (3) aft clamp 8003, (4) aft clamp compression ring 8004, and (5) threaded handle receiver (also referred to herein as “second cavity” in some embodiments) 8005, all of which are shown in FIG. 53d. As used herein, the term “reel connecting member,” such as reel connecting member 83, represents one of more components used to connect a reel to a fishing rod reel seat of the present invention. For example, in standard ITRS 8000a, reel connecting member 83 comprises (1) forward clamp 8002, (2) aft clamp 8003, and (3) aft clamp compression ring 8004. However, it should be noted that any reel connecting member 83, comprising one or more components, may be sued in the present invention as long as reel connecting member 83 is capable of connecting a fishing reel (e.g., fishing reel 4510 shown in FIG. 24b) to a fishing rod reel seat of the present invention.

Forward clamp 8002 is positioned at the forward end of standard ITRS 8000a, and has an opening that accepts and holds down the forward end of a fishing reel 4510 (see, FIG. 56). Forward clamp 8002 is static, remains stationary and does not move in a lateral or longitudinal direction. Forward clamp 8002 may be substantially round and elongated, or any other suitable shape. Forward clamp 8002 may, if desired, be cut, formed, or molded together into one solid, seamless, and uniform piece. The length and width of forward clamp 8002 may be of any desired dimension to accommodate a fishing reel.

Reel seat chassis member 8001 comprises the main part or body of standard ITRS 8000a onto which both the forward and aft clamps attach. Reel seat chassis member 8001 may be substantially round and elongated, or any other suitable shape. Reel seat chassis member 8001 may, if desired, be cut, formed, or molded together into one solid, seamless, and uniform piece. The length and width of reel seat chassis member 8001 may be of any desired dimension to accommodate forward clamp 8002, aft clamp 8003 and a fishing reel.

Aft clamp 8003 is positioned at the aft end of standard ITRS 8000a and has an opening that accepts and holds down the aft end of fishing reel 4510 (see, FIG. 56). Aft clamp 8003 is dynamic, rotates in a clockwise direction to ride along external threads of reel seat chassis member 8001, and moves in a forward (or backward) direction along the longitudinal axis of reel seat chassis member 8001. Fishing reel 4510 may be placed between forward clamp 8002 and aft clamp 8003, and aft clamp 8003 subsequently moved in a forward direction so as to compress fishing reel 4510, locking fishing reel 4510 between aft clamp 8003 and forward clamp 8002.

Aft clamp 8003 may be substantially round and elongated, or any other suitable shape. Aft clamp 8003 may, if desired, be cut, formed, or molded together into one solid, seamless, and uniform piece. The length and width of aft clamp 8003 may be of any desired dimension to accommodate a fishing reel (e.g., fishing reel 4510).

Threaded handle receiver 8005 forms the aft end of reel seat chassis member 8001. Threaded handle receiver 8005 provides the point at which one or more IFRHs 5000a, 6000a, and 7000a connect to ITRS 8000a or 8000b. Threaded handle receiver 8005 comprises internal threads 87 (see, FIG. 24b) that run along an interior surface (e.g., second cavity 88) at the aft end of reel seat chassis member 8001. Threaded handle receiver 8005 accepts any dimension and all various sizes of standard and or metric threads of IFRHs 5000a, 6000a, and 7000a.

Threaded handle receiver 8005 may be substantially round and elongated, or any other suitable shape. Threaded handle receiver 8005 may, if desired, be cut, formed, or molded together into one solid, seamless, and uniform piece. The length and width of threaded handle receiver 8005 may be of any desired dimension to accommodate one or more of IFRHs 5000a, 6000a, and 7000a.

While standard ITRS 8000a is used primarily on, but not limited to, open-face fishing reels, trigger-style ITRS 8000b, shown in FIGS. 54a-54d, is used primarily on, but not limited to, closed-face and bait casting fishing reels. Trigger-style ITRS 8000b typically comprises six distinct parts: (1) forward clamp 8002, (2) reel seat chassis member 8001, (3) aft clamp 8003, (4) aft clamp compression ring 8004, (5) finger rest member 8006, and (6) threaded handle receiver 8005, all of which are shown in FIG. 54c. Forward clamp 8002, reel seat chassis member 8001, aft clamp 8003, aft clamp compression ring 8004, and threaded handle receiver 8005 on trigger-style ITRS 8000b serve the same functions as discussed above in relation to standard ITRS 8000a.

Finger rest member 8006 is usually located near the aft of reel seat chassis member 8001, forms an appendage that protrudes down from reel seat chassis member 8001, and generally forms the shape of a trigger-like projection. Finger rest member 8006 may be substantially round and elongated, or any other suitable shape. Finger rest member 8006 may, if desired, be cut, formed, or molded together into one solid, seamless, and uniform piece. The length and width of finger rest member 8006 may be of any desired dimension to accommodate reel seat chassis member 8001. The main purpose of finger rest member 8006 is to provide a user a point at which to securely hold onto trigger-style ITRS 8000b while performing the act of casting.

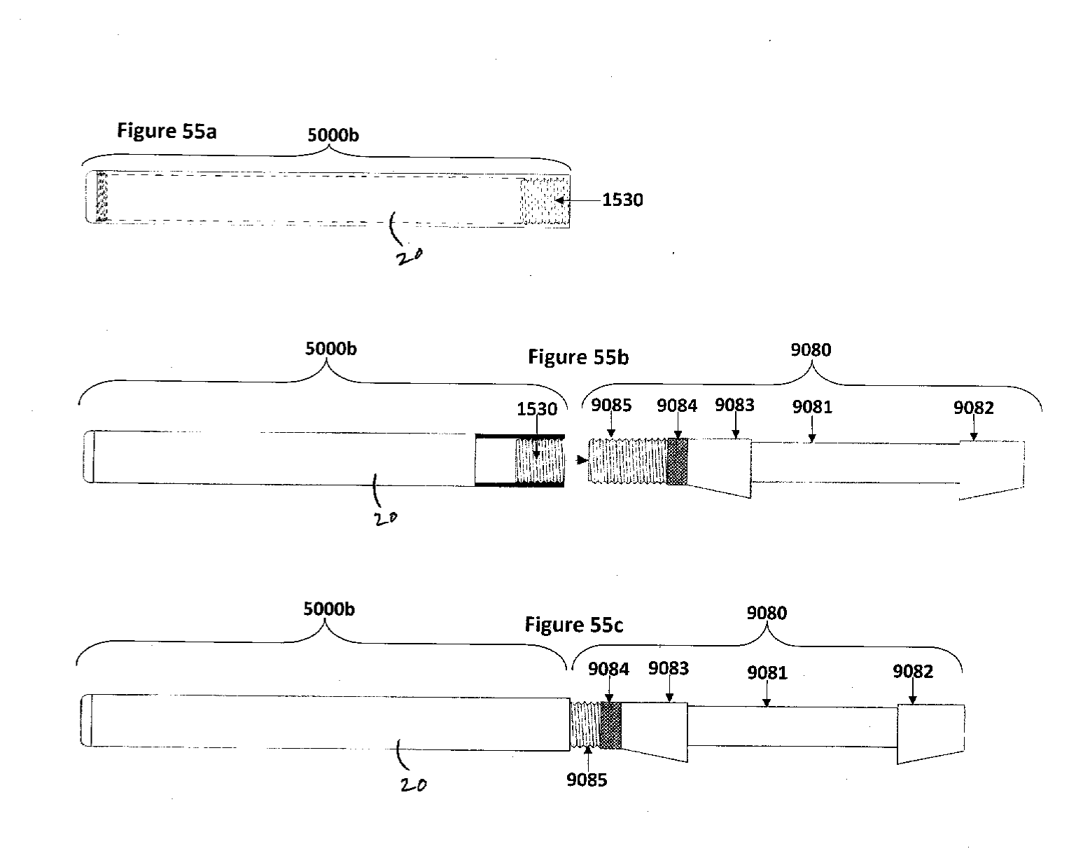

In other embodiments, the ITRS of the present invention has external threads for engaging with IFRHs having corresponding internal threads. IFRHs 5000b, 6000b and 7000b shown in FIG. 56 are examples of these types of IFRHs. Universal IFRH 5000b is similar in design and function to IFRH 5000a, but does not have threaded connector rod 1520. Instead, universal IFRH 5000b has internal threads 1530 that line an inside wall (or cavity) at a forward section of universal IFRH 5000b. Internal threads 1530 allow universal IFRH 5000b to be connected to external threads along a fishing rod reel seat such as reel seat 9080 shown in FIG. 55b. Internal threads 1530 connect to reel seat 9080 via the aft clamp compression ring external threads 9085 shown in FIG. 55b. Aft clamp compression ring external threads 9085 are typically standard on reel seats 9080.

FIG. 55c shows universal IFRH 5000b and reel seat 9080 joined to one another. Whereas universal IFRH 5000b is similar in design and function as IFRH 5000a, the same is also true for universal IFRHs 6000b and 7000b in relation to IFRHs 6000a and 7000a.

The present invention is also directed to methods of making and using any of the disclosed fishing rod components including, but not limited to, removable fishing rod handles, fishing rod reel seats suitable for use with removable fishing rod handles, and fishing rod anchoring devices (e.g., Type 1, Type 2, etc.), as well as kits containing any of the disclosed fishing rod components, and fishing rods comprising one or more of the disclosed fishing rod components.

Any of the above-described components may be manufactured from any type of suitable material. Suitable materials may, if desired, be of a homogeneous composition, a multi-component composition of varying degrees, or a laminated material. Suitable materials may, if desired, be rigid or have varying degrees of rigidity disposed along its longitudinal length. Suitable materials may include, but are not limited to, any plastic, metal (e.g., aluminum, stainless steel, etc.), wood, bamboo, graphite, fiberglass, ceramic, or any combination of one or more of these materials. In some desired embodiments, many of the above-described fishing rod components of the present invention (e.g., FRA components, fishing rod reel seat components, and removable fishing rod handle components) are formed from a metal, such as aluminum or stainless steel, except for some removable fishing rod handle components (e.g., o-ring 5002 (e.g., rubber) and handle wrap 6002 (e.g., polymeric foam material).

Further, any of the above-described components may be formed using conventional techniques. For example, many, if not all, of the above-described components may be thermoformed (e.g., molded) from the above-mentioned materials, and subsequently joined to one another so as to result in any one of the above-described fishing components of the present invention.

### Other Embodiments

Fishing Rod Anchoring Devices and Methods of Making and Using the Same:
1. A fishing rod anchoring device comprising: an anchor chassis member; an adjustable clamping assembly attached to said anchor chassis member, said adjustable clamping assembly being operatively adapted and sized to clamp onto an object; and a fishing rod attaching component operatively adapted and sized so as to attach said fishing rod anchoring device to a fishing rod.
2. The fishing rod anchoring device of embodiment 1, wherein said adjustable clamping assembly comprises (i) a static clamping member that is movable from a first resting position to a second engaging position, and (ii) an adjustable clamping member that is movable from a first resting position to a second engaging position, and is movable along a length of said anchor chassis member.
3. The fishing rod anchoring device of embodiment 2, wherein said adjustable clamping assembly further comprises a clamping screw member attached to and extending along a length of said anchor chassis member, said adjustable clamping member being movable along a length of said anchor chassis member via said clamping screw member.
4. The fishing rod anchoring device of embodiment 3, wherein said adjustable clamping assembly further comprises a clamping rotation member attached to said anchor chassis member, said clamping rotation member being operatively adapted to rotate said clamping screw member so as to move said adjustable clamping member along a length of said anchor chassis member via said clamping screw member.
5. The fishing rod anchoring device of embodiment 4, wherein said clamping rotation member moves from (i) a first storage position at least partially embedded within a first end of said clamping screw member to (ii) a second use position in which said clamping rotation member extends from said first end of said clamping screw member and is rotatable along an axis extending through said clamping screw member.
6. The fishing rod anchoring device of any one of embodiments 1 to 5, wherein said fishing rod attaching component comprises a quick release component that attaches to a corresponding quick release component on a fishing rod.
7. The fishing rod anchoring device of any one of embodiments 1 to 5, wherein said fishing rod attaching component comprises a fishing rod coupling device, said fishing rod coupling device being operatively adapted to connect to a fishing rod and form a handle or handle extension of a fishing rod.
8. The fishing rod anchoring device of embodiment 7, wherein said fishing rod coupling device comprises coupling threads operatively adapted to connect to corresponding threads on a fishing rod.
9. The fishing rod anchoring device of any one of embodiments 1 to 8, wherein said fishing rod anchoring device further comprises: a fishing rod attaching component locking mechanism operatively adapted and sized to (i) lock said fishing rod attaching component into a locked position relative to said anchor chassis member, and (ii) unlock said fishing rod attaching component from said locked position.
10. The fishing rod anchoring device of any one of embodiments 1 to 9, wherein said fishing rod anchoring device further comprises a spike member attached to said anchor chassis member, said spike member being operatively adapted and sized to extend into the ground.
11. The fishing rod anchoring device of any one of embodiments 1 to 10, wherein said fishing rod anchoring device further comprises: a spike member attached to said anchor chassis member, said spike member being operatively adapted and sized to extend into the ground; and a recessed housing component along an outer surface of said anchor chassis member, said spike member being movable from a first position within said recessed housing component into a second position when in use, and said recessed housing component having dimensions that enable at least a portion of said spike member to be positioned within said recessed housing component when in said first position.
12. The fishing rod anchoring device of embodiment 10 or 11, wherein said spike member has a substantially flat surface extending across a width of said spike member.
13. The fishing rod anchoring device of embodiment 10 or 11, wherein said spike member has a curved surface extending across a width of said spike member.
14. The fishing rod anchoring device of any one of embodiments 10 to 13, wherein said spike member comprises at least one pointed end member along a distal end of said spike member.
15. The fishing rod anchoring device of any one of embodiments 10 to 14, wherein said fishing rod anchoring device further comprises: a spike member locking mechanism operatively adapted and sized to (i) lock said spike member into a locked position relative to said anchor chassis member, and (ii) unlock said spike member from said locked position.
16. A fishing rod anchoring device comprising: an anchor chassis member; an adjustable clamping assembly attached to said anchor chassis member, said adjustable clamping assembly being operatively adapted and sized to clamp onto an object; a fishing rod attaching component operatively adapted and sized so as to attach said fishing rod anchoring device to a fishing rod; a fishing rod attaching component locking mechanism operatively adapted and sized to (i) lock said fishing rod attaching component into a locked position relative to said anchor chassis member, and (ii) unlock said fishing rod attaching component from said locked position; a spike member attached to said anchor chassis member, said spike member being operatively adapted and sized to extend into the ground; and move from (i) a housed position within the anchor chassis member to (ii) a use position outside of the anchor chassis member.
17. A fishing rod anchoring device comprising: an anchor chassis member; an adjustable clamping assembly attached to said anchor chassis member, said adjustable clamping assembly being operatively adapted and sized to clamp onto an object, and said adjustable clamping assembly comprising (i) a static clamping member that is movable from a first resting position to a second engaging position, (ii) an adjustable clamping member that is movable from a first resting position to a second engaging position, and is movable along a length of said anchor chassis member, (iii) a clamping screw member attached to and extending along a length of said anchor chassis member, said adjustable clamping member being movable along a length of said anchor chassis member via said clamping screw member, and (iv) a clamping rotation member attached to said anchor chassis member, said clamping rotation member being operatively adapted to rotate said clamping screw member so as to move said adjustable clamping member along a length of said anchor chassis member via said clamping screw member; a fishing rod attaching component operatively adapted and sized so as to attach said fishing rod anchoring device to a fishing rod; a fishing rod attaching component locking mechanism operatively adapted and sized to (i) lock said fishing rod attaching component into a locked position relative to said anchor chassis member, and (ii) unlock said fishing rod attaching component from said locked position; a spike member attached to said anchor chassis member, said spike member (a) being operatively adapted and sized to extend into the ground, and (b) movable from (i) a housed position within the anchor chassis member to (ii) a use position outside of the anchor chassis member.
18. The fishing rod anchoring device of any one of embodiments 1 to 17 in combination with a rod component that attaches to (i) said fishing rod attaching component of said fishing rod anchoring device and (ii) a fishing rod.
19. The rod component recited in embodiment 18.
20. The fishing rod anchoring device of any one of embodiments 1 to 17 in combination with a fishing rod, said fishing rod comprising a rod component that attaches to said fishing rod attaching component of said fishing rod anchoring device.
21. The fishing rod recited in embodiment 20.
22. The fishing rod of embodiment 21, wherein said rod component comprises a corresponding quick release component that attaches to a quick release component of a fishing rod anchoring device as described herein.
23. The fishing rod of embodiment 21, wherein said rod component comprises a rod handle component or a rod handle extension of the fishing rod that attaches to a fishing rod coupling device of a fishing rod anchoring device as described herein.
24. The fishing rod of claim embodiment, wherein said fishing rod comprises rod threads that correspond to coupling threads of a fishing rod anchoring device as described herein.
25. The fishing rod anchoring device of embodiment 24, wherein said rod threads are embedded within a rod handle of said fishing rod.
26. A method of using the fishing rod anchoring device, the rod component, or the fishing rod of any one of embodiments 1 to 25, said method comprising at least one step selected from: attaching the rod component to a fishing rod; attaching the fishing rod anchoring device to the object; inserting the spike member of the fishing rod anchoring device into the ground; and attaching the fishing rod to the fishing rod anchoring device.
27. The method of embodiment 26, wherein the object comprises a dock, a railing, a boat, or a tree.
28. A method of making the fishing rod anchoring device, the rod component, or the fishing rod of any one of embodiments 1 to 25, said method comprising at least one step selected from: thermoforming at least one component; and connecting two or more components to one another.

Fishing Rod Reel Seats and Methods of Making and Using the Same:
1. A fishing rod reel seat comprising: a reel seat member having a first end, a second end opposite said first end, and a reel connecting member positioned along said reel seat member between said first end and said second end; a first cavity extending a first depth into said reel seat member from said first end, said first cavity being sized to house a connecting end of a fishing rod therein; and a fishing rod handle connecting member comprising (i) internal threads extending along a second cavity that extends a second depth into said reel seat member from said second end, (ii) external threads extending along an outer surface of said reel seat member proximate said second end, or (iii) both (i) and (ii), said fishing rod handle connecting member being sized and configured to be attachable to one or more removable fishing rod handles.
2. The fishing rod reel seat of embodiment 1, wherein said fishing rod handle connecting member comprises internal threads extending along a second cavity that extends a second depth into said reel seat member from said second end, said internal threads being sized and configured to attach to corresponding external threads of one or more removable fishing rod handles.
3. The fishing rod reel seat of embodiment 2, further comprising a removable fishing rod handle, said removable fishing rod handle comprising external threads that engage with said internal threads of said reel seat member.
4. The fishing rod reel seat of embodiment 1, wherein said fishing rod handle connecting member comprises external threads extending along an outer surface of said reel seat member proximate said second end, said external threads being sized and configured to attach to corresponding internal threads of one or more removable fishing rod handles.
5. The fishing rod reel seat of embodiment 4, further comprising a removable fishing rod handle, said removable fishing rod handle comprising internal threads that engage with said external threads of said reel seat member.
6. The fishing rod reel seat of any one of embodiments 1 to 5, wherein said fishing rod handle connecting member comprises (i) internal threads extending along a second cavity that extends a second depth into said reel seat member from said second end, said internal threads being sized and configured to attach to corresponding external threads of one or more removable fishing rod handles, and (ii) external threads extending along an outer surface of said reel seat member proximate said second end, said external threads being sized and configured to attach to corresponding internal threads of one or more removable fishing rod handles.
7. The fishing rod reel seat of any one of embodiments 1 to 6, further comprising a removable fishing rod handle, said removable fishing rod handle comprising a fishing rod anchoring device comprising (i) an anchor chassis member; (ii) an adjustable clamping assembly attached to said anchor chassis member, said adjustable clamping assembly being operatively adapted and sized to clamp onto an object; and (iii) a fishing rod attaching component operatively adapted and sized so as to releasably attach said fishing rod anchoring device to said fishing rod reel seat.
8. The fishing rod reel seat of any one of embodiments 1 to 6, further comprising a removable fishing rod handle, said removable fishing rod handle comprising a fishing rod anchoring device comprising (i) an anchor chassis member; (ii) a spike member attached to said anchor chassis member, said spike member being operatively adapted and sized to extend into soil; and (iii) a fishing rod attaching component operatively adapted and sized so as to releasably attach said fishing rod anchoring device to said fishing rod reel seat.
9. The fishing rod reel seat of any one of embodiments 1 to 6, further comprising a removable fishing rod handle, said removable fishing rod handle comprising a fishing rod anchoring device comprising (i) an anchor chassis member; (ii) an adjustable clamping assembly attached to said anchor chassis member, said adjustable clamping assembly being operatively adapted and sized to clamp onto an object; (iii) a spike member attached to said anchor chassis member, said spike member (a) being operatively adapted and sized to extend into soil, and (b) movable from a housed position within the anchor chassis member to a use position outside of the anchor chassis member; and (iv) a fishing rod attaching component operatively adapted and sized so as to releasably attach said fishing rod anchoring device to said fishing rod reel seat.
10. The fishing rod reel seat of any one of embodiments 1 to 9, further comprising a fishing rod with a connecting end of the fishing rod positioned within said first cavity and a tip end opposite said connecting end.
11. The fishing rod reel seat of any one of embodiments 1 to 10, further comprising a reel positioned along and connected to said reel seat member via said reel connecting member.

Fishing Rod Kits and Methods of Making and Using the Same:
12. A fishing rod kit comprising: (I) at least one fishing rod reel seat, each of said at least one fishing rod reel seat comprising a reel seat member having a first end, a second end opposite said first end, and a reel connecting member positioned along said reel seat member between said first end and said second end; a first cavity extending a first depth into said reel seat member from said first end, said first cavity being sized to house a connecting end of a fishing rod therein; and a fishing rod handle connecting member comprising (i) internal threads extending along a second cavity that extends a second depth into said reel seat member from said second end, (ii) external threads extending along an outer surface of said reel seat member proximate said second end, or (iii) both (i) and (ii), said fishing rod handle connecting member being sized and configured to be attachable to one or more removable fishing rod handles; and (II) at least one removable fishing rod handle, each of said at least one removable fishing rod handle comprising a set of internal or external threads that are engagable with said internal threads or said external threads of said at least one fishing rod reel seat.
13. The fishing rod kit of embodiment 12, further comprising one or more of: (i) a fishing rod with a connecting end of the fishing rod being positionable or positioned within said first cavity and a tip end opposite said connecting end; (ii) a reel positionable and connectable to or positioned along and connected to said reel seat member via said reel connecting member.
14. The fishing rod kit of embodiment 12 or 13, wherein at least one removable fishing rod handle comprises a fishing rod anchoring device comprising (i) an anchor chassis member; (ii) a fishing rod attaching component operatively adapted and sized so as to releasably attach said fishing rod anchoring device to said fishing rod reel seat, and at least one of (iii) an adjustable clamping assembly attached to said anchor chassis member, said adjustable clamping assembly being operatively adapted and sized to clamp onto an object; and (iv) a spike member attached to said anchor chassis member, said spike member being operatively adapted and sized to extend into soil.

It should be understood that although the above-described fishing rod components (e.g., anchoring devices, removable fishing rod handles, fishing rod reel seats, etc.), fishing rods (i.e., with rod, reel, handle, and optional anchoring device), kits, and methods are described as “comprising” one or more components or steps, the above-described fishing rod components (e.g., anchoring devices, removable fishing rod handles, fishing rod reel seats, etc.), fishing rods (i.e., with rod, reel, handle, and optional anchoring device), kits, and methods may “comprise,” “consists of,” or “consist essentially of” any of the above-described components, features or steps of the fishing rod components (e.g., anchoring devices, removable fishing rod handles, fishing rod reel seats, etc.), fishing rods (i.e., with rod, reel, handle, and optional anchoring device), kits, and methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a fishing rod component (e.g., anchoring devices, removable fishing rod handles, fishing rod reel seats, etc.), a fishing rod (i.e., with rod, reel, handle, and optional anchoring device), a kit, and/or method that “comprises” a list of elements (e.g., components, features or steps) is not necessarily limited to only those elements (or components or steps), but may include other elements (or components or steps) not expressly listed or inherent to the fishing rod component (e.g., anchoring devices, removable fishing rod handles, fishing rod reel seats, etc.), the fishing rod (i.e., with rod, reel, handle, and optional anchoring device), kit, and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a fishing rod component (e.g., anchoring devices, removable fishing rod handles, fishing rod reel seats, etc.), a fishing rod (i.e., with rod, reel, handle, and optional anchoring device), a kit, and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described fishing rod components (e.g., anchoring devices, removable fishing rod handles, fishing rod reel seats, etc.), fishing rods (i.e., with rod, reel, handle, and optional anchoring device), kits, and methods may comprise, consist essentially of, or consist of any of the herein-described components and features, as shown in the figures with or without any feature(s) not shown in the figures. In other words, in some embodiments, the fishing rod components (e.g., anchoring devices, removable fishing rod handles, fishing rod reel seats, etc.), fishing rods (i.e., with rod, reel, handle, and optional anchoring device), kits, and/or methods of the present invention do not have any additional features other than those shown in the figures, and such additional features, not shown in the figures, are specifically excluded from the fishing rod components (e.g., anchoring devices, removable fishing rod handles, fishing rod reel seats, etc.), fishing rods (i.e., with rod, reel, handle, and optional anchoring device), kits, and/or methods. In other embodiments, the fishing rod components (e.g., anchoring devices, removable fishing rod handles, fishing rod reel seats, etc.), fishing rods (i.e., with rod, reel, handle, and optional anchoring device), kits, and/or methods of the present invention do have one or more additional features that are not shown in the figures.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A fishing rod reel seat comprising:
a reel seat member having a first end, a second end opposite said first end, and a reel connecting member positioned along said reel seat member between said first end and said second end;
a first cavity extending a first depth into said reel seat member from said first end, said first cavity being sized to house a connecting end of a fishing rod therein; and
a fishing rod handle connecting member comprising (i) internal threads extending along a second cavity that extends a second depth into said reel seat member from said second end, (ii) external threads extending along an outer surface of said reel seat member proximate said second end, or (iii) both (i) and (ii), said fishing rod handle connecting member being sized and configured to be attachable to one or more removable fishing rod handles.

2. The fishing rod reel seat of claim 1, wherein said fishing rod handle connecting member comprises internal threads extending along a second cavity that extends a second depth into said reel seat member from said second end, said internal threads being sized and configured to attach to corresponding external threads of one or more removable fishing rod handles.

3. The fishing rod reel seat of claim 2, further comprising a removable fishing rod handle, said removable fishing rod handle comprising external threads that engage with said internal threads of said reel seat member.

4. The fishing rod reel seat of claim 1, wherein said fishing rod handle connecting member comprises external threads extending along an outer surface of said reel seat member proximate said second end, said external threads being sized and configured to attach to corresponding internal threads of one or more removable fishing rod handles.

5. The fishing rod reel seat of claim 4, further comprising a removable fishing rod handle, said removable fishing rod handle comprising internal threads that engage with said external threads of said reel seat member.

6. The fishing rod reel seat of claim 1, wherein said fishing rod handle connecting member comprises (i) internal threads extending along a second cavity that extends a second depth into said reel seat member from said second end, said internal threads being sized and configured to attach to corresponding external threads of one or more removable fishing rod handles, and (ii) external threads extending along an outer surface of said reel seat member proximate said second end, said external threads being sized and configured to attach to corresponding internal threads of one or more removable fishing rod handles.

7. The fishing rod reel seat of claim 1, further comprising a removable fishing rod handle, said removable fishing rod handle comprising a fishing rod anchoring device comprising (i) an anchor chassis member; (ii) an adjustable clamping assembly attached to said anchor chassis member, said adjustable clamping assembly being operatively adapted and sized to clamp onto an object; and (iii) a fishing rod attaching component operatively adapted and sized so as to releasably attach said fishing rod anchoring device to said fishing rod reel seat.

8. The fishing rod reel seat of claim 1, further comprising a removable fishing rod handle, said removable fishing rod handle comprising a fishing rod anchoring device comprising (i) an anchor chassis member; (ii) a spike member attached to said anchor chassis member, said spike member being operatively adapted and sized to extend into soil; and (iii) a fishing rod attaching component operatively adapted and sized so as to releasably attach said fishing rod anchoring device to said fishing rod reel seat.

9. The fishing rod reel seat of claim 1, further comprising a removable fishing rod handle, said removable fishing rod handle comprising a fishing rod anchoring device comprising (i) an anchor chassis member; (ii) an adjustable clamping assembly attached to said anchor chassis member, said adjustable clamping assembly being operatively adapted and sized to clamp onto an object; (iii) a spike member attached to said anchor chassis member, said spike member being operatively adapted and sized to extend into soil; and (iv) a fishing rod attaching component operatively adapted and sized so as to releasably attach said fishing rod anchoring device to said fishing rod reel seat.

10. The fishing rod reel seat of claim 1, further comprising a fishing rod with a connecting end of the fishing rod positioned within said first cavity and a tip end opposite said connecting end.

11. The fishing rod reel seat of claim 10, further comprising a reel positioned along and connected to said reel seat member via said reel connecting member.

12. A fishing rod kit comprising:
at least one fishing rod reel seat, each of said at least one fishing rod reel seat comprising:
a reel seat member having a first end, a second end opposite said first end, and a reel connecting member positioned along said reel seat member between said first end and said second end;
a first cavity extending a first depth into said reel seat member from said first end, said first cavity being sized to house a connecting end of a fishing rod therein; and
a fishing rod handle connecting member comprising (i) internal threads extending along a second cavity that extends a second depth into said reel seat member from said second end, (ii) external threads extending along an outer surface of said reel seat member proximate said second end, or (iii) both (i) and (ii), said fishing rod handle connecting member being sized and configured to be attachable to one or more removable fishing rod handles; and
at least one removable fishing rod handle, each of said at least one removable fishing rod handle comprising a set of internal or external threads that are engagable with said internal threads or said external threads of said at least one fishing rod reel seat.

13. The fishing rod kit of claim 12, further comprising one or more of: (i) a fishing rod with a connecting end of the fishing rod being positionable or positioned within said first cavity and a tip end opposite said connecting end; (ii) a reel positionable and connectable to or positioned along and connected to said reel seat member via said reel connecting member.

14. The fishing rod kit of claim 12, wherein at least one removable fishing rod handle comprises a fishing rod anchoring device comprising (i) an anchor chassis member; (ii) a fishing rod attaching component operatively adapted and sized so as to releasably attach said fishing rod anchoring device to said fishing rod reel seat, and at least one of (iii) an adjustable clamping assembly attached to said anchor chassis member, said adjustable clamping assembly being operatively adapted and sized to clamp onto an object; and (iv) a spike member attached to said anchor chassis member, said spike member being operatively adapted and sized to extend into soil.

15. A fishing rod anchoring device comprising:
an anchor chassis member;
a fishing rod attaching component operatively adapted and sized so as to attach said fishing rod anchoring device to a fishing rod;
a fishing rod attaching component locking mechanism operatively adapted and sized to (i) lock said fishing rod attaching component into a locked position relative to said anchor chassis member, and (ii) unlock said fishing rod attaching component from said locked position;
at least one of (1) an adjustable clamping assembly attached to said anchor chassis member, said adjustable clamping assembly being operatively adapted and sized to clamp onto an object; and (2) a spike member attached to said anchor chassis member, said spike member (a) being operatively adapted and sized to extend into soil, and (b) movable from (i) a housed position within the anchor chassis member to (ii) a use position outside of the anchor chassis member.

16. The fishing rod anchoring device of claim 15, wherein said device comprises an adjustable clamping assembly attached to said anchor chassis member, said adjustable clamping assembly being operatively adapted and sized to clamp onto an object.

17. The fishing rod anchoring device of claim 15, wherein said device comprises a spike member attached to said anchor chassis member, said spike member (a) being operatively adapted and sized to extend into soil, and (b) movable from (i) a housed position within the anchor chassis member to (ii) a use position outside of the anchor chassis member.

18. The fishing rod anchoring device of claim 15, wherein said device comprises (1) an adjustable clamping assembly attached to said anchor chassis member, said adjustable clamping assembly being operatively adapted and sized to clamp onto an object; and (2) a spike member attached to said anchor chassis member, said spike member (a) being operatively adapted and sized to extend into soil, and (b) movable from (i) a housed position within the anchor chassis member to (ii) a use position outside of the anchor chassis member.

19. The fishing rod anchoring device of claim 15, wherein said fishing rod attaching component comprises a quick release component that attaches to a corresponding quick release component on a fishing rod.

20. The fishing rod anchoring device of claim 15, wherein said device is a removable fishing rod handle that is connectable to a fishing rod reel seat having (i) internal threads extending along an interior of the fishing rod reel seat, (ii) external threads extending along an outer surface of the reel seat member, or (iii) both (i) and (ii).
